(19) United States
(12) Patent Application Publication
(10) Pub. No.: US 2013/0268440 A1
(43) Pub. Date: Oct. 10, 2013

(54) Gift Transaction Processing System and Method

(71) Applicant: Doing Good Better, LLC, Sunnyvale, TX (US)

(72) Inventors: Carl Christopher Tierney, Dallas, TX (US); Matthew Joel Crane, Mission Viejo, CA (US)

(21) Appl. No.: 13/887,267

(22) Filed: May 3, 2013

Related U.S. Application Data
(63) Continuation-in-part of application No. 13/420,364, filed on Mar. 14, 2012.
(60) Provisional application No. 61/642,183, filed on May 3, 2012.

(51) Int. Cl. G06Q 20/10

(52) U.S. Cl. CPC G06Q 20/10
USPC 705/44

(57) ABSTRACT

A gift transaction processing system/method allowing collection and management of financial and non-financial gifts from gift donors to gift recipients using a distributed communication network is disclosed. The gift donor interacts with a graphical user interface (GUI) client to donate a gift under control of a gifting computing server (GCS). The GCS receives gift donor information and assigns an identification token to the gift donor and associates this token with the received gift donor information. The GCS then sends the token and an HTML document identifying the gift to the client along with a donation application activator. The client receives this information and displays the HTML document at which time the donor selects the donation activator and the client informs the GCS to complete the gift transaction and provide a receipt to the donor via the client.

### CROSS REFERENCE TO RELATED APPLICATIONS

### Continuation-In-Part Patent Application

This patent application is a Continuation-In-Part and incorporates by reference U.S. Utility patent application for “SECURE TRANSACTION PROCESSING SYSTEM AND METHOD”, Ser. No. 13/420,364, docket AV2SY.0101, filed electronically with the USPTO on Mar. 14, 2012 with EFS ID 12307054 confirmation number 1163.

### PROVISIONAL PATENT APPLICATIONS

Applicant claims benefit pursuant to 35 U.S.C. §119 and hereby incorporates by reference United States Provisional Patent Application for “GIFT TRANSACTION PROCESSING SYSTEM AND METHOD”, Ser. No. 61/642,183, docket AV2SY.0102P, filed electronically with the USPTO on May 3, 2012 with EFS ID 12698502 confirmation number 7688.

### UTILITY PATENT APPLICATIONS

Applicant claims benefit pursuant to 35 U.S.C. §120 and hereby incorporates by reference U.S. Utility patent application for “SECURE TRANSACTION PROCESSING SYSTEM AND METHOD”, Ser. No. 13/420,364, docket AV2SY.0101, filed electronically with the USPTO on Mar. 14, 2012 with EFS ID 12307054 confirmation number 1163.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention relates to gift processing systems/methods and generally includes gifting operations related to financial transfers utilizing credit card, debit card, and/or ACH transactions, as well as non-financial gift transactions of time, labor, and the like.

### PRIOR ART AND BACKGROUND OF THE INVENTION

### Overview

The prior art teaches that in order to give either financial or non-financial gifts via the web or mobile device requires one of the following:
Remembering a code and an obscure SMS text number in order to donate a set predefined amount via a mobile device.
A difficult to navigate multi-step process for placing a financial donation without the opportunity to donate time or other non-financial gifts.
Integration of a separate merchant processing service to process payments.
Sending files of ACH transaction data to a bank to process ACH transactions.
Manual reconciliation of electronic payments net of fees with history of gifts.
Duplicate detection based on database matching of partial name and partial address matches that resulted in a highly inaccurate and slow process.
A manual process for creating updates to the general ledger based on static account definitions
Limited capabilities for donors to view, search and manage their giving to organizations.

More than ever individuals are connected to the Internet to manage many facets of their personal and professional lives. This includes many types of commerce including donation of financial and non-financial gifts. There are many online destinations that allow a volunteer to gift time or donate financially to a cause. Examples of this include churches, a businesses, non-profit organizations, or anywhere that supports causes that are important to the public.

However, these currently available systems have significant deterrents to fund raising and recruiting volunteers for all organizations that solicit help. The convenience of placing a donation and the timing of this donation is essential to an organization's desire to capture and raise funds and recruit volunteers. Typically an individual gift donor enters into a volunteering destination site, or a giving destination site, that requires the donor to enter the amount of time available to volunteer or the amount of money they would like to donate to an organization. Generally these gifting systems involve a process that is overly time consuming and complex. Due to the complexity of the process or the amount of time it takes to complete the process, these systems present a significant deterrent to gifting. Gift donors require a simple process and system in order to support a cause they believe in with their time and money and make a difference in the world.

Donations given online or via mobile device are typically handled with three types of systems that are often integrated manually that are discussed in detail below.

### Text-to-Donate Model

The first common prior art gifting system is a text-to-donate model. A user is presented with a code, a donation dollar amount and a target gifting SMS address associated with the donee. Within this context the term SMS or Short Messaging Service is defined as a text messaging service component of phone, web, or mobile communication systems, using standardized communication protocols that allow the exchange of short text messages between fixed line or mobile phone devices. After the SMS message is sent, the gift donation amount is then charged to the donor's applicable mobile carrier bill. This system allows for the convenience of donating via a mobile device but is limiting for the donor and the recipient of the donation. The donor does not have the ability in most cases to select a custom dollar amount they would like to give, and they have to remember in most cases an obscure code associated with the SMS message target donee recipient. The donor also has no way to review their consolidated tax-deductible gifts as they only receive a bill from their mobile carrier that combines their donation with other non-tax-deductible mobile charges. The recipient of the donation in this instance also has limited information about the donor who is interested in their cause, which limits their ability to engage them with future opportunities to donate their time and money. The recipient of the donation also has a significant waiting period after the donation is made in order to receive the funds from the third party involved in processing the payment.

### Web Page Single-Step E-Commerce Transaction

The second way of handling donation online or via mobile is for a user to donate through an electronic catalog. This is based on a single giving page where the donor selects one of the possible designations for their gift from a drop down box. For example a donor selects one project, fund or cause they are interested in donating to, then fill out a web form with personal data that is not only time consuming but increases the security risk of transmitting personal information over the network.

### Web Page Multi-Step E-Commerce Transaction

The third way of handling donation online or via mobile is for a user to donate through an electronic catalog. This is based on the shopping cart model and although it is convenient (as most donors understand the shopping cart analogy because it is common for ecommerce), it requires many unnecessary interactions by the donor in order to complete the gift. For example a donor selects one project or cause they are interested in donating to, then when they checkout they are prompted to fill out cumbersome web forms with personal data that is not only time consuming but increases the security risk of transmitting personal information over the network.

### Offline Gift Processing System

The fourth type of system for handling donations is in a web page multi-step ecommerce transaction. This gifting option is cumbersome in that it doesn't allow for multiple donations to be given at once like in a shopping cart model and it also contains all of the usability and security deficiencies of the shopping cart model.

### Shared Multi Organization Fundraising

In order for organizations to work together to fundraise typically this involves a process in which there is an agreement between one or more organizations which involves sharing proceeds, commitments to marketing efforts and accounting for each organizations gifts to all organizations participating. This process is difficult, manual and made more complex by the number of systems that are involved in the process. Each system operates separately and sometimes they are integrated well and others depend on import and export to move data back and forth.

### Prior Art User Authentication Methodologies

For purposes of understanding some of the terms used in the diagrams and in the system and method narratives described herein, the following definitions may be useful:

OpenID—OpenID is an open source technology that allows a website user to use and existing account to sign in to multiple websites, without needing to create a new password. When a user uses OpenID their identity is only provided to their applicable identity provider, so other websites never see their actual password, minimizing the chances of their identity being compromised.

Basic Authentication (Internet)—Basic user authentication is on the Internet is the process of determining whether a visitor is who they say they are. This authentication is accomplished by prompting the user to input a USERNAME and PASSWORD. The user's knowledge of this information is assumed to guarantee the user is authentic. Each user registers initially with an assigned or user self-declared password. On each subsequent use the user will use the previously defined password. This information is then sent to the server to verify the user and the server provide approval back to the user allowing access to their personal information if the information is correct, otherwise the user is denied access.

### Prior Art System Context (0100)

The prior art system as generally depicted in FIG. 1 (0100) describes a typical system that could be used to implement online donations. An end user (0101) interacts with a Graphical User Interface (0102) to interact with a computer (0103) using software (0104) to access the Internet (0120). A web page (0131) is requested from a web server (0130), which is displayed in the Graphical User Interface (0102). The web page contains an Embedded Secure transaction input form (0131) submits back to the Credit/Debit Transaction Processor (0141) over the Internet (0120).

### Prior Art Fundraising System Architecture (0200)

A typical prior art gift processing system is generally illustrated in FIG. 2 (0200). In some cases an organization may or may not to choose to have all of the potential systems to support mobile, backoffice, and online giving. Within this context, an organization would establish a website (0201) which would provide information about the organization and its mission. If the organization is accepting gifts over the web, an online gift processing system (0203) is setup and a donation website is created (0202) which is linked to the organization main website (0201).

The online gift processing system (0203) is integrated with the offline gift processing system (0204) via an API or through import and export of data. Typically a merchant processing system (0205) is then integrated with the online fundraising system (0203) to handle processing of credit cards and ACH transactions. If the organization uses a mobile gift processing system (0206) such as SMS to donate, it is setup and a process is defined to import and export data to the back office fundraising system (0204). A third party service or system is often integrated to provide address validation, de-duplication of personal data to help maintain the hygiene of the back office fundraising system (0207).

Lastly, a financial accounting package (0208) is integrated or fed via import and export information with the back office gift processing system (0204) is integrated via import export or through an API with a financial accounting solution (0208) to ensure that the financial accounting for the gifts received by an organization reflects the data captured and recorded in the gift processing system. Typically this process involves setting up multiple accounts to represent revenue and deposits correctly in the general ledger. These accounts must match the accounts as they are defined in the financial solution (0208) in order for the output from the gift processing system (0203) to be input into the financial solution (0204).

### Single-Step Gift Donation Page Setup Method (0300)

FIG. 3 (0300) provides a general prior art description of the single page gift processing setup process. This is the process that is used by many of the current solutions to online giving due to the constraints and requirements related to PCI compliance. A separate server is setup in a PCI compliant environment (0301). If the organization does not have a merchant account (0302) they apply for a merchant account with a merchant processor (0303). The merchant account is then configured in the online gift processing system (0304). The online gift processing system is then configured with the designations that are defined in the offline system (0305). Typically there is some form of integration between the offline and online system, a service that is called to pull gifts and profiles from the online system into the offline system. In many cases this process involves an export of data from the online gift processing system and an import of data. The user typically has some level of configuration that must be completed to setup to enable the online system to feed the offline system information (0307). Because the systems are not tightly integrated there is a manual process required to reconcile donor profiles that are created in the online system with the offline system as a result of accepting an online gift.

Each system is different in terms of its capabilities for handling this reconciliation process, but typically it requires some manual process to resolve the duplicates that may be created as a result of online activity or a process that is run after accepting profiles from the online system in the offline system to remove the duplicates and merge the gift history. In general each organization will define the process for this reconciliation based on the systems they are using for offline gift processing and online gift processing and the volume they do (0308). Once the merchant account is setup, the giving page is typically styled to match the website it is coming from. The giving page may have the ability to be completely styled to match the site that is linked to it, or it may only allow a logo to be added to the giving page (0309). After the configuration is completed, typically the organization will go through a testing process to verify the integration between the online system and the offline system and verify that the merchant processing system works (0310).

### Single-Step Gift Donation Method (0400)

FIG. 4 (0400) provides a general prior art description of the single page gift processing method. A user navigates to an organization's website (0402) and chooses to give to the organization. The single page gift processing system displays a web form and allows the user to choose the designation they wish to give to (0403). The user completes the web form choosing a designation and providing their information (0404). The gift processing system validates the data and submits the transaction to a merchant processor for processing (0405). If the transaction is successful (0406) then the gift processing system records the gift, displays the acknowledgement to the user (0407). The system also typically will email the donor an acknowledgement and receipt of their gift (0408).

### Web Multi-Step Gift Donation Data Flow (0500)

A typical prior art web based multi-step donation system data flow is generally illustrated in FIG. 5 (0500). Within this context, a sending/receiving entity (0510) can be any device that has a web browser (0511) (typically AJAX capable) such as a mobile phone (0512), a tablet (0513), or a laptop/desktop (0514). A sending/receiving entity (0510) communicates with a web server (0530) via network communication (0520) to request (0521) web pages with gift donation opportunities (0531) and to make payment requests (0522). The payment requests are handled by an input through a Payment Information Web Form (0532). A gift donation received acknowledgement (0533) is then sent via network communication (0523) back to the sending/receiving entity (0510).

### Multi-Step Gift Donation Overview Method (0600)

FIG. 6 (0600) provides a general overview of prior art methodology associated with multi-step gift donations. This illustrates an example of how an organization might present multi-step donations to permit a donor to request and view a donation opportunity on an organization website (0601). Then the donor would select a giving opportunity and an amount from the available opportunities presented by the organization (0602). Then the Website would request payment information from the donor to process a payment of the entered donation amount (0603). The donor would then submit his donation to the website (0604). The payment information is then typically verified and processed (0605) and then an acknowledgement message is generally sent to the donor (0606).

### Multi-Step Donation Shopping Cart System Data Flow (0700)

A prior art multi-step donation method utilizing a shopping cart is generally illustrated in FIG. 7 (0700). Within this context, a sending/receiving entity (0710) can be any device that has an AJAX capable web browser (0711) such as a mobile phone (0712), a tablet (0713), or a laptop/desktop (0714). A sending/receiving entity (0710) communicates with a web server (0730) via network communication (0720) to request (0721) web pages with donation opportunities (0731) and also multiple donations selected in a shopping cart (0723) and to make payment requests (0722). The payment requests are handled by an input through a Payment Information Web Form (0732). A donation received acknowledgement (0734) is then sent via network communication (0724) back to the sending/receiving entity (0710).

### Multi-Step Donation with Shopping Cart Method (0800)

The prior art methodology associated with shopping cart multi-step systems is generally illustrated in FIG. 8 (05800). As an example of how an organization might present multi-step donations with a shopping cart a donor would first select a gift donation (0801). The gift donation would then be added to the shopping cart (0802). Then the Website typically requests payment information from the donor to process a payment of the entered donation amount (0803).

### Exemplary Prior Art Gift Selection Methodology (0900)

An exemplary prior art gift selection method is generally illustrated in FIG. 9 (0900). Another example of how an organization might present multi-step donations with a shopping cart may include a donor request and viewing of a donation opportunity on an organization website (0901). The donor then selects a giving opportunity and an amount and adds the gift to the shopping cart (0902).

### Exemplary Prior Art Shopping Cart Methodology (1000)

An exemplary prior art shopping cart method is generally illustrated in FIG. 10 (1000). An additional scenario for a multi-step donation being made with a shopping cart may include a donor request to review the shopping cart prior to checkout (1001). Then the gift donor makes any desired changes to items and amounts in the shopping cart (1002). The gift donor then requests to make payment and is presented with a payment form to checkout with the shopping cart and makes donation payment (1003).

### Exemplary Prior Art Payment Methodology (1100)

An exemplary prior art payment processing method is generally illustrated in FIG. 11 (1100). Execution of a multi-step donation with a shopping cart may include the donor being presented with a request from the website for their payment information in order to process a payment (1101) and the donor would submit their payment via the website (1102). The payment information is then verified and process (1103) and an acknowledgement of donation sent to the donor (1104).

### Multi-Step Gift with Shopping Cart Donation Setup Method (1200)

FIG. 12 (1200) provides a general prior art description of the multi-step gift processing setup process. This is a less frequently used process that by current solutions to perform online giving. A separate server is setup in a PCI compliant environment (1201). If the organization does not have a merchant account (1202) they apply for a merchant account with a merchant processor (1203). The merchant account is then configured in the online gift processing system (1204).

The online gift processing system is then configured with the designations that are defined in the offline system (1205). A multi-step gift donation system that is capable of providing a multi gift designation experience often requires the configuration of a catalog to assist the user in finding the designation they wish to give to (1206). Typically there is some form of integration between the offline and online system, a service that is called to pull gifts and profiles from the online system into the offline system. In many cases this process involves an export of data from the online gift processing system and an import of data. The user typically has some level of configuration that must be completed to setup to enable the online system to feed the offline system information (1207, 1208).

Because the systems are not tightly integrated there is a manual process required to reconcile donor profiles that are created in the online system with the offline system as a result of accepting an online gift. Each system is different in terms of its capabilities for handling this reconciliation process, but typically it requires some manual process to resolve the duplicates that may be created as a result of online activity or a process that is run after accepting profiles from the online system in the offline system to remove the duplicates and merge the gift history. In general each organization will define the process for this reconciliation based on the systems they are using for offline gift processing and online gift processing and the volume they do (1209).

Once the merchant account is setup, the giving page is typically styled to match the website it is coming from. The giving page may have the ability to be completely styled to match the site that is linked to it, or it may only allow a logo to be added to the giving page (1210). After the configuration is completed, typically the organization will go through a testing process to verify the integration between the online system and the offline system and verify that the merchant processing system works (1211).

### Prior Art Mobile Text Based Giving Setup (1300)

The prior art methodology with mobile based text based giving is generally illustrated in FIG. 13 (1300). The process is relatively simple to setup. An organization contacts a text to give organization and setups a SMS code that will result in the phone company billing the individual for the SMS based message (1301). The method then initiates setup of the SMS code and start and end dates for how long the SMS code should be active (1302). Finally, the method defines a process to reconcile revenue received with deposits (1303).

### Prior Art Mobile Web Based Giving Setup (1400)

In some cases the single page and multi-step web based giving solutions may be capable of rendering usable giving forms to a mobile device. In those cases the setup process would be the same as the process identified in previous figures. However, if a specialized mobile web giving experience is required, a separate software package is configured as outlined in FIG. 14 (1400). A server is configured in a PCI compliant environment (1401). A designation is configured in the mobile giving system (1402). A process is defined to export profiles to the offline giving solution (1403). A process is setup for importing gifts into the offline giving solution (1404). A reconciliation process is defined for duplicate profiles created as a result of importing profiles and reconciling the deposits with the revenue reported by the mobile giving solution (1405). A web page is styled for mobile (1406). The process is tested to verify that the reconciliation, deposits, and reporting all work as expected (1407).

### Financial Accounting in Gift Processing Solution (1500)-(1600)

The financial accounting for a non-profit is a critical part of providing accountability to donors for how funds are used. Typically the offline gift processing solution provides either the reports or a file of journal entries that update the general ledger in the financial solution to ensure that it is synchronized with what donations have been received by the organization. Non-profit accounting in the United States is typically based on FASB 116 (http://www.fasb.org/pdf/fas116.pdf) which provides the primary guidance on how to account for contribution revenue. In some organizations, the accounting is handled by pulling reports and manually producing journal entries. Typically this is the approach for smaller organizations as it does not provide an auditable set of financial statements.

For more formal organization, most offline systems use the approach in FIG. 15 (1500) to configuring their offline gift processing solution to feed their financial solution. A designation or fund is setup in the offline gift processing system (1501). A pair of account numbers from the general ledger is associated with a number of gift types and gift sub types (1502) as depicted in FIG. 16 (1600) for each designation in the offline system. An organization may have anywhere from 10 to 100's of designations that need to be mapped in this fashion. Each of these configurations must be tested by creating a series gifts to verify that the GL output is accurate (1503). A process is established to export (1504) the entries to the financial solution being used on a scheduled basis to keep the financial accounting system reconciled (1505). Lastly, a process is developed to deal with adjustments so that the offline gift processing system is reconciled with the financial accounting system (1506).

### Duplicate Detection in Gift Processing Method (1700)-(1800)

Most gift processing systems have a method of detecting duplicates in individual profiles and organization profiles involving some combination of name, address, email, and phone information as generally depicted in FIG. 17 (1700). A typical logical profile may resemble the logical data defined in FIG. 17 (1700) with potentially 0 to N number of alias names (1711), 0 to N number of addresses (1712), 0 to N number of email addresses (1713) and 0 to N phone numbers (1714).

These systems typically handle this process as a user initiated process that is run on the system as a maintenance task using the method defined in FIG. 18 (1800). An exemplary method of the duplicate detection logic for this logical model is defined in FIG. 18 (1800). The system may perform all of logic in a single database, flat file, document or search index request, but the conditions defined in FIG. 11 are the basic logic used. The system compares N number of the first initial characters of the first name and alias first names of the individual profile (1801). If the partial first name matches, typically the entire last name is used to compare it to existing names and aliases in the database (1802). If the names match, an attempt is made to match some other piece of contact information such as partial address (1803), email address and/or phone number (1804). If all of these match, then the profiles with the matching data based on the above criteria are flagged as potential duplicates in the system (1805). In some cases the amount of matching contact information is used to score the match. In some cases a SOUNDEX or METAPHONE algorithm is used to match first name and last name to produce a score. The deficiency with this approach is that the contact information which provides key criteria in this process must be standardized to use it in comparison to other records. In addition the approach requires the creation of known aliases for first names that may be used to identify the person as depicted in the example profile of FIG. 17 (1700).

### Address Validation Standardization, Geo Coding and CASS Certified Addresses in Offline Gift Processing (1900)-(2000)

Most systems have a user initiated process for updating addresses, adding geo coding information, updating the zip code information and address correction via Coding Accuracy Support System verification (CASS). A typical offline gift processing system method for updating and standardizing address information is defined in FIG. 19 (1900). A user selects to export all or a set of addresses to be standardized and geo coded (1901). The data is sent to a service via FTP, Web Service, or other form of transmission (1902). The user receives the address data back from the service via FTP, Web Service or other form of transmission (1903). The data is then imported back into the system to update the existing address records, add geo coding information and standardizing the addresses (1904).

Address standardization will take an address in the form depicted in FIG. 20 prior to standardization (2001) and transform it to its standardized form as depicted in (2002). While this process itself is fairly standard and could be done individual for a single address or in bulk for the entire set of addresses in the system, the standardization of the address after it has been stored or based on user choice to standardize it makes the address an unreliable method for identifying duplicates in the system. As a result the address matching decision defined in (1903) is an inaccurate mechanism of comparison because it is not standardized.

### Merchant Processing Reconciliation Method (2100)-(2200)

The prior method for reconciling merchant processing and ACH payment transactions with the deposits at the bank and the financial accounting for the merchant processing and ACH transactions is depicted in FIG. 21 (2100)-FIG. 22 (2200). Referencing FIG. 21 (2100), a report is pulled from the merchant processor that shows all of the payments processed and the deposits made for the period being reconciled (2101). A report is pulled from the offline, mobile or online gift processing system that shows the gift payments that were made for the period (2102). A report of the fees, chargebacks and refunds are pulled from the merchant processing system for the period (2103). The gift payment history is pulled from the gift processing system or systems that is being reconciled (2104). To reconcile the bank account the deposit history is compared to the merchant report (2105). If the amounts do not match, the previous period or following period are reviewed to see if the merchant processing report amount can be reconciled (2106). If the amounts still do not match the user must contact the merchant processor to resolve the discrepancy. If the merchant processor deposit history for the period matches the bank history then the bank and the merchant processing history is reconciled. Once the deposit history is reconciled the user then checks the gift payment history with the merchant processing gross payment history for the period.

If the amounts do not match, the user checks the gift processing system and the merchant processing system for transactions that are in one of the systems and not the other (2207). If the amounts still do not match, the user looks in the gift processing system(s) and the merchant processing system for payments that would reconcile the amounts from previous or following periods (2208). If the amounts still do not match, the user checks the merchant system for voids and refunds that are not present in the gift processing system(s) (2209). If the amounts still don't match the user checks the gift processing system for refunds or voids (2211) that are not represented in the current period in the merchant processing system (2210).

If the amount of gross payments from the merchant processing system do not match the gross payment amounts from the gift processing system(s) (2212) an adjusting entry or entries are created to balance the other entries being made (2213). The entries for the merchant processing history and deposits are created for the period (2214). The current prior art methodology requires a lot of effort on the part of the user of the gift processing system to resolve the discrepancies that can exist between the multiple systems and reports to ensure correct and accurate financial reporting.

### Prior Art Joint Fundraising Setup Method (2300)

In some cases organizations may choose to work together to raise funds for a project or a disaster. FIG. 23 (2300) outlines the method of setting up the structure and process for enabling organizations to jointly raise funds together. First step is an organization invites another organization to participate in a joint fundraising effort (2301). An agreement is made by both organizations about what investment will be made in marketing the program and how the proceeds will be divided as a result of the joint fundraising effort (2302). The organizations will then define a process and reports and treasury calendar for how to account for the money raised separately by each organization, how to share the progress each organization is making, and how to distribute funds (2303) to the organizations participating in the joint effort based on the funds collected by a single participant in the joint fundraising effort (2304). The current method for setting up joint fundraising requires that each organization trust the other organization to fulfill their obligations per the agreement. It also lacks any third party ability to establish accountability for the proper recognition, and treatment of funds raised by the participants.

### Joint Fundraising Reconciliation and Treasury Method (2400)

Once the agreement is made to jointly raise funds is defined between organizations and the process is defined for each organization's participation in the joint fundraising effort. The method defined in FIG. 24 (2400) outlines the steps necessary that each organization must undertake individually to reconcile and perform treasury functions to distribute proceeds based on the joint fundraising agreement. The first step an organization participating in the joint fundraising effort is to pull a report of all gifts made to the organization from the gift processing systems that are designated to the joint fundraising effort.

The first step is to reconcile and account for the merchant processing that is applicable to the period (see FIG. 21 (2100)-FIG. 22 (2200)) (2401). Once the merchant processing reconciliation is complete a total of all giving payments received and pending is pulled from the gift processing system (2402). The total to be paid to each of the organization based on the defined split of proceeds (see FIG. 23 (2300)) is calculated based on the bank deposits net of fees and refunds (2403). A receivable is setup in the ledger of the participating organization for all gift payments received during the period being reconciled (2404). A check is cut to each of the participating organizations for the deposits received and the remaining receivable is carried forward to the next reconciliation process.

### Deficiencies in the Prior Art

The prior art as detailed above suffers from the following deficiencies:
Payment information entered by donors is passed across the network for every instance of individual donations.
The gift donor is required to enter payment information upon every donation.
Prior art systems generally require multiple steps to affect checkout completion by the donor.
Prior art systems generally incur significant time delays in the gift donor checkout cycle.
Prior art systems generally require entering of payment information upon every instance of checking out with shopping cart.
Prior art systems generally require an additional step of entering donation amount upon selecting a giving opportunity.
Prior art systems generally require gift donors to enter payment information upon making any changes or updates to items and amounts in the shopping cart.
Prior art systems generally require the gift donor to submit their payment information over the network to the organization website.
Many of the deficiencies in the prior art are a result of the integration of mobile, offline, online, merchant processing, and financial systems and the reconciliation process required to keep all of the systems data synchronized.
The prior art online systems are always separate software servers with their own data stores that must be integrated with an offline solution
The prior art online systems rely on manual translation of reports to the financial solution to reconcile bank balances, and accurately reflect revenue and cash.
The prior art online gift processing systems require manual synchronization of designations to ensure that the giving made online is synchronized with the offline gift processing system.
The prior art text-to-give mobile gift processing systems require manual synchronization of designations with text to give solutions.
The prior art online gift processing systems require that marketing information and coding is duplicated between systems to ensure that giving data is correctly attributed to the marketing source of the gift.
The prior art online gift processing systems typically will not allow users to edit their designation choices, amounts, payment methods for recurring gifts because the transfer of giving information is one directional from the gift processing system to the offline processing system.
If the prior art online gift processing system allows for changes to information in the online giving processing system it is not synchronized with the offline gift processing system.
The prior art method for importing profiles created via online or mobile giving requires manual intervention to verify whether or not a new profile is needed or is this profile a match for an existing profile because of deficient duplicate detection logic.
The prior art method for detecting individual duplicates in an offline giving solution relies on non-standardized data to match contact information such as addresses, phone numbers, and email addresses.
The prior art method for defining general ledger accounts by gift type, and/or sub type for producing accurate information to update the general ledger requires large amounts of manual data entry which is error prone.
The prior art method for defining general ledger accounts by gift type, and/or sub type does not allow the organization to correctly reflect the logical design of their general ledger account structure.
The prior art method for defining general ledger accounts does not allow the mapping from designations, payment methods, departments, fund restriction, or other pieces of account segment data to be mapped logically to data in the offline giving solution.
The prior art method of processing credit card payments and ACH payments does not allow for the correct reflection of fees and deposits to facilitate accurate bank reconciliation or financial statements.
The prior art method of setting up a joint fundraising program is manual and lacks a method of controls to ensure each participant meets their obligations.
The prior art method of distributing proceeds from a joint fundraising program is a manual process that requires each organization to honestly account for and report the proceeds they received during the joint fundraising program.

While some of the prior art may teach some solutions to several of these problems, the core issues of reducing the cost and increasing the convenience and security within gift transaction processing systems have not been addressed by the prior art.

### OBJECTIVES OF THE INVENTION

Accordingly, the objectives of the present invention are (among others) to circumvent the deficiencies in the prior art and affect the following objectives:
(1) Provide for a gift transaction processing system and method that allows for a single action donation of time and/or money in a server client environment.
(2) Provide for a gift transaction processing system and method that allows a single action donation to reduce the time and complexity it takes in order to make a donation.
(3) Provide for a gift transaction processing system and method that allows impulse donations to a cause or a project to be accommodated by a simple single action (click or touch) to donate.
(4) Provide for a gift transaction processing system and method allowing a gift donor to donate the amount they want with one simple click or triggering function, avoiding a multi-click gifting experience.
(5) Provide for a gift transaction processing system and method to provide a way for individuals to set a preferred donation amount as part of their preferences.
(6) Provide for a gift transaction processing system and method that allows for a more user customized, improved, and simplified gifting experience.
(7) Provide for a gift transaction processing system and method that minimizes the transmission of donor sensitive information by providing a secure PCI compliant system that uniquely identifies an individual donor and stores all donor information, allowing for a consolidated donation accounting for the individual donor including donation preferences and history.
(8) Provide for a gift transaction processing system and method that allows for the client system to provide a one click experience for the donor at the time of gift that only transmits a secure token over the network without transmitting sensitive donor information.
(9) Provide for a gift transaction processing system and method that improves upon the prior art by not transmitting sensitive donor information over the network for a single donation they make to an individual organization, but in contrast minimizes the data sent over the network by storing all of the donors organizations they give to in one secure server location.
(10) Provide for a single integrated solution that eliminates the manual process of moving data to and from disparate channel based gift processing systems.
(11) Provide a robust and fast duplicate detection mechanism that prevents duplicate individual profiles from entering the system during the online, offline, and mobile giving process.
(12) Provide a gift processing system that allows data associated with the gift such as but not limited to channel, restriction type, fund, designation, payment method, campus, gift type, donor type, event type, grant type, constants to be used as segment providers in defining an account string for the purpose of updating the general ledger.
(13) Provide an integrated payment processing mechanism with the gift processing system for all channels that automatically reconciles merchant processing transactions with gift payments, charitable event payments, and grants.
(14) Provide a gift transaction processing system that automatically updates and informs all parties of joint fundraising transactions that would benefit them based on defined rules entered into the gift transaction processing system.
(15) Provide for a gift transaction processing system that would automatically perform treasury functions related to joint fundraising transactions.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

A system and method for facilitating financial and non-financial gift donations via a distributed communication system such as the Internet is disclosed. The gift donation is placed by a gift donor via a client system (desktop, tablet computer, and/or mobile device) and received by a gifting computing server (GCS). The GCS receives gift donor information including identification of the donor, donation information, and volunteer time available from the client system. The GCS then assigns an identification token to the client system and associates the assigned client token with the received gift donor information. The GCS sends to the client system the assigned client token and an HTML document identifying the gift item and including a gift donation button or activation trigger. The client system receives and stores the assigned client token and receives and displays the HTML document. In response to the selection of the gift donation button or gift activation trigger, the client system sends to the GCS a request to donate to the identified organization or gift recipient. The GCS receives the request and combines the gift donor information associated with the client token of the client system to generate a gift donor receipt of the donation that is emailed to the gift donor and stored in the secure GCS.

The disclosed system/method facilitates financial and non-financial gifts, charitable event registrations, grants and other charitable revenue transactions. The gift donation can be made through a variety of channels such as in person, through the mail, via a mobile phone application, via a website, via a telephone.

Using a single application that is capable of serving all channels with a logical data store that serves all channels eliminates the need to manually reconcile, import, export data to and from a central gift processing system. In order to facilitate a true multi-channel capable solution that does not require software be installed on premise for performing mobile and web based giving a robust set of features must be delivered via cross domain requests see (other patent).

However to effectively manage the checkout experience for non-profit organizations without requiring authentication for each web or mobile based transaction, the gift processing system must be fairly accurate and fast in identifying potential duplicate profiles. One of the benefits of the prior art approach to handling mobile and web based gift processing is that each record being accepted by the offline gift processing system could be inspected for being a potential duplicate. The integrated multi-channel gift processing system contains a unique approach to managing duplicates by leveraging CASS certified addresses, known first name aliases, metaphone3 based phonetic name indexing, and search index based scoring to accurately identify matching records.

Having a single platform addresses some of the costly and time consuming methods used to centralize information for non-profit organizations. One of the most tedious and challenging areas of reconciliation and data integration is related to the processing of electronic payments. Due to the date issues related to payment date, settlement date, deposit date reported and deposit date actual combined with the fact that many merchant processors report fees and actual deposits in summary and not in detail and non-profit organizations have to invest manual effort in trying to reconcile the merchant processing reports with the bank deposit records with the gift processing records.

The need to obtain and configure a merchant account, reconcile payments with gifts, reconcile deposits with gifts, and reconcile fees and reconcile payments with deposits can eliminated by building a gift processing system that has merchant processing features. Using fully embedded merchant processing allows the gift processing system to directly update gift payment information based on the data feed from the acquiring bank. This direct feed of data and recording deposit and settlement data by the charitable transaction allows an accurate representation of bank deposits and payment status without the need to manually download, upload, or interpret reports.

To address the challenges associated with financial solution integration a more robust mechanism is required to support financial accounting within the gift processing system itself. Our invention teaches that an embedded general ledger which is part of the transaction process prevents many of the errors and problems related to the calculated general ledger approach that the current prior art method teaches. Combined with an account design process that allows data associated with a gift transaction to be annotated with segment information and combined using an account design eliminates the tedious process of assigning account pairs to gift type information which constrains the design of the general ledger and is often error prone.

With a multi-tenant gift processing system, the capabilities of a fully embedded sub ledger and a fully embedded payment processing mechanism, our invention streamlines the ability for organizations to jointly raise funds as well. Using an invite process which specifies how proceeds are split, organizations can quickly establish a joint fundraising program that is made available on their websites, their mobile application and in their offline gift processing by accepting an invite. In addition, our inventions embedded general ledger combined with our embedded payment system allows for the automatic accounting and distribution of funds at the time the gift transaction takes place and when the funds are deposited. There is a greatly reduced need for manual coordination of joint fundraising efforts and a third party which enforces the agreed upon reporting and distribution of funds.

### BRIEF DESCRIPTION OF THE DRAWINGS

For a fuller understanding of the advantages provided by the invention, reference should be made to the following detailed description together with the accompanying drawings wherein:

FIG. 1 illustrates a prior art gifting system architecture;

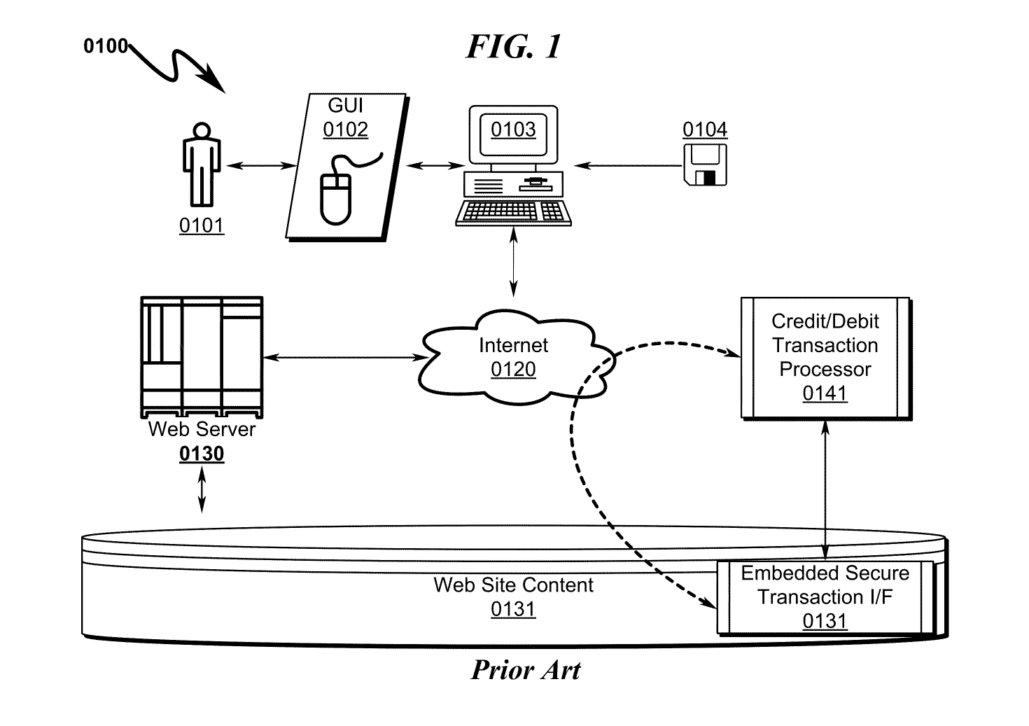

FIG. 2 illustrates a prior art web-based gift donation architecture;

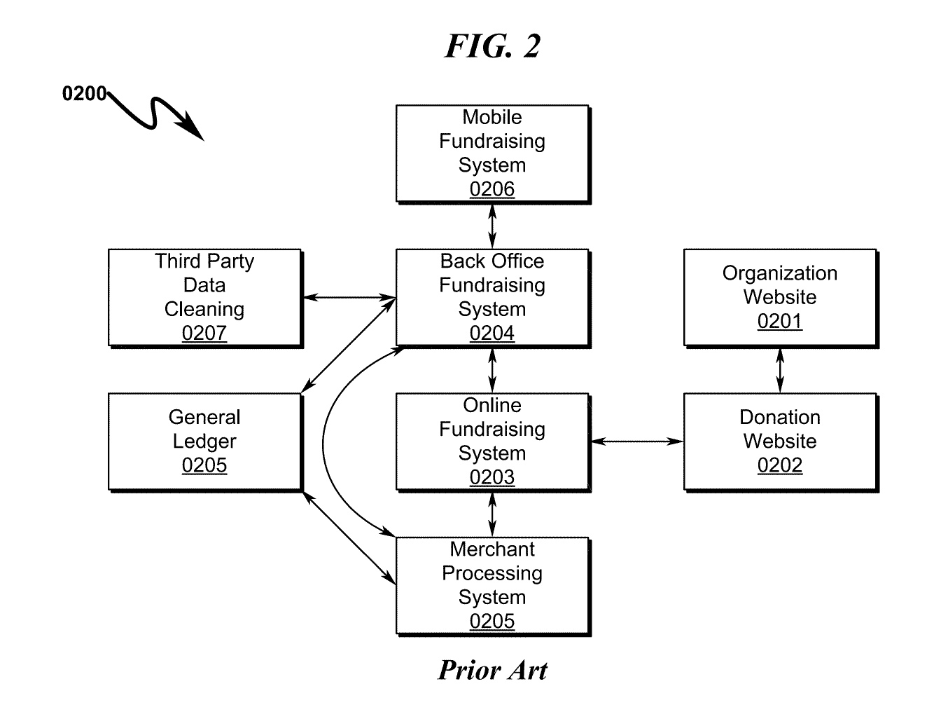

FIG. 3 illustrates a prior art web-based single-step gift donation setup method;

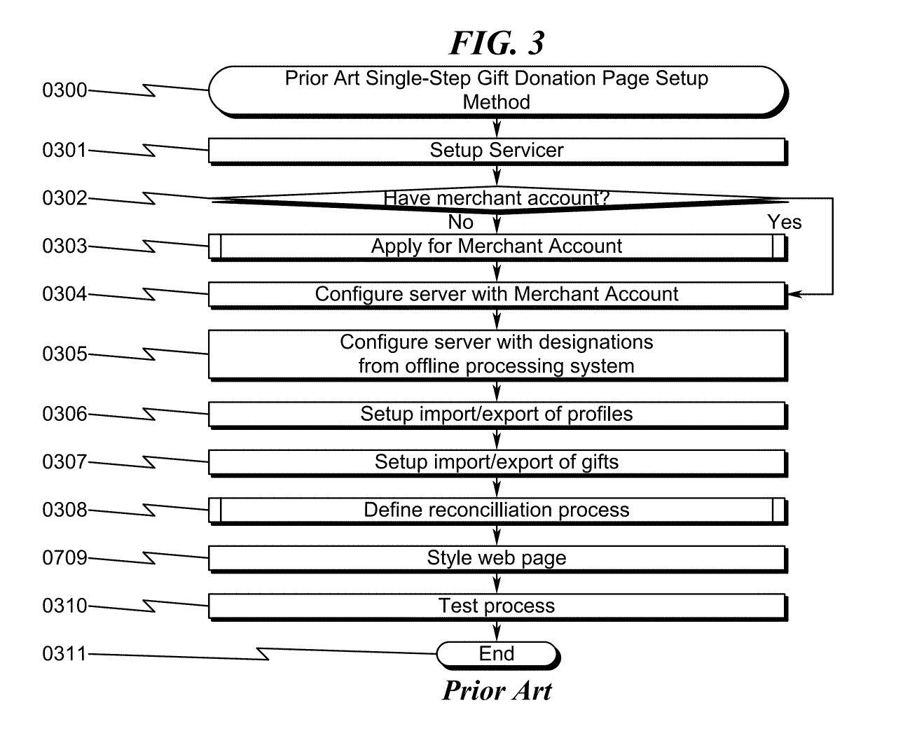

FIG. 4 illustrates a prior art web-based single-step gift donation method;

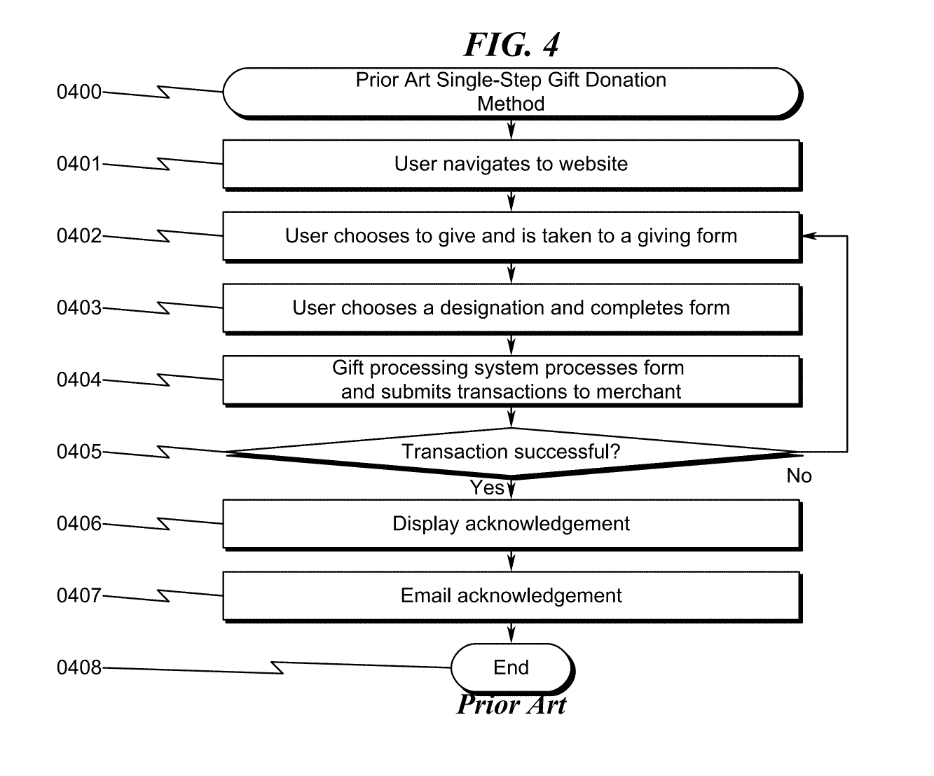

FIG. 5 illustrates a prior art web-based multi-step gift donation architecture data flow;

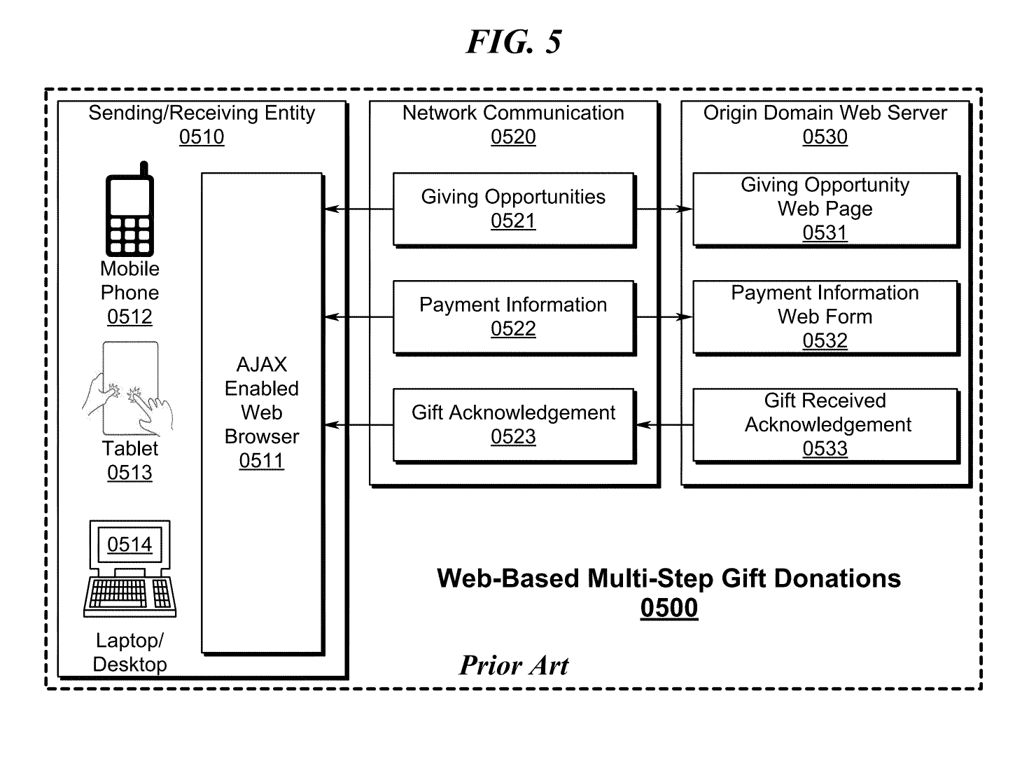

FIG. 6 illustrates a prior art multi-step giving method;

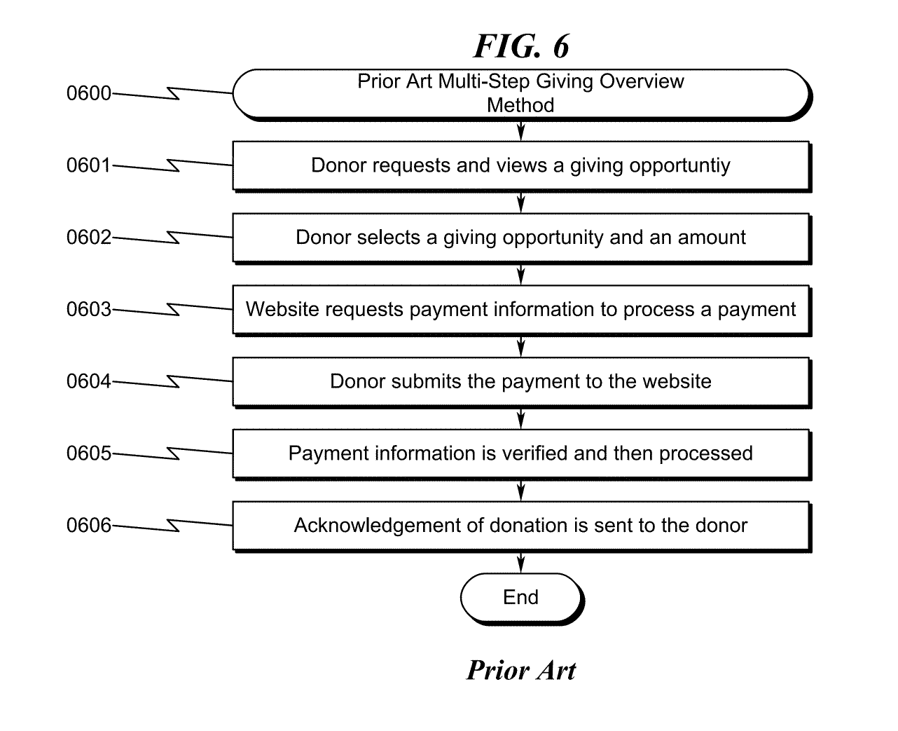

FIG. 7 illustrates a prior art multi-step donation system data flow incorporating a shopping cart;

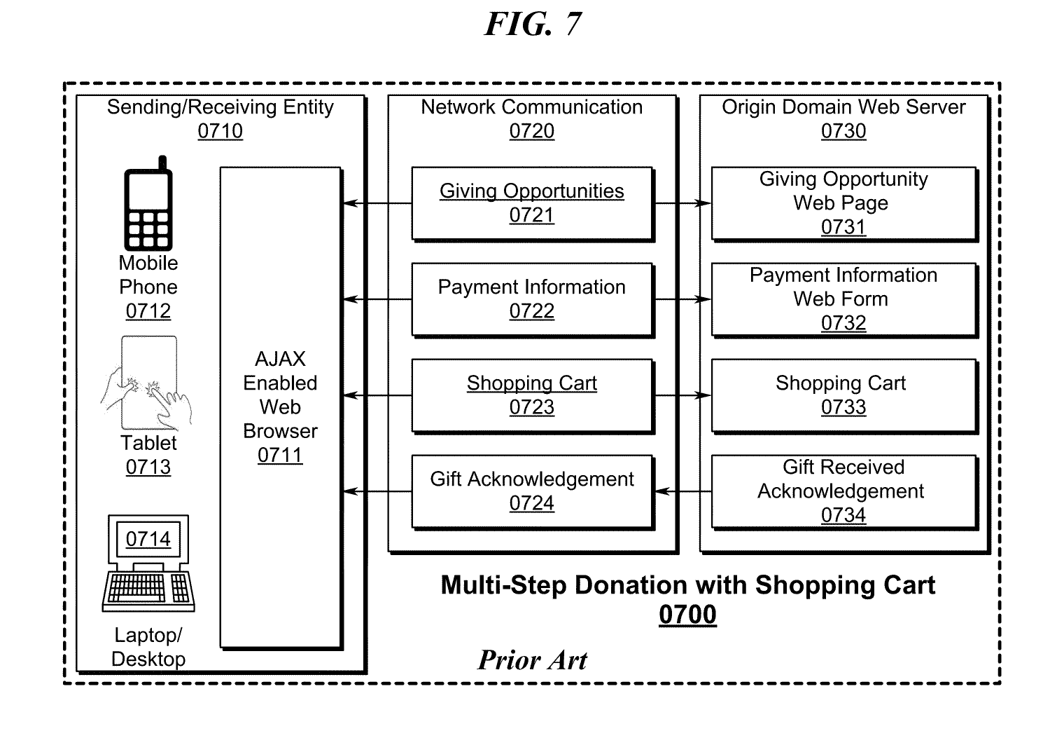

FIG. 8 illustrates a prior art multi-step donation method incorporating a shopping cart;

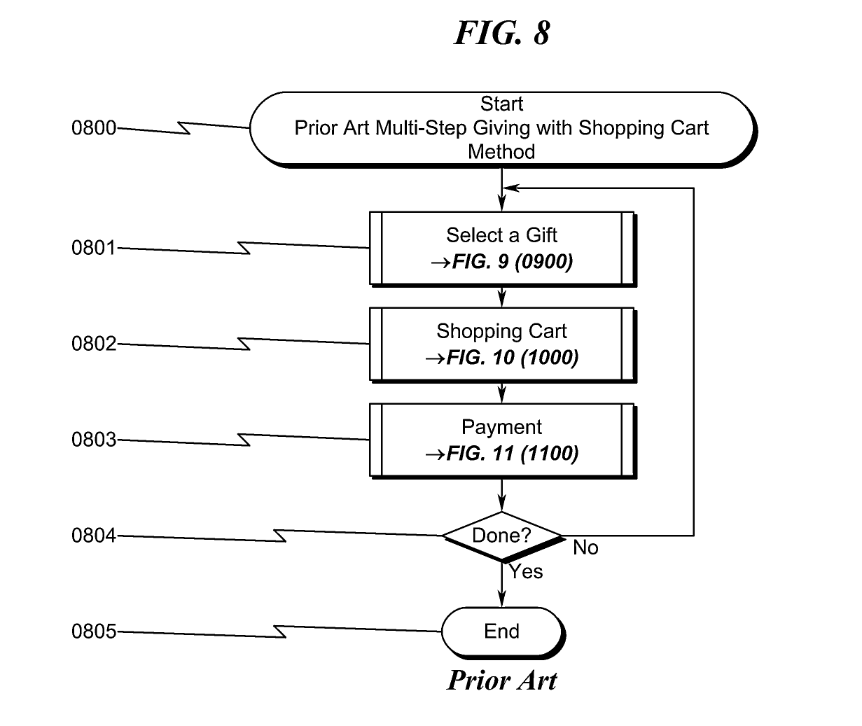

FIG. 9 illustrates a prior art multi-step donation gift selection method;

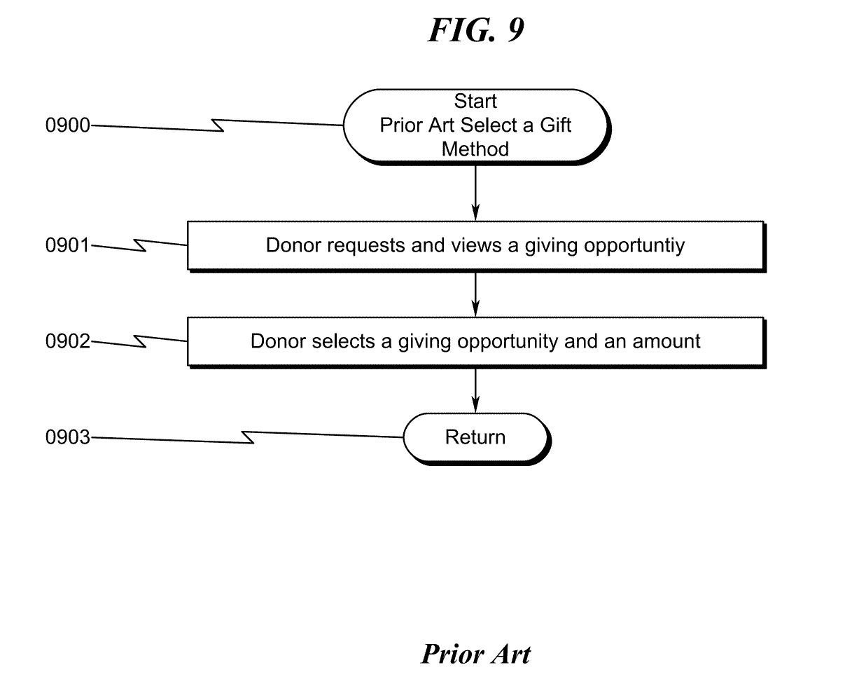

FIG. 10 illustrates a prior art multi-step donation shopping cart method;

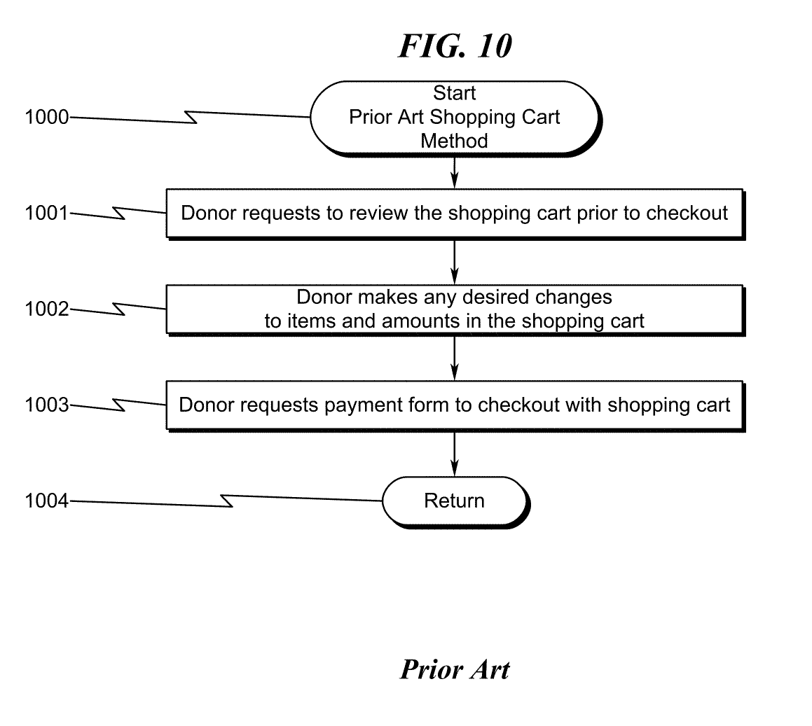

FIG. 11 illustrates a prior art multi-step donation payment method;

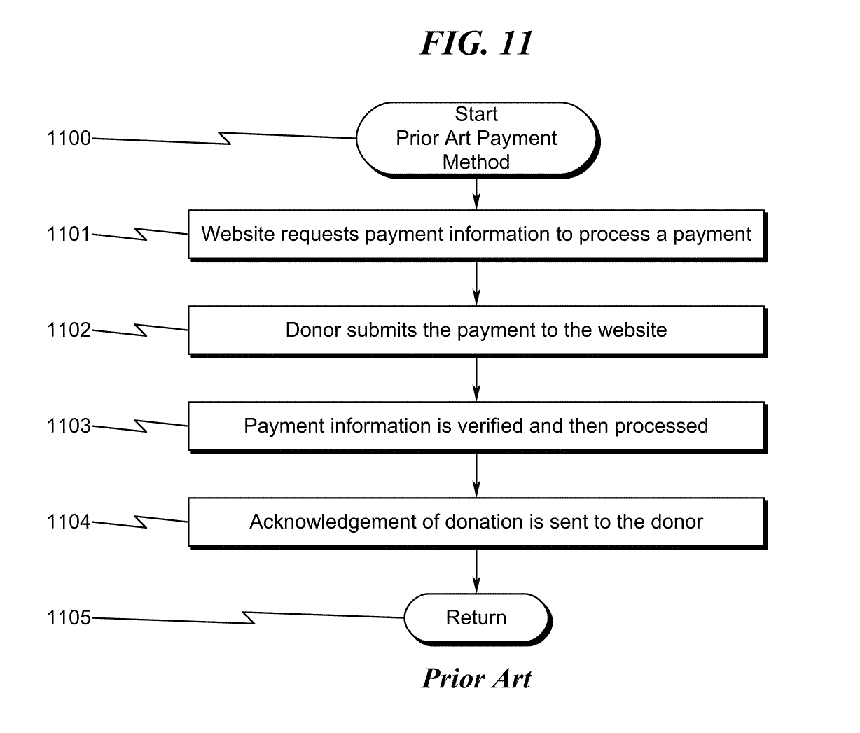

FIG. 12 illustrates a prior art web-based single-step gift donation setup method;

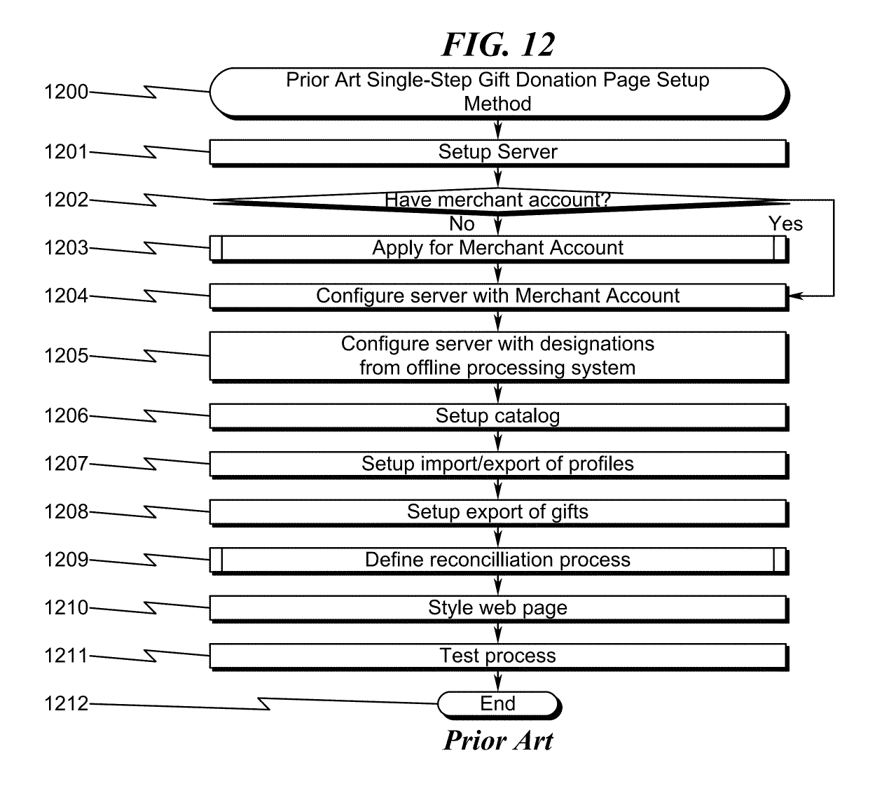

FIG. 13 illustrates a prior art text-based giving setup method;

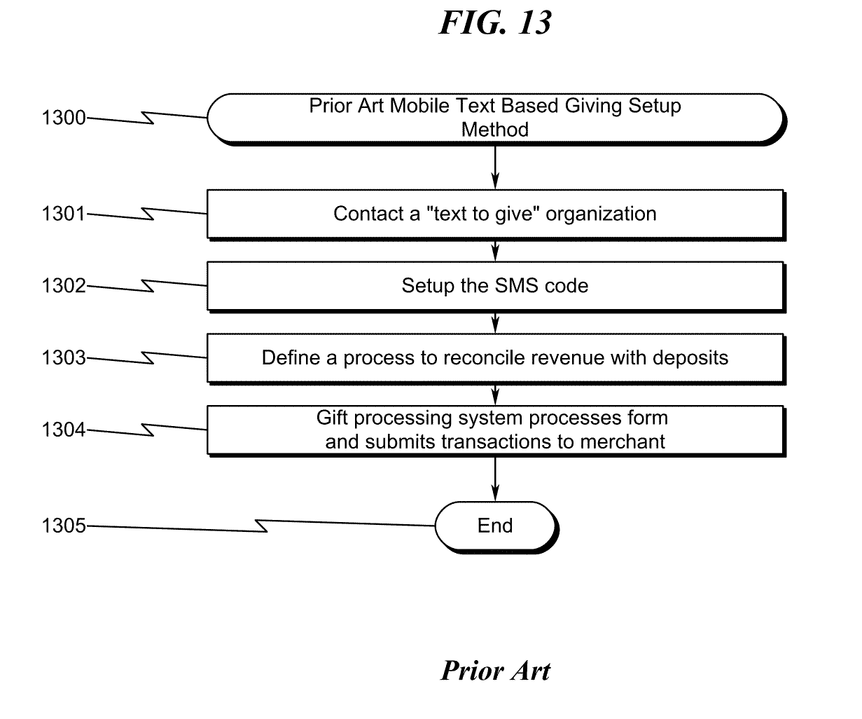

FIG. 14 illustrates a prior art web-based giving setup method;

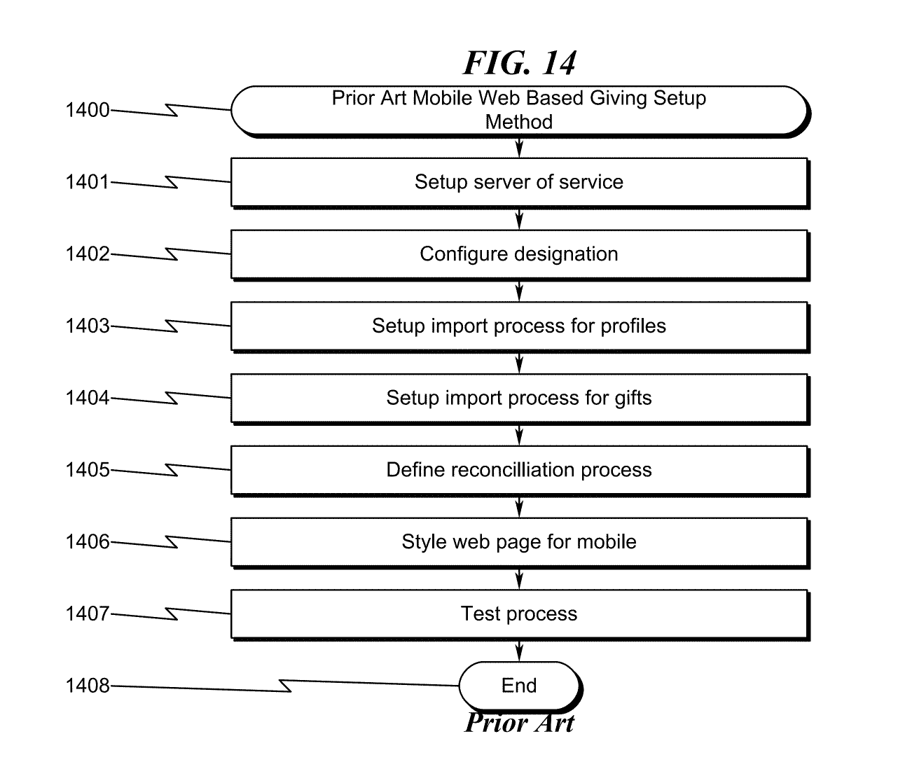

FIG. 15 illustrates a prior art financial gift processing solution setup method;

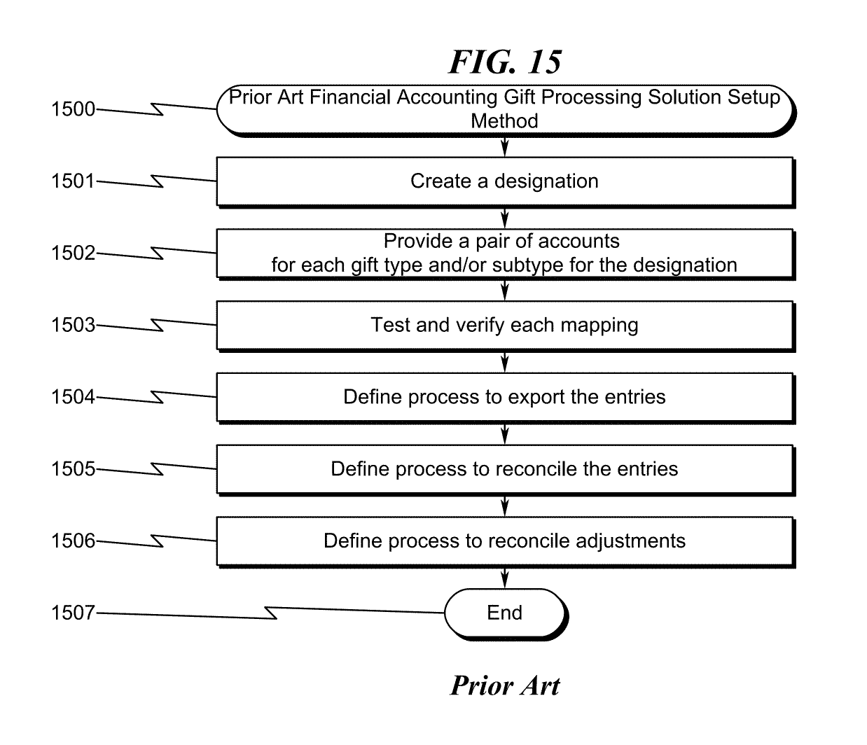

FIG. 16 illustrates a prior art exemplary gift transaction ledger;

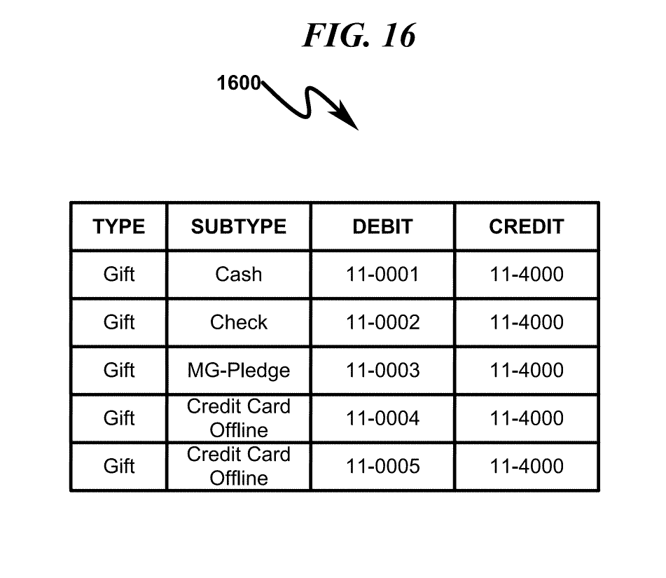

FIG. 17 illustrates a prior art content duplication example;

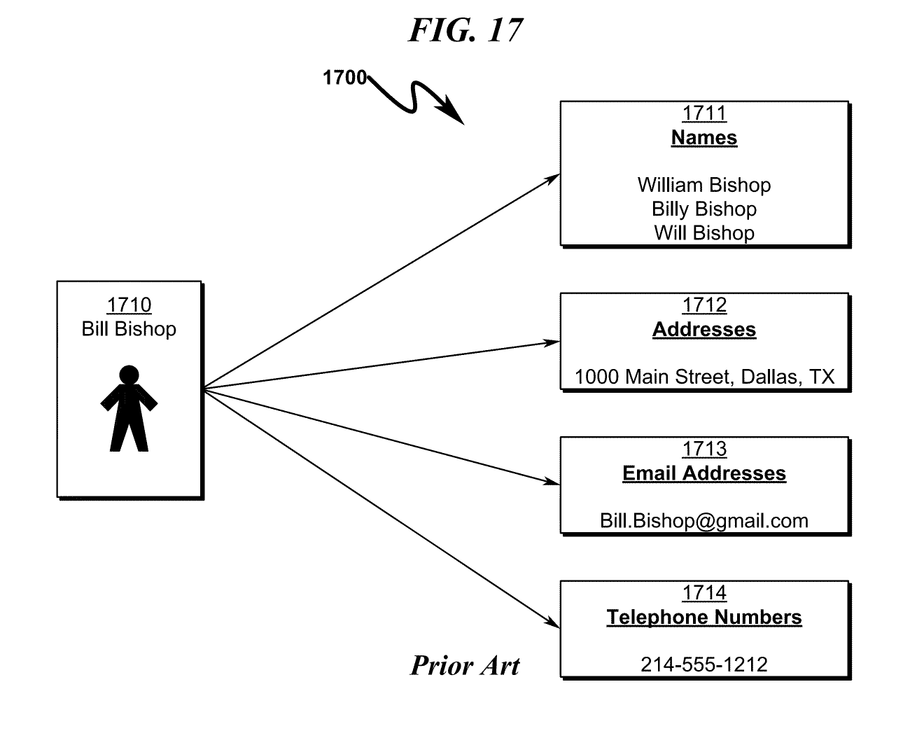

FIG. 18 illustrates a prior art duplicate detection method;

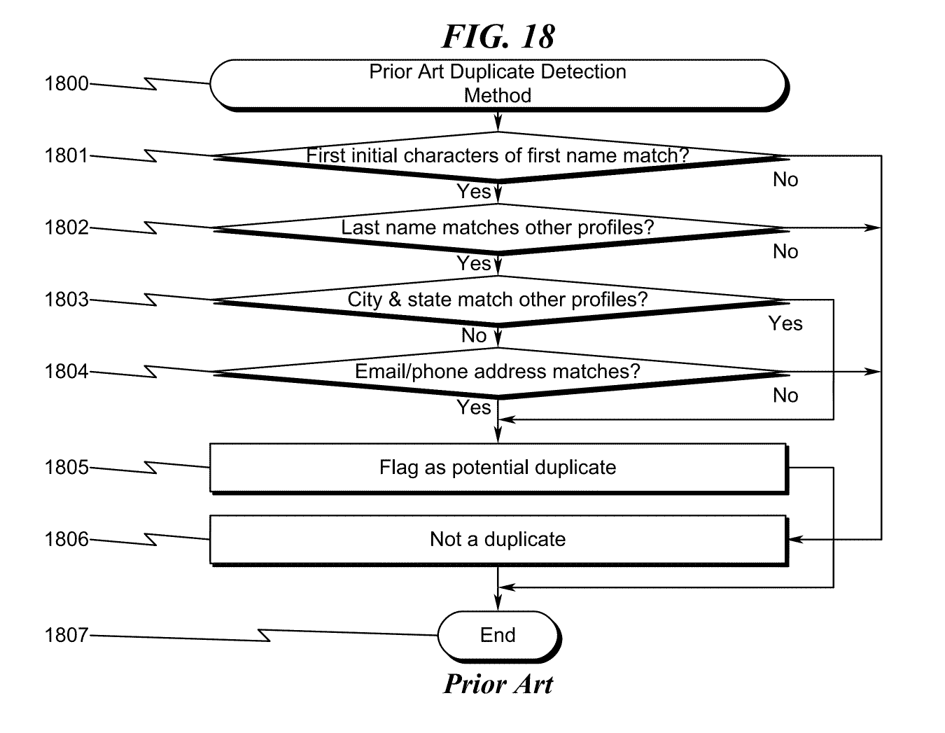

FIG. 19 illustrates a prior art address validation standardization method;

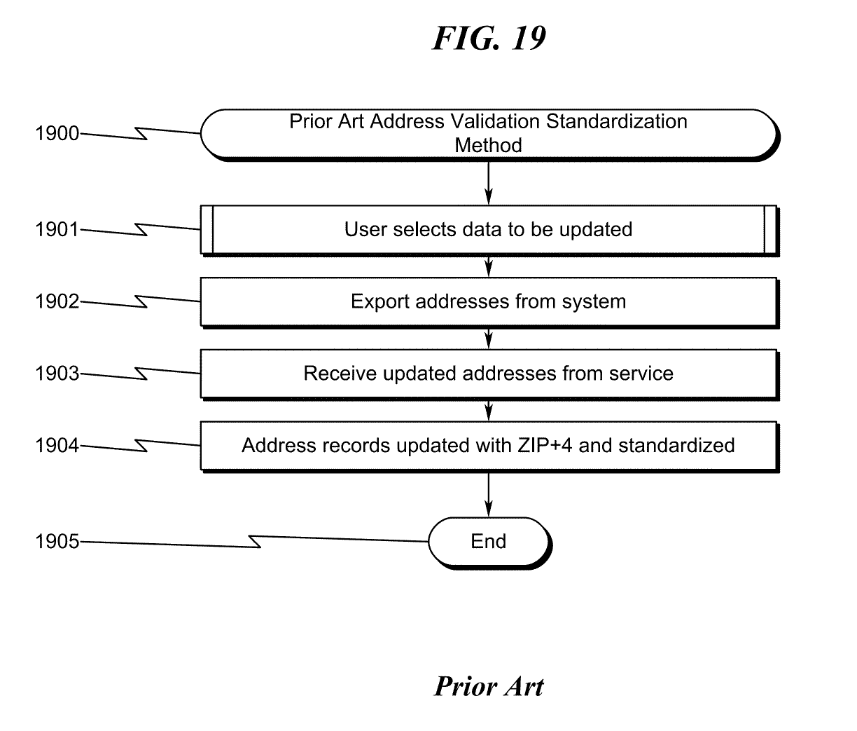

FIG. 20 illustrates an address validation standardization example;

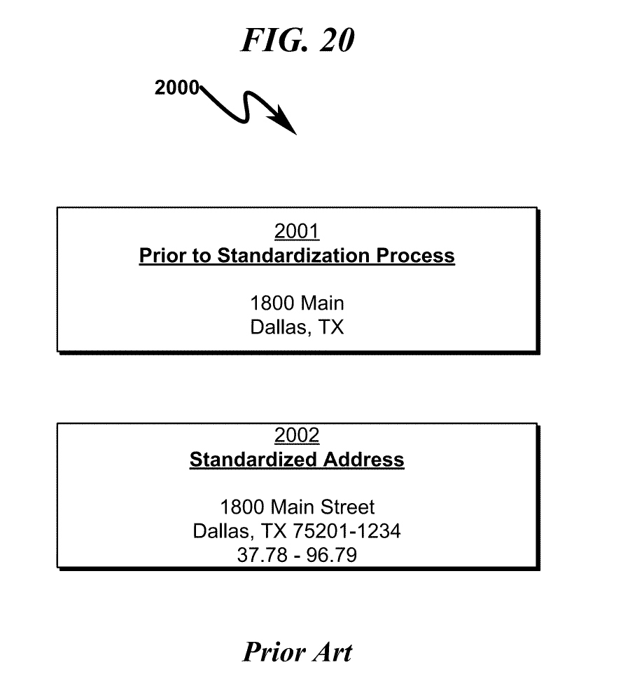

FIG. 21 illustrates a prior art merchant processing reconciliation method;

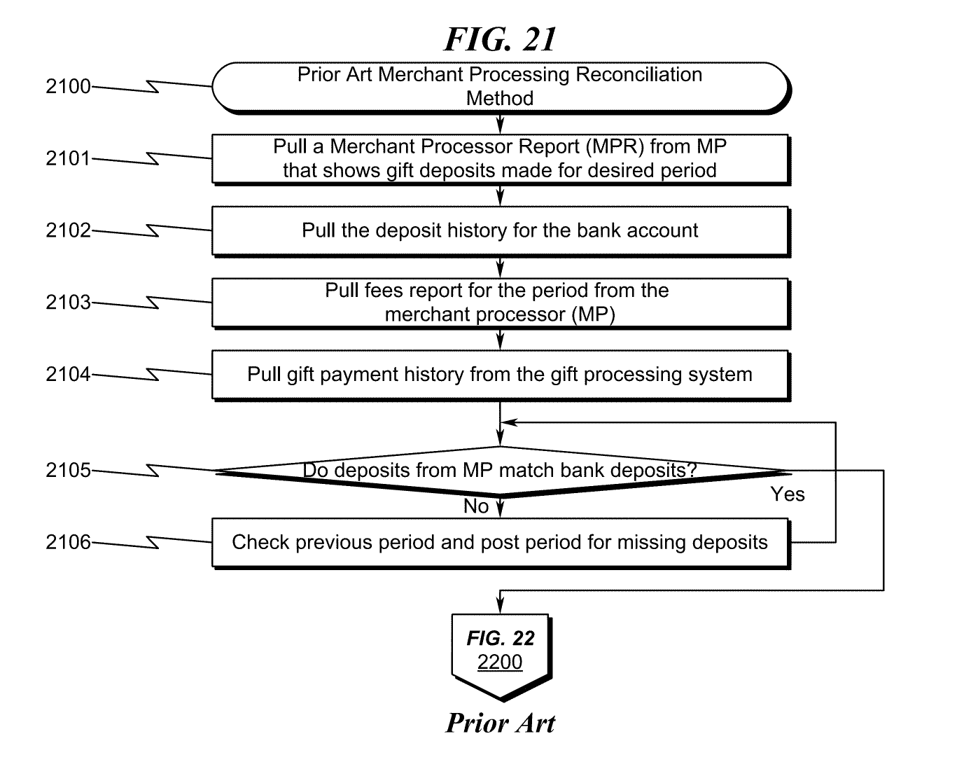

FIG. 22 illustrates a prior art merchant processing reconciliation method;

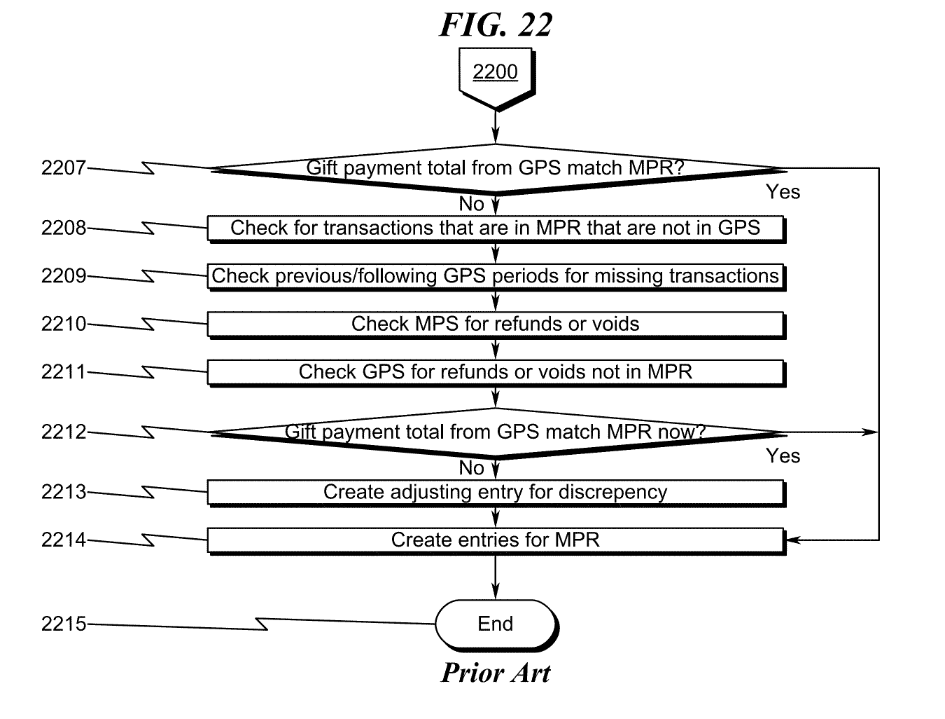

FIG. 23 illustrates a prior art joint fundraising method;

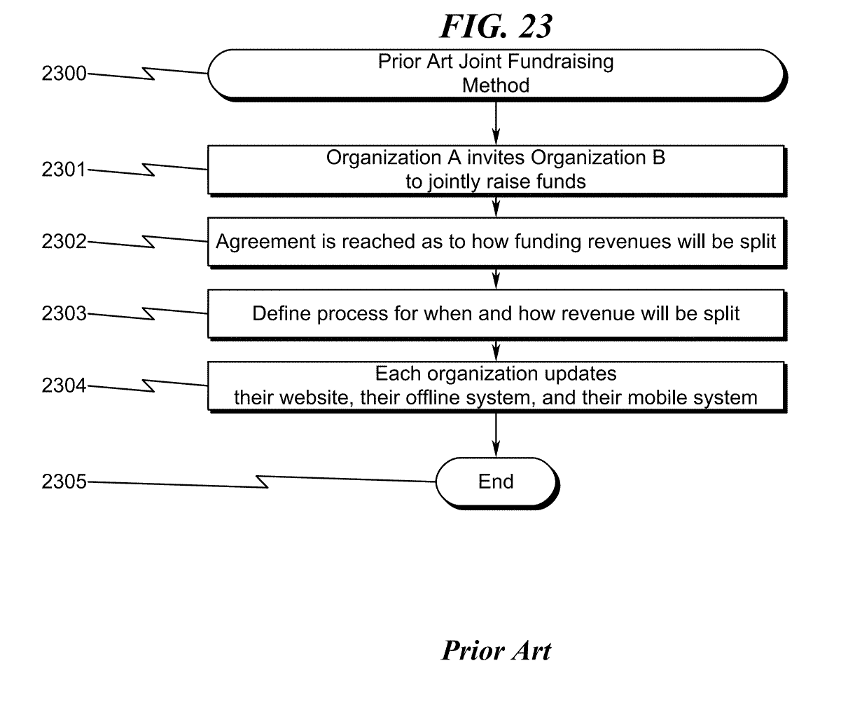

FIG. 24 illustrates a prior art joint fundraising reconciliation and treasury method;

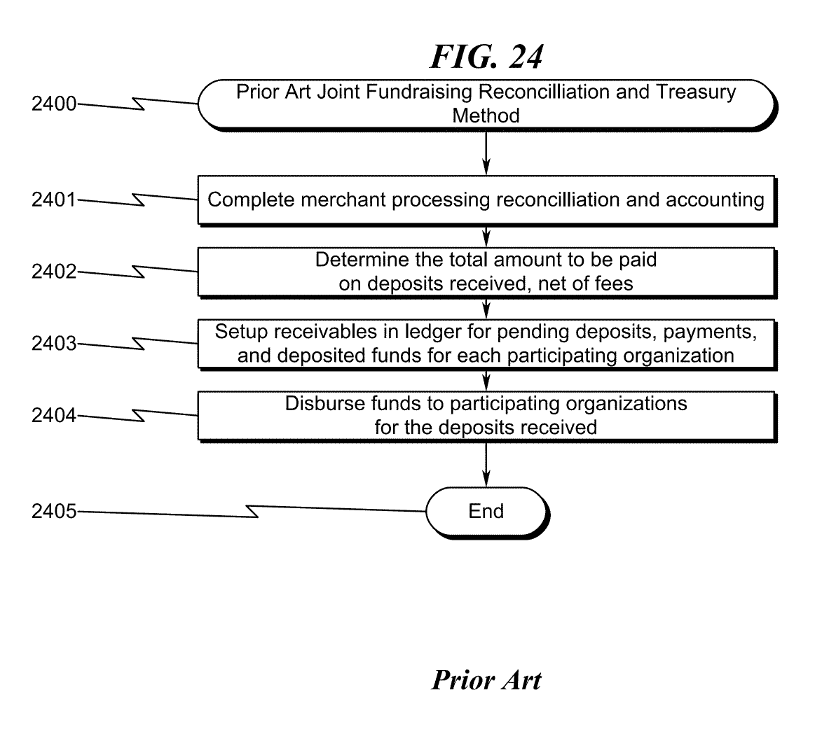

FIG. 25 illustrates a preferred exemplary system embodiment of the present invention;

FIG. 26 illustrates a preferred exemplary system embodiment of the present invention implementing a financial gifting system;

FIG. 27 illustrates a preferred exemplary system embodiment of the present invention implementing a non-financial gifting system;

FIG. 28 illustrates a preferred exemplary method embodiment of the present invention;

FIG. 29 illustrates a preferred exemplary method embodiment of the present invention depicting an exemplary donor profile configuration method;

FIG. 30 illustrates a preferred exemplary method embodiment of the present invention depicting an exemplary time and financial donation opportunity catalog method;

FIG. 31 illustrates a preferred exemplary method embodiment of the present invention depicting an exemplary donor/donee association and one-click donation method;

FIG. 32 illustrates a preferred exemplary method embodiment of the present invention depicting an exemplary transaction processing and reconciliation method;

FIG. 33 illustrates a preferred exemplary system embodiment of the present invention depicting use of secure donor databases and financial institution payment processing interfaces;

FIG. 34 illustrates a preferred exemplary data structure associated with some preferred embodiments of the donor database;

FIG. 35 illustrates a preferred exemplary one-click donation method associated with some preferred embodiments of the present invention;

FIG. 36 illustrates a preferred exemplary donor organization association method associated with some preferred embodiments of the present invention;

FIG. 37 illustrates a preferred exemplary conditional gifting system associated with some preferred embodiments of the present invention;

FIG. 38 illustrates a preferred exemplary conditional gifting method associated with some preferred embodiments of the present invention;

FIG. 39 illustrates a preferred exemplary geospatial gifting system associated with some preferred embodiments of the present invention;

FIG. 40 illustrates a preferred exemplary geospatial gifting method associated with some preferred embodiments of the present invention;

FIG. 41 illustrates an exemplary system block diagram illustrating subsystems contained within a preferred exemplary embodiment of the present invention;

FIG. 42 illustrates an exemplary account credentialing flowchart associated with a preferred exemplary embodiment of the present invention;

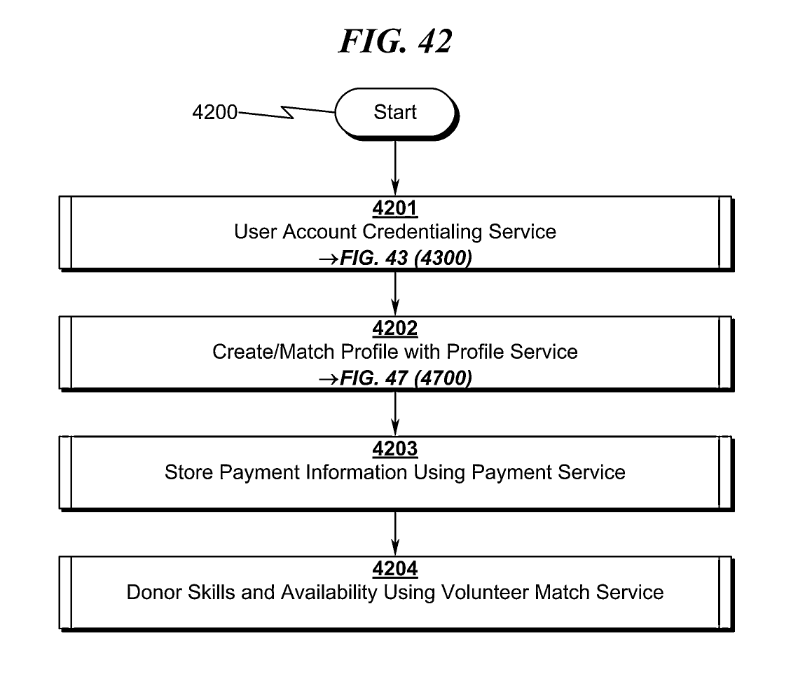

FIG. 43 illustrates an exemplary credentialing flowchart associated with a preferred exemplary embodiment of the present invention;

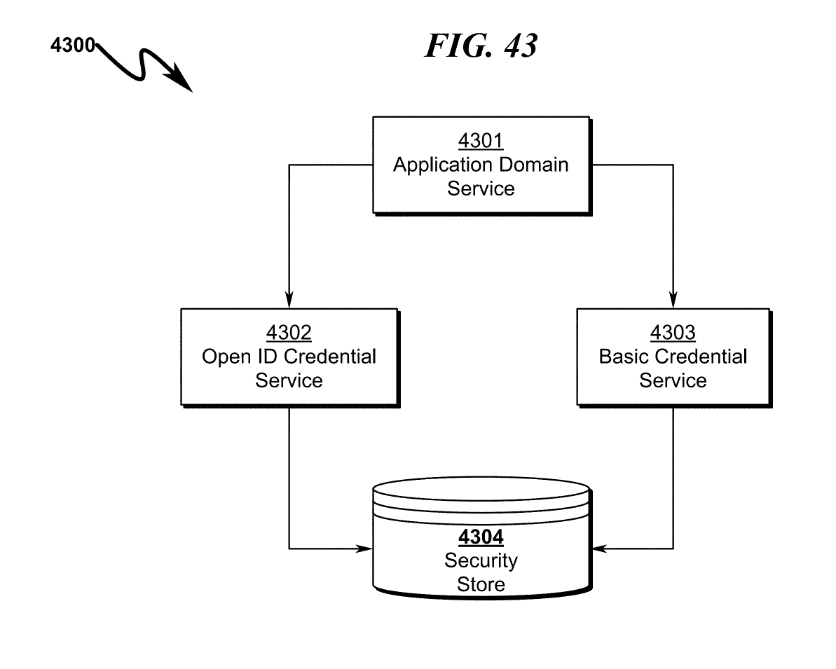

FIG. 44 illustrates an exemplary domain processing flowchart associated with a preferred exemplary embodiment of the present invention;

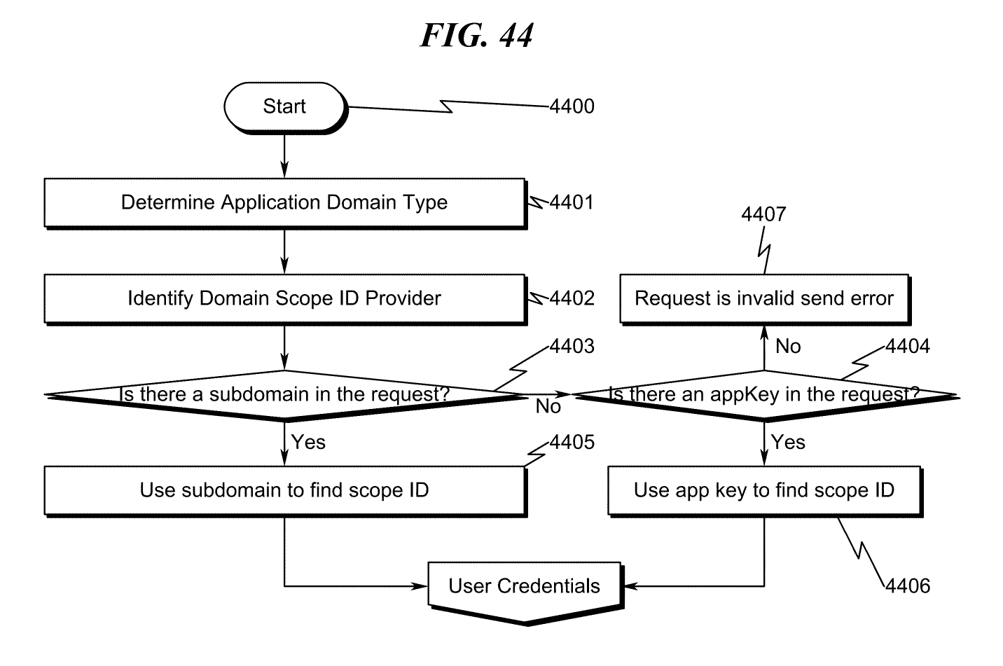

FIG. 45 illustrates an exemplary user registration flowchart associated with a preferred exemplary embodiment of the present invention;

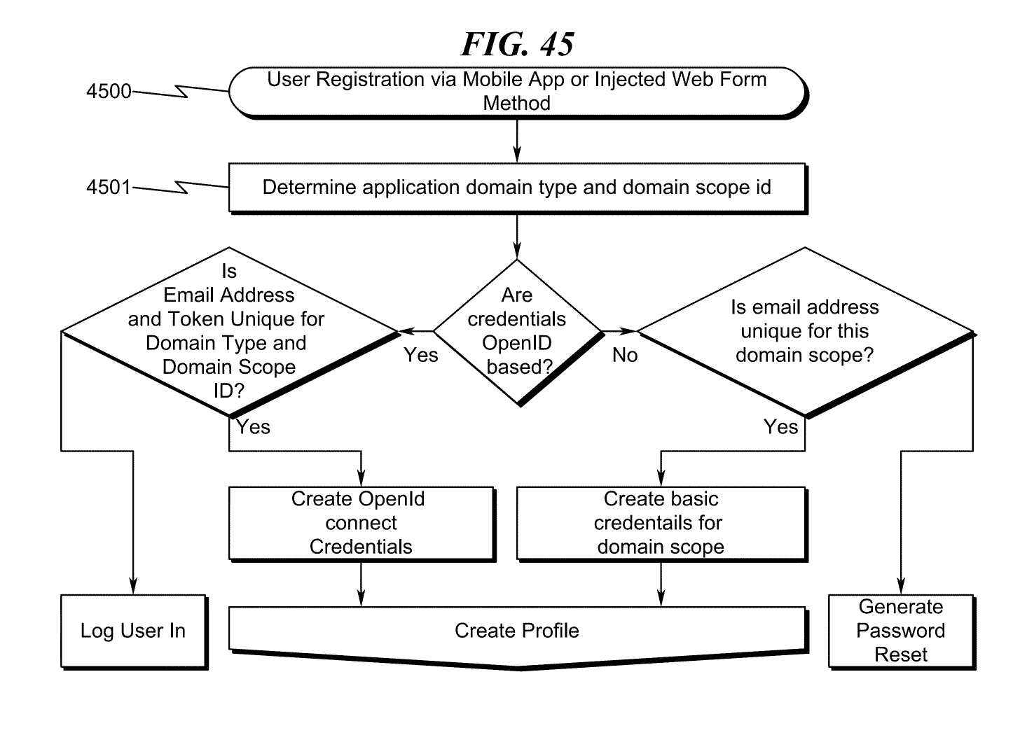

FIG. 46 illustrates an exemplary donor database layout associated with a preferred exemplary embodiment of the present invention;

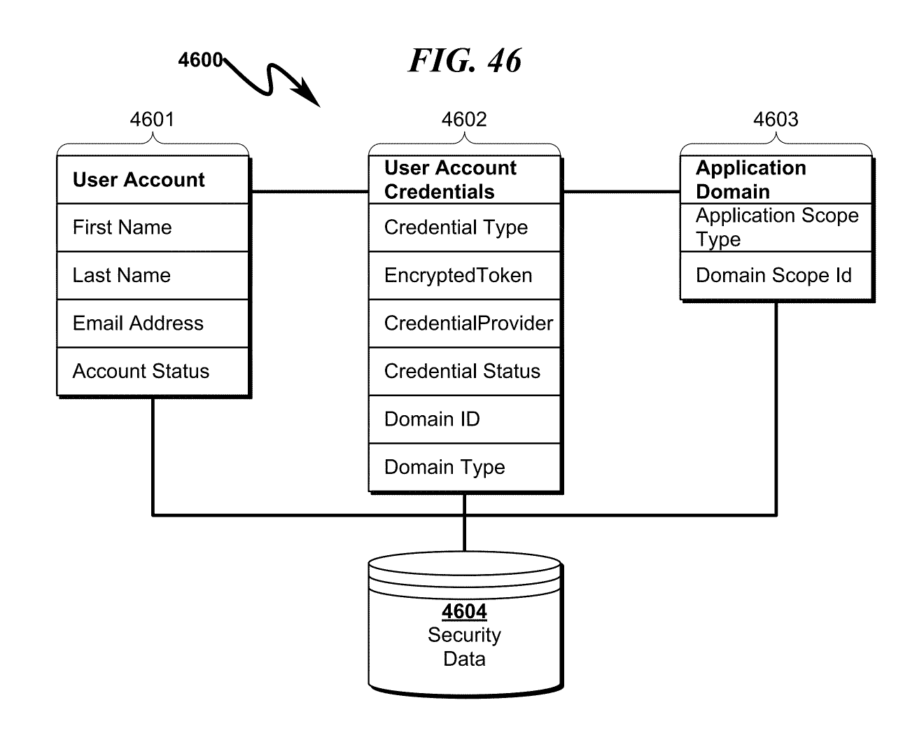

FIG. 47 illustrates an exemplary name indexing flowchart associated with a preferred exemplary embodiment of the present invention;

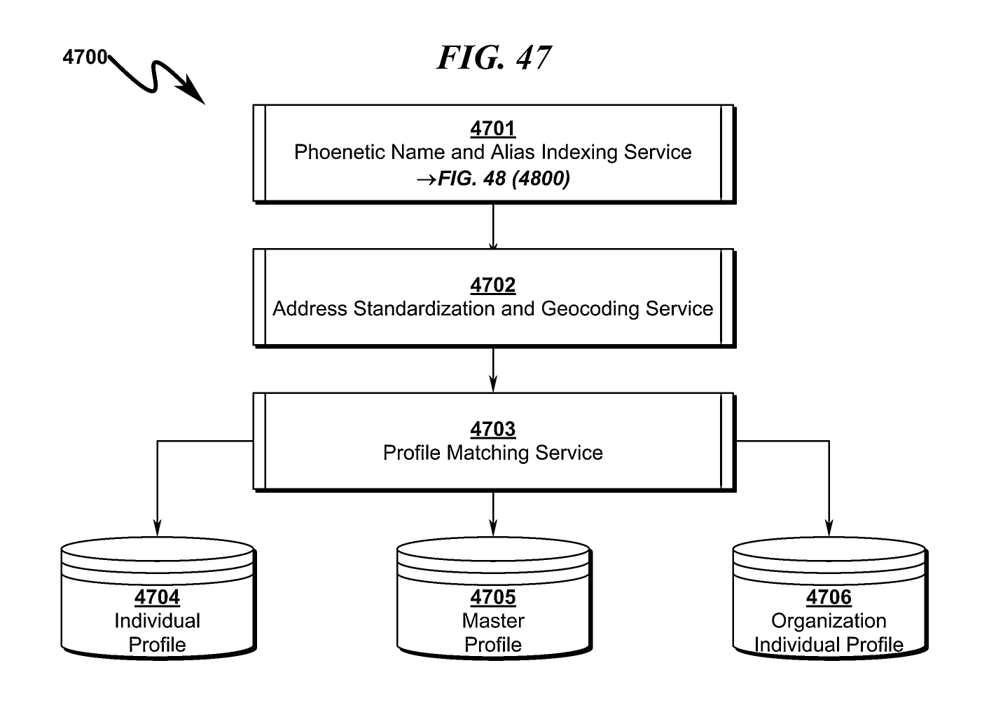

FIG. 48 illustrates an exemplary name indexing detail method flowchart associated with a preferred exemplary embodiment of the present invention;

FIG. 49 illustrates a functional block diagram of a preferred exemplary system embodiment of the present invention;

FIG. 50 illustrates an exemplary profile data structure useful in some preferred invention embodiments;

FIG. 51 illustrates an exemplary profile data structure useful in some preferred invention embodiments;

FIG. 52 illustrates a preferred exemplary method embodiment of the present invention depicting an exemplary individual profile detection method;

FIG. 53 illustrates an exemplary ledger data structure useful in some preferred invention embodiments;

FIG. 54 illustrates an exemplary User Interface for Account Design useful in some preferred invention embodiments;

FIG. 55 illustrates a preferred exemplary method embodiment of the present invention depicting an exemplary account creation/assignment method;

FIG. 56 illustrates an exemplary merchant payment data structure useful in some preferred invention embodiments;

FIG. 57 illustrates a preferred exemplary method embodiment of the present invention depicting an exemplary merchant processing charitable transaction method;

FIG. 58 illustrates an exemplary Data Model For Joint Fundraising Efforts useful in some preferred invention embodiments;

FIG. 59 illustrates a preferred exemplary method embodiment of the present invention depicting an exemplary joint fundraising invite method;

FIG. 60 illustrates an exemplary Joint Fundraising Invite and Acceptance User Interface useful in some preferred invention embodiments;

FIG. 61 illustrates an exemplary Joint Fundraising Invite and Acceptance Status User Interface useful in some preferred invention embodiments;

FIG. 62 illustrates a preferred exemplary method embodiment of the present invention depicting an exemplary donation received for joint fundraising method;

FIG. 63 illustrates an exemplary Payment Processing Ledger Report User Interface useful in some preferred invention embodiments;

FIG. 64 illustrates an exemplary Payment Processing Ledger Detail Report User Interface useful in some preferred invention embodiments.

### DESCRIPTION OF THE PRESENTLY PREFERRED EXEMPLARY EMBODIMENTS

While this invention is susceptible to embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a GIFT TRANSACTION PROCESSING SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Internet Communication not Limitive

The present invention anticipates that a wide range of communication methodologies may be utilized to affect a specific implementation of the present invention. While the present invention specifically anticipates that the use of the Internet for most applications, the present invention makes no limitation on the type of communication technology or computer networking that may be used. Thus, the term “computer network” and/or “Internet” are to be given the broadest possible definitions within the scope of the present invention.

### Secure Transaction Processing not Limitive

The present invention anticipates that a wide range of secure transaction processing methodologies may be utilized to affect a specific implementation of the present invention. The present invention specifically anticipates that the use of techniques detailed in U.S. Utility patent application for “SECURE TRANSACTION PROCESSING SYSTEM AND METHOD” (Ser. No. 13/420,364, docket AV2SY.0101, filed electronically with the USPTO on Mar. 14, 2012 with EFS ID 12307054 confirmation number 1163) may have application in some preferred invention embodiments. However, the present invention makes no limitation on the type of communication and/or transaction security technology that may be used to implement the present invention.

### Terms

### Gift Processing System

Within the context of the present disclosure the system will be described as a gift processing system. However, some others may refer to it as a fundraising system or a constituent relationship management system or online and offline giving systems. All of these terms imply the same type of system. For the purpose of this disclosure we are focused on disclosing the inventions that are related to the gift processing portion of these systems.

### Offline Gift Processing System

A system that typically provides CRM, and a centralized place for recording and reporting on all fundraising activities regardless of a channel. Typically this system supports defining various marketing activities/fundraising appeals that can be associated with giving to provide analysis and reporting on how well the organization is in obtaining donations. The system also provides a centralized source of all organization and individual profile records for use in various communication activities to support the charitable organization.

### Online Gift Processing System

A gift processing system that is primarily focused on web and mobile web based giving. This system may or may not include outbound marketing capabilities via SMS, social network, content based and email marketing. The online gift processing system typically includes some capabilities as it relates to understanding what has been given online by a donor, an ability to authenticate with the online system, and reports and/or exports to feed the offline giving system. Some online gift processing systems have connectors or web services that allow them to interact more directly with the offline solution. Typically the online gift processing system is hosted separately because of the PCI requirements related to its accepting credit card payments.

### Designation

For the purposes of the disclosure we will describe donor intent of their gift as a designation.

### Collaborative Giving

For the purposes of the disclosure we will use the term collaborative giving to describe the overall effort between multiple organizations to share fundraising.

### System Overview

The present invention is defined as a system and method for facilitating and managing charitable financial and non-financial transactions to an organization. The client system is built as a multi-tenant SAAS model for merchant processing, revenue financial accounting, and gift processing for multiple channels. This system which features embedded capabilities of typically disparate systems provides unique cost advantages, data, and speed advantages to organizations which perform multi-channel and/or joint fundraising. The client system is built as a SAAS model and typically provides a unique account for each individual that can span multiple organizations within the overall gift donation system.

Individual donors within this context are associated with a unique identifier that will allow them to store their individual information, name, nickname, address, preferred account for giving (ACH, MASTERCARD®, VISA®, AMERICAN EXPRESS®, etc.) and available time to volunteer. The client system will provide access and details of opportunities to donate financial or non-financial gifts to individual organizations or projects within organizations with a simple selection or click to donate. Once this action is taken the client system communicates to the server in order to store the details of the donation from the individual. The server then communicates with the organization to let them know the donation has been completed.

### Preferred Exemplary System Embodiment (2500)

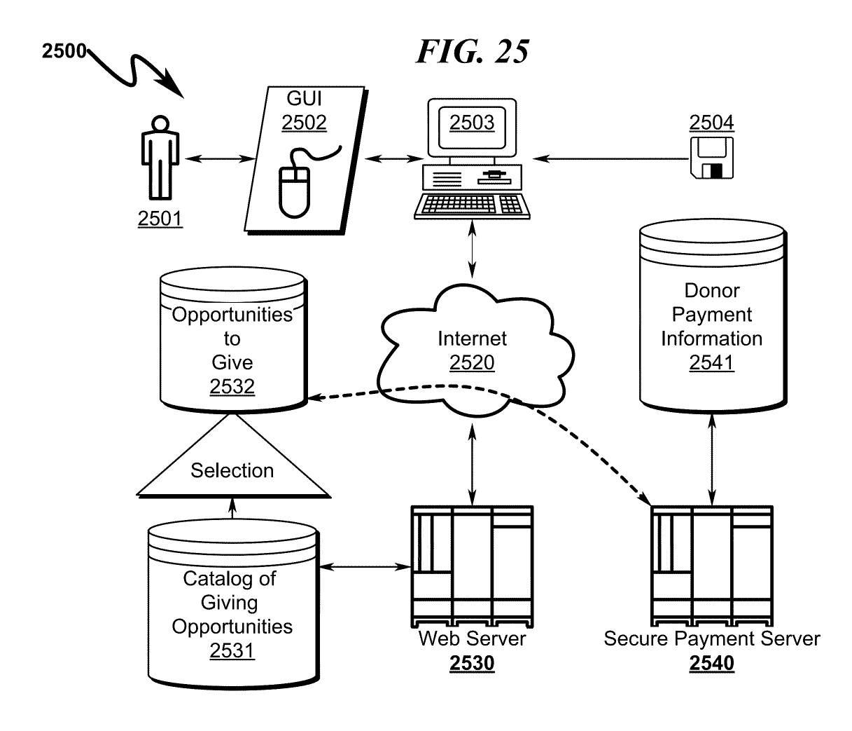

A preferred exemplary system embodiment of the present invention is generally illustrated in FIG. 25 (2500) and depicts a One-Click-Donation-System. The One Click Donation System describes an exemplary system that could be used to implement the present invention. An end user (2501) interacts with a Graphical User Interface (2502) running on a computer (2503) executing software read from a computer readable medium (2504) to access the Internet (2520). An opportunity to give (2532) is selected from the catalog of donation opportunities (2531) via the web server (2530). The user then donates to the opportunity with one click or other activation trigger. The donor payments information (2541) is then accessed via the secure payment server (2540).

### Preferred Exemplary Financial Transaction System (2600)

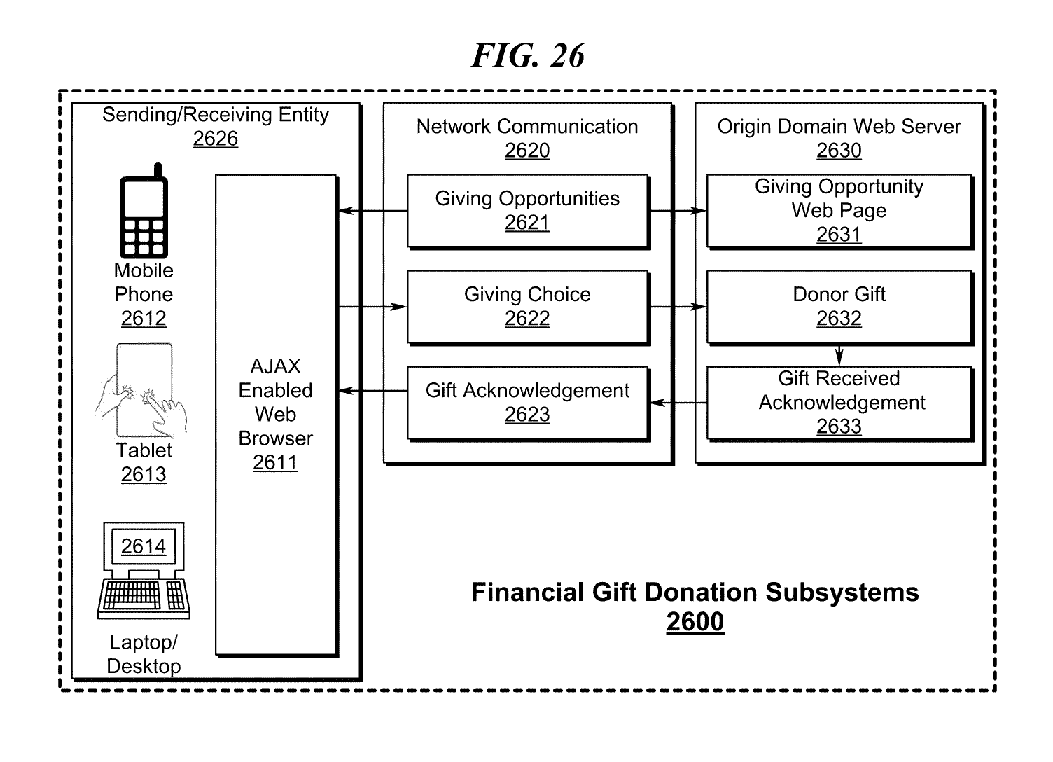

A preferred exemplary system embodiment of the present invention as applied to financial gifting is generally illustrated in FIG. 26 (2600). The financial donation processing system involves a sending/receiving entity (2610) that can be any device that has an AJAX capable web browser (2611) such as a mobile phone (2612), a tablet (2613), or a laptop/desktop (2614). A sending/receiving entity (2610) makes domain web page requests (2621) using an AJAX enabled browser (2611) through a network connection (2620) to view a web page (2631) that is hosted on an organization web server (2630). When the sending/receiving entity selects a giving choice (2622) and inputs the financial donation (2632). The origin domain web server then sends a gift received acknowledgement (2633) back over the network (2623) to the sending/receiving entity (2610).

### Preferred Exemplary Non-Financial Transaction System (2700)

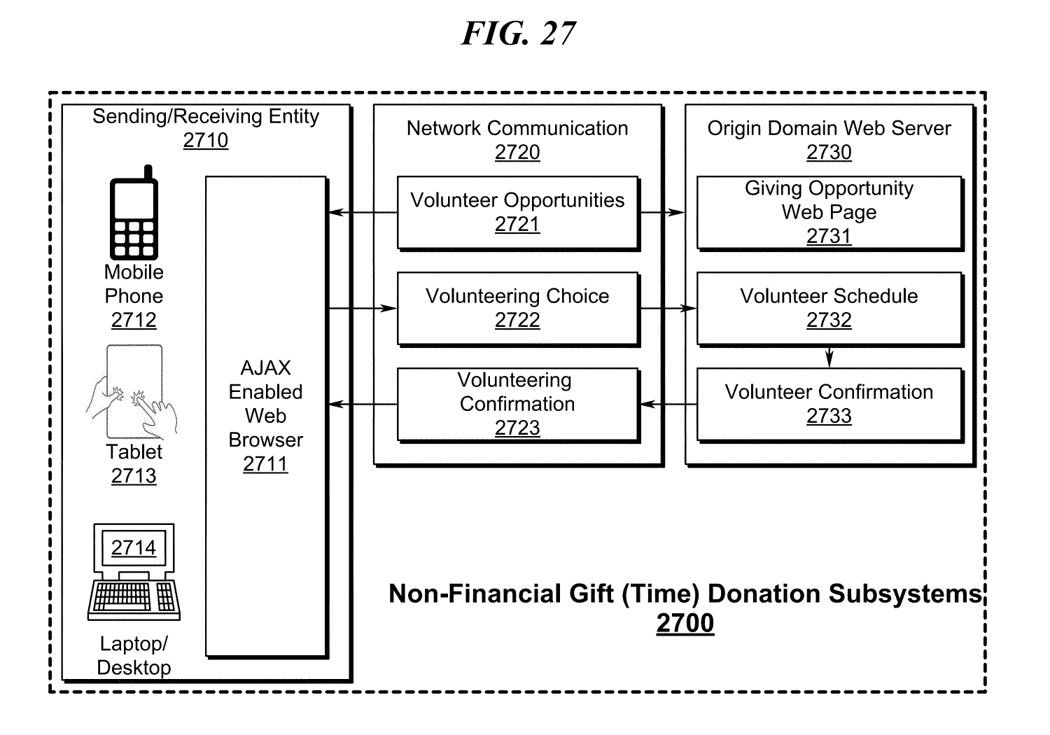

A preferred exemplary system embodiment of the present invention as applied to non-financial gifting is generally illustrated in FIG. 27 (2700). The financial donation processing system involves a sending/receiving entity (2710) that can be any device that has an AJAX capable web browser (2711) such as a mobile phone (2712), a tablet (2713), or a laptop/desktop (2714). A sending/receiving entity (2710) makes domain web page requests (2721) using an AJAX enabled browser (2711) through a network connection (2720) to view a web page (2731) that is hosted on an organization web server (2730). When the sending/receiving entity selects a giving choice (2722) and inputs the time donation (2732). The origin domain web server then sends a gift received acknowledgement (2733) back over the network (2723) to the sending/receiving entity (2710).

### Exemplary Gift Transaction Processing Method (2800)

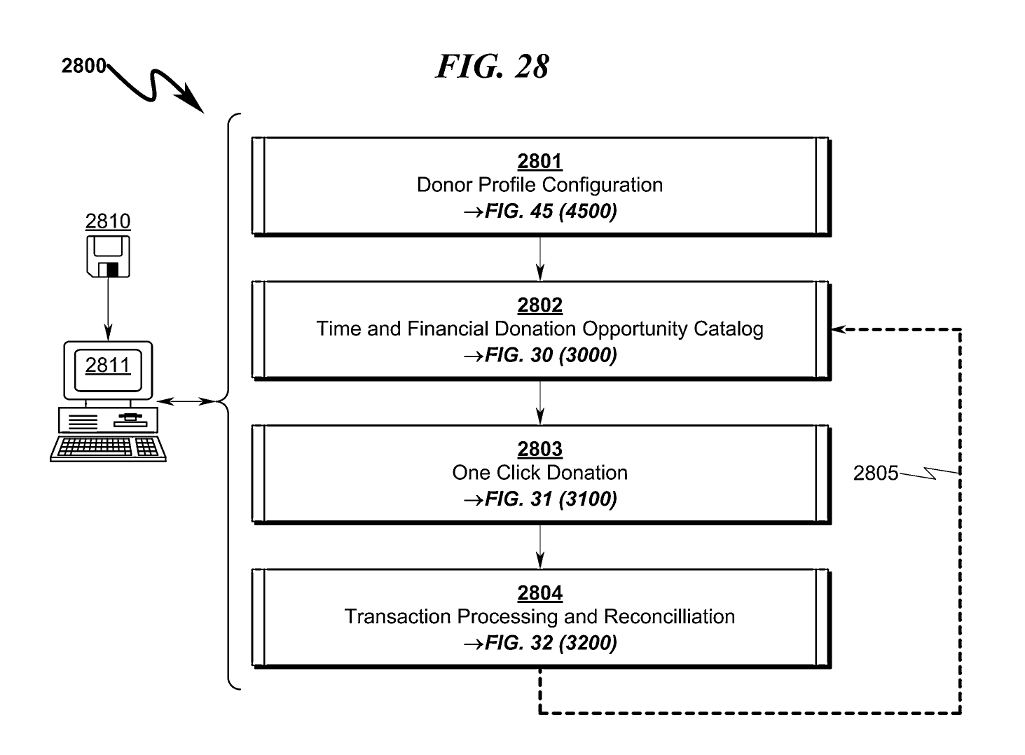

An overview of a preferred exemplary method embodiment of the present invention is depicted in the flowchart of FIG. 28 (2800). The web browser makes a request for a web page from the origin domain web server for the configuration of the donor profile (2801). The origin domain web page contains a catalog of time and financial donation opportunities (2802) which is retrieved and initialized by the web browser. The end user then selects a makes a one click donation on the web page and submitted (2803). The one click transaction is then processed and reconciled (2804).

### Exemplary Donor Profile Configuration Method (2900)

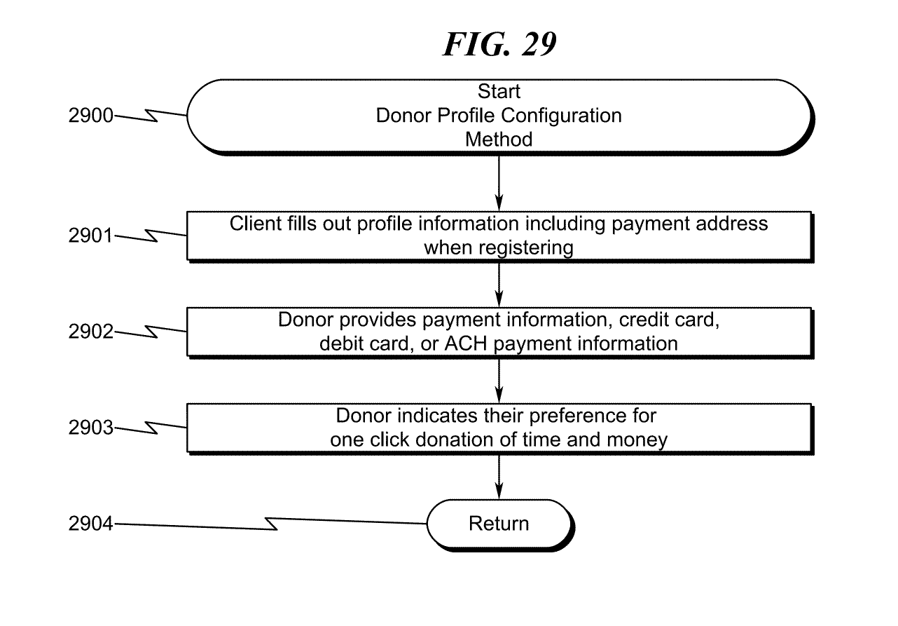

A preferred exemplary embodiment of a Donor Profile Configuration method useful within some embodiments of the present invention is depicted in the flowchart of FIG. 29 (2900). Client that wants to donate of time fills out profile information including payment address when registering on the organization website (2901). Then the donor provides payment information either credit card or ACH (2902). Donor then inputs their preferences of time and/or money they would like to donate to be saved as part of their profile (2903). The donor can then browse and shop the online catalog that contains opportunities to give of time or money (2904) and simply click once to select an opportunity and financial and time amount can automatically be applied based on the users already stored preferences.

### Time and Financial Donation Opportunity Catalog Method (3000)

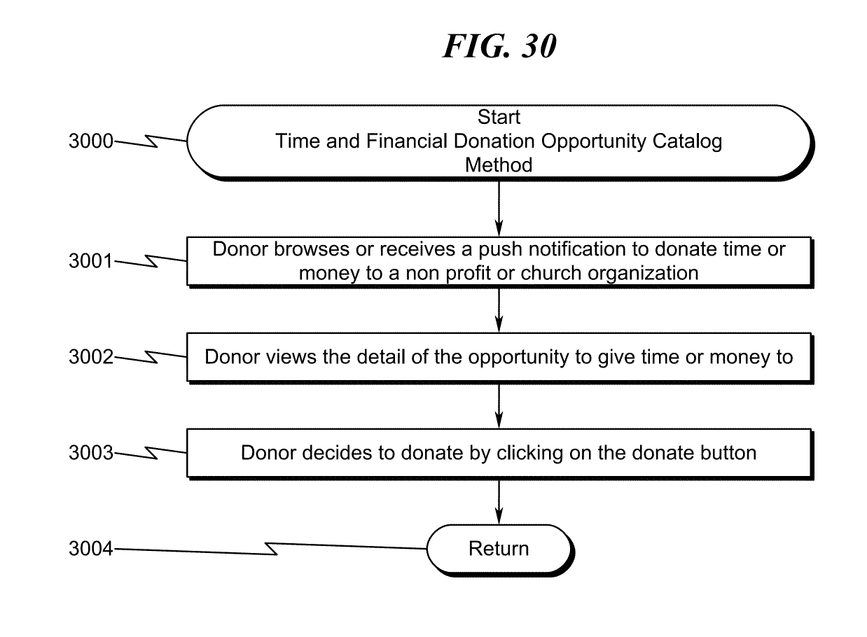

A preferred exemplary embodiment of a Time and Financial Donation Opportunity Catalog method useful within some embodiments of the present invention is depicted in the flowchart of FIG. 30 (3000). Donor browses on web or receives a push notification to request they donate time or money to an organization (3001). Then the donor views the detail of the opportunity to give time or money to (3002). The donor then makes the decision to donate by clicking on the donate button (3003).

### Donor Match to Organization Method (3100)

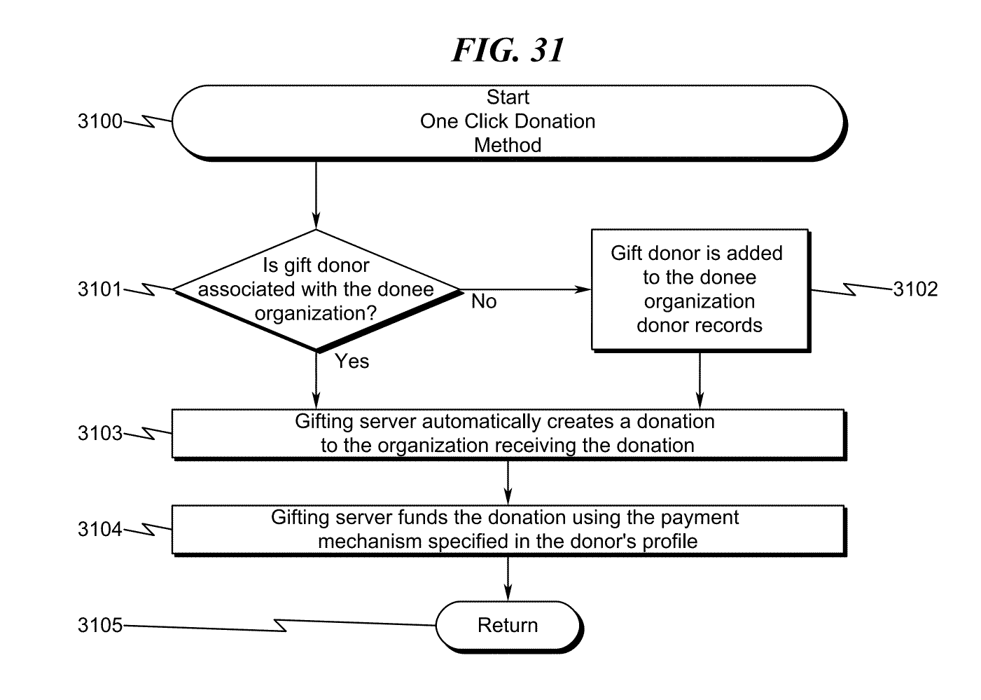

A preferred exemplary embodiment of a One-Click Donation/Donor Match to Organization method useful within some embodiments of the present invention is depicted in the flowchart of FIG. 31 (3100). The system checks if the donor is already associated with the organization (3101). If the donor is not associated with the organization then their information is added to the organization's donor records (3102). Once the donor is associated with the organization then the system automatically creates a donation to the organization (3103). Then the system funds the donation using the payment mechanism specified by the donor's preferences in their profile (3104). The transaction is then processed and reconciled (3005).

### Transaction Processing and Reconciliation Method (3200)

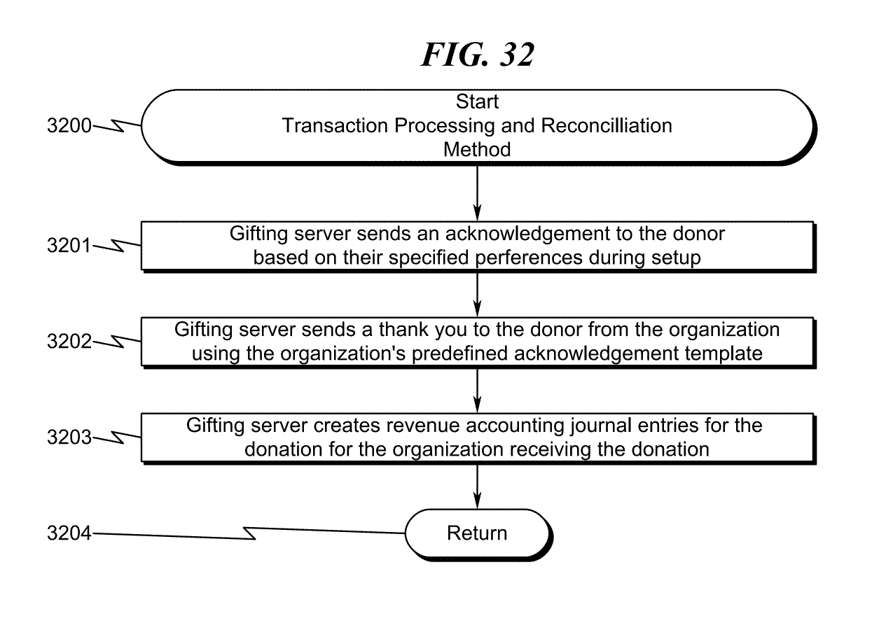

A preferred exemplary embodiment of a Transaction Processing and Reconciliation method useful within some embodiments of the present invention is depicted in the flowchart of FIG. 32 (3200). The system sends an acknowledgement to the donor based on their specified preferences during account setup (3201). The system then sends a thank you message to the donor from the organization based on the organizations predefined acknowledgement template (3202). The system then creates revenue accounting journal entries for the donation for the organization receiving the donation (3203).

### Preferred Financial Exemplary System Embodiment (3300)

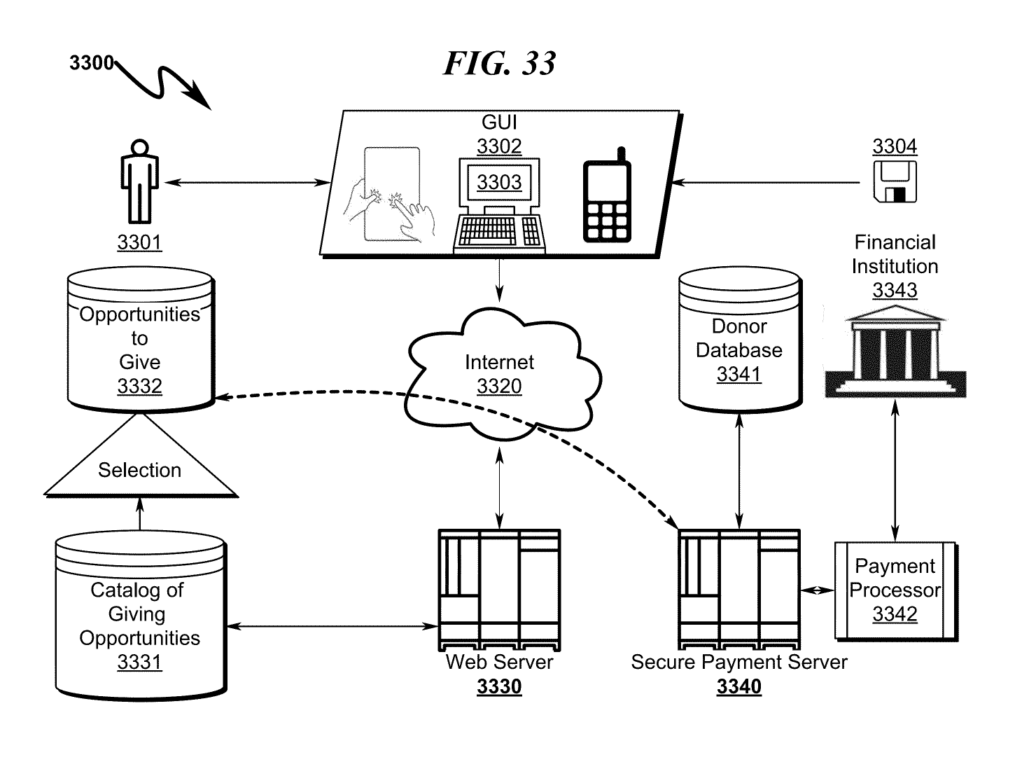

A preferred financial gifting exemplary system embodiment of the present invention is generally illustrated in FIG. 33 (3300). Within this context, a financial gifting donor (3301) interacts with a Graphical User Interface (3302) running on some form of a computerized device (3303) executing software read from a computer readable medium (3304) to access the Internet (3320). An opportunity to give (3332) is selected from the catalog of donation opportunities (3331) via the web server (3330). The donor (3301) then donates to the gifting opportunity by informing the gifting computing server (GCS) (3340) to affect the funds transfer. The donor payments information obtained from the donor database (3341) is then accessed via the secure payment server (3340) to obtain information necessary for the payments processor (3342) to affect funds transfer from the financial institution (3343) to the selected gift recipient.

A significant aspect of this architecture is that the sensitive financial information associated with the donor (3301) is not transmitted via the Internet (3320) but rather contained locally within the donor database (3341) and is accessed only by the secure gifting computing server (GCS) (3340). This information is securely accessed by the payment processor (3342) that deals directly with the financial institution (3343) to affect funds transfer to the gift recipient.

### Exemplary Donor Database Structure (1800)

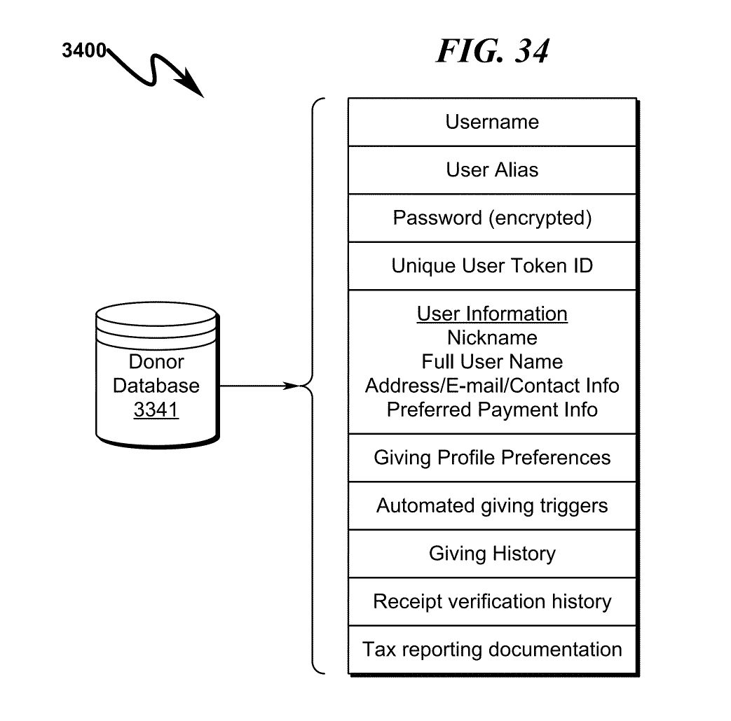

The donor database (3341) generally illustrated in FIG. 33 (3300) may have many forms, but an exemplary embodiment of the donor record structures associated with this database may be found in FIG. 34 (3400), wherein the donor information data may include, but is not limited to, the following information:
Username (3401);
User alias (3402);
Password (3403);
Unique User Token ID (3404);
User information, including user nickname, full user name, address/contact information, preferred payment information, etc. (3405);
Giving profile preferences (3406);
Automated giving triggers (3407);
Giving history (3408);
Giving receipt verification history (3409);
Tax reporting documentation (3410).

One skilled in the art will recognize that this donor database can have a wide variety of information and that the above list is only exemplary of this information content.

### One Click Donation (3500)

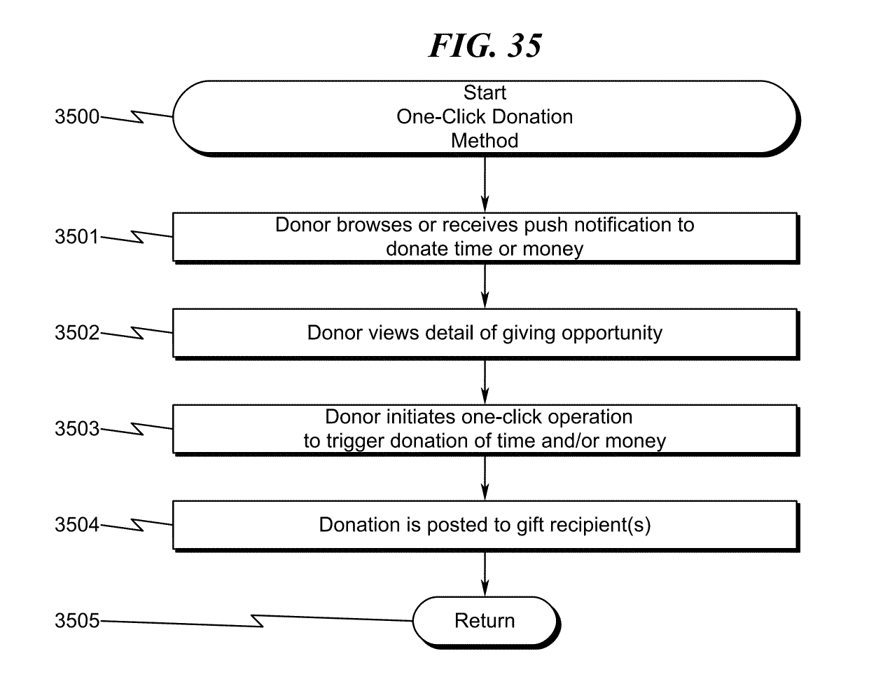

A preferred method for one click donation of the present invention is generally illustrated in FIG. 35 (3500). Donor browses or receives a push notification to donate time or money to an organization (3501). Donor then is able to view the detail of the opportunity to give time or money (3502). The donor then decides to donate by clicking the donate button (3503) and makes a one click donation to post the gift to the gift recipient(s) (3504).

### Donor Organization Association (3600)

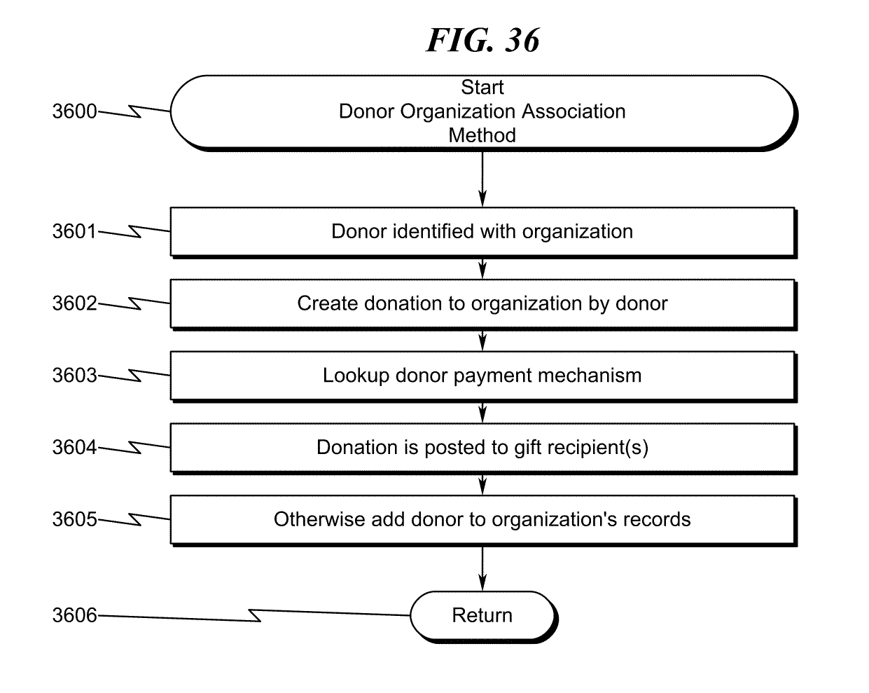

A preferred method for associating a donor with an organization of the present invention is generally illustrated in FIG. 36 (3600). If the system identifies the donor as associated with the organization (3601) then the system automatically creates a donation to the organization receiving the donation (3602). If the donor is not associated with the organization, then the donor is added to the organizations donor records (3603). The system then funds the donation using the payment mechanism specified in the donor's profile (3604). The transaction is then processed and reconciled (3605).

### Conditional Gifting System Embodiment (3700)

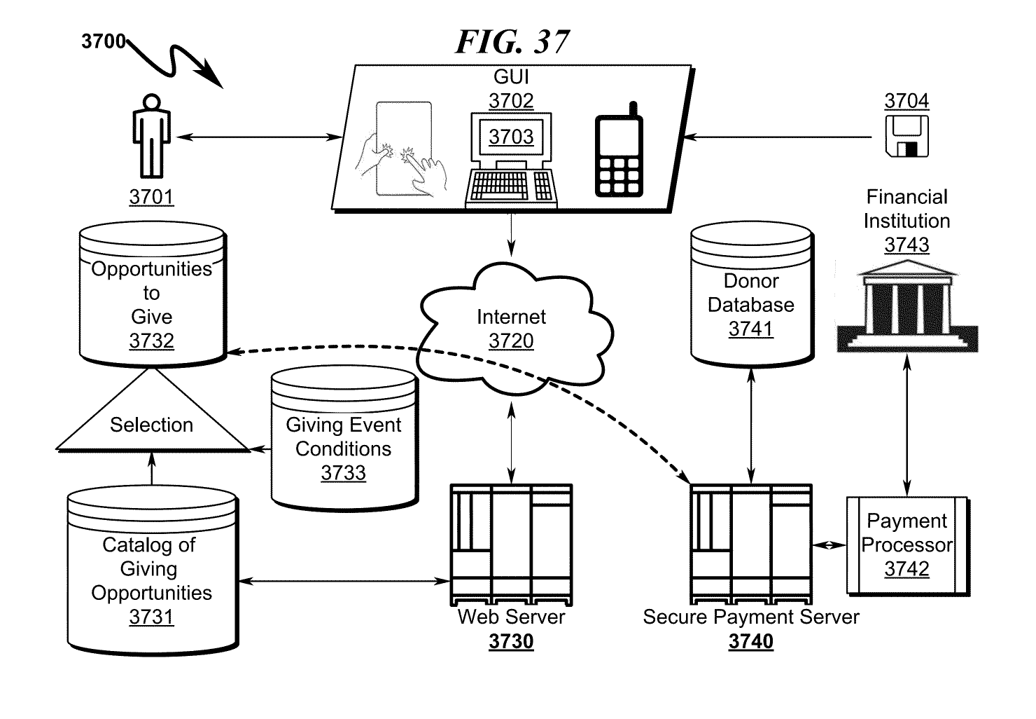

As generally illustrated in FIG. 37 (3700), the system embodiment of FIG. 33 (3300) may be augmented with a gifting event conditional trigger database (3733) that triggers selection of a gifting opportunity based on a wide variety of event triggers that may be periodic or based on gifting by others or associated “challenge” gifts. This database (2133) may incorporate Boolean operators or other complex functions to determine what is gifted, when it is gifted, and to what extent it is gifted. These external event conditions may even in some embodiments incorporate inspection of donor bank accounts and other information in determining the timing and extent of a given gift. A wide variety of gifting triggers is anticipated in the present invention and may include external events/states associated with a given gifting recipient. For example, gifting based on gifts given by others, time-driven gifts, revenue-driven gifts, etc.

### Conditional Gifting Method Embodiment (3800)

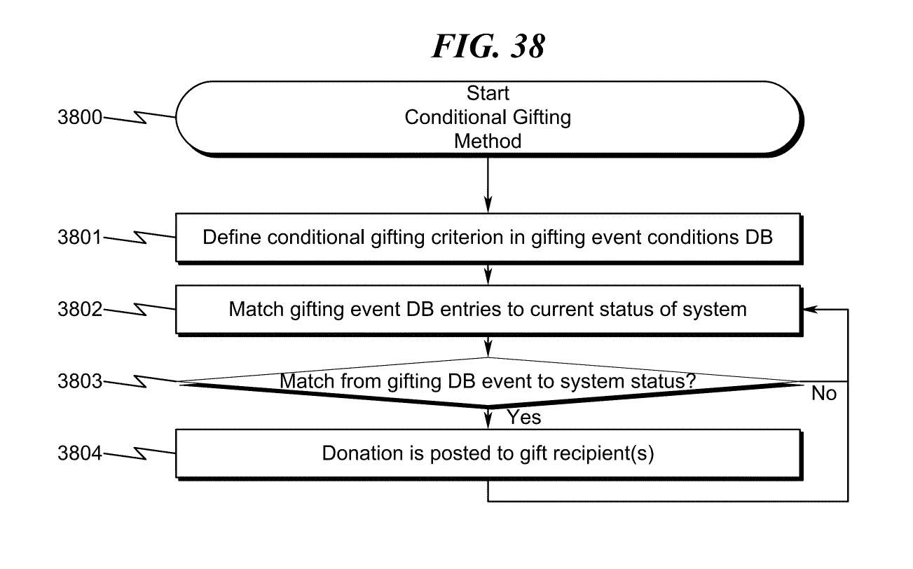

The conditional gifting system described in FIG. 37 (3700) may have an associated method as generally depicted in FIG. 38 (3800) wherein the conditional gifting event database is initialized with conditional gifts (3801), these events are matched to the current system status (3802), and if a match is found (3803), then the gift is posted to the gift recipient(s) (3804), otherwise control passes to additional gifting event conditions.

### Geospatial Gifting System Embodiment (3900)

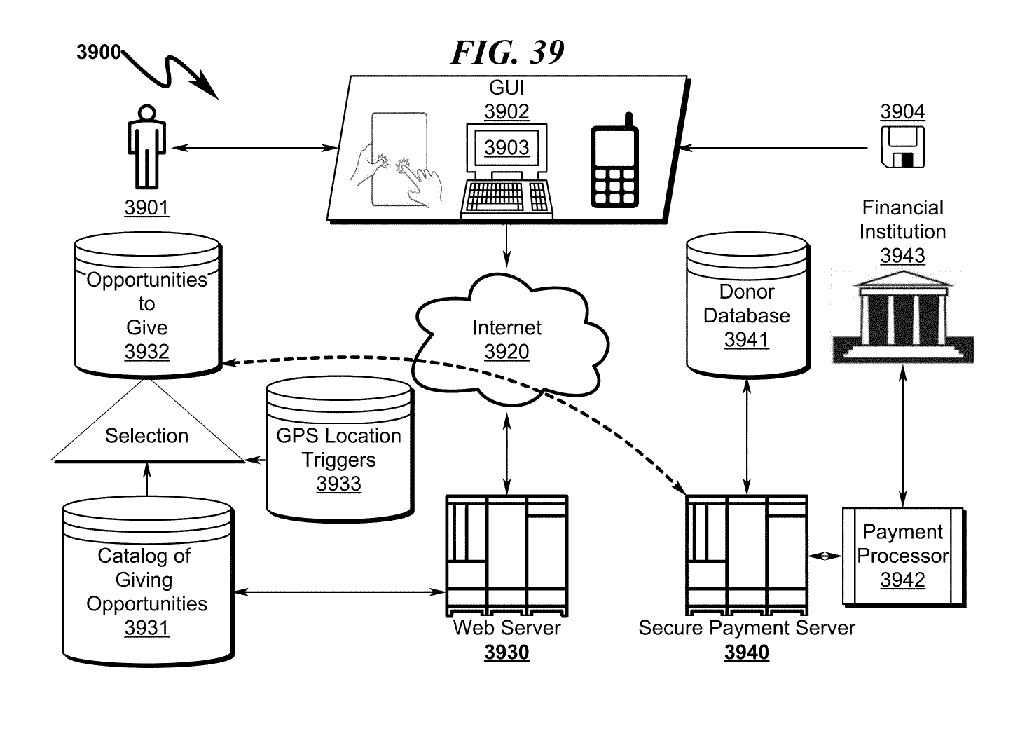

As generally illustrated in FIG. 39 (3900), the system embodiment of FIG. 33 (3300) may be augmented with a gifting geospatial triggering database (3933) that triggers selection of a gifting opportunity based on the location of the donor's GUI. This database (3933) may incorporate Boolean operators or other complex functions to determine what is gifted, when it is gifted, and to what extent it is gifted based on the GPS coordinates of the donor's GUI. These external event conditions may even in some embodiments incorporate tiered distance information and seasonal timing information in determining the timing and extent of a given gift.

### Geospatial Gifting Method Embodiment (4000)

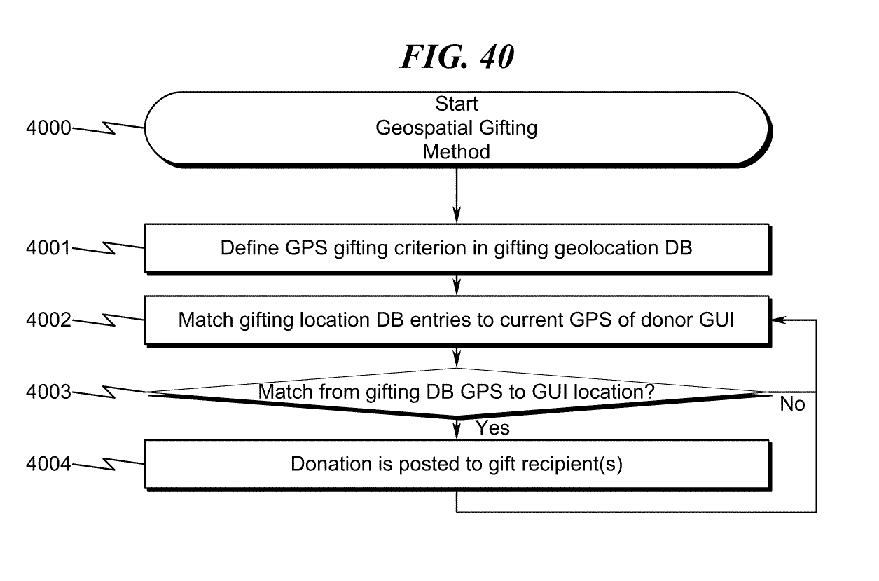

The geospatial gifting system described in FIG. 39 (3900) may have an associated method as generally depicted in FIG. 40 (4000) wherein the geospatial gifting event database is initialized with GPS locations (4001), these events are matched to the current GPS location of the donor GUI (4002), and if a match is found (4003), then the gift is posted to the gift recipient(s) (4004), otherwise control passes to additional gifting event conditions.

### Exemplary System Implementation Details (4100)-(4800)

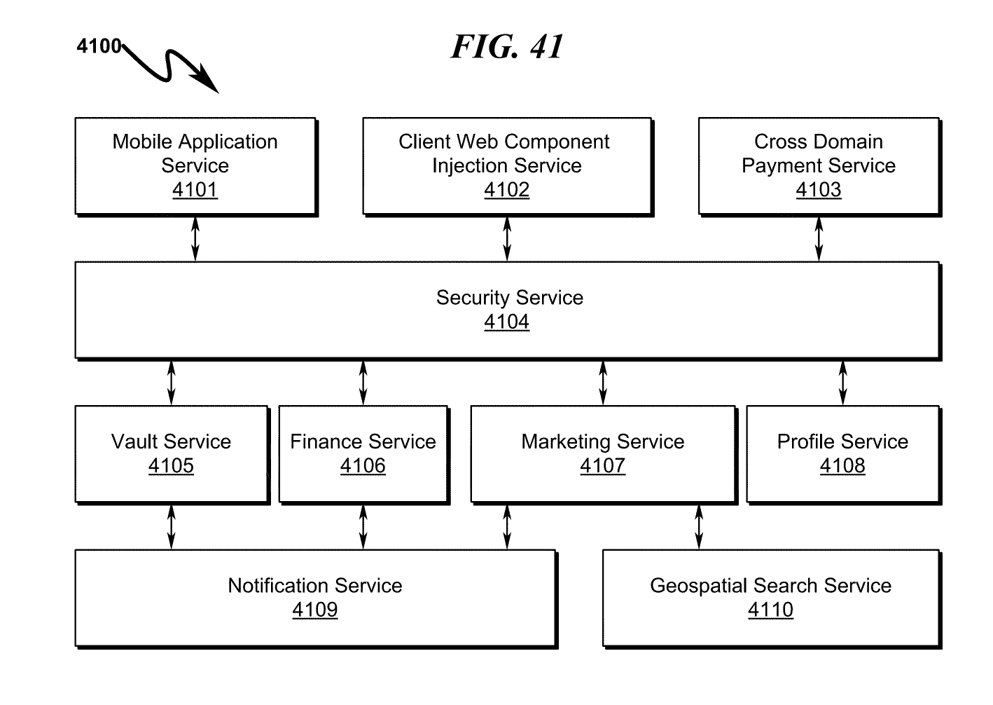

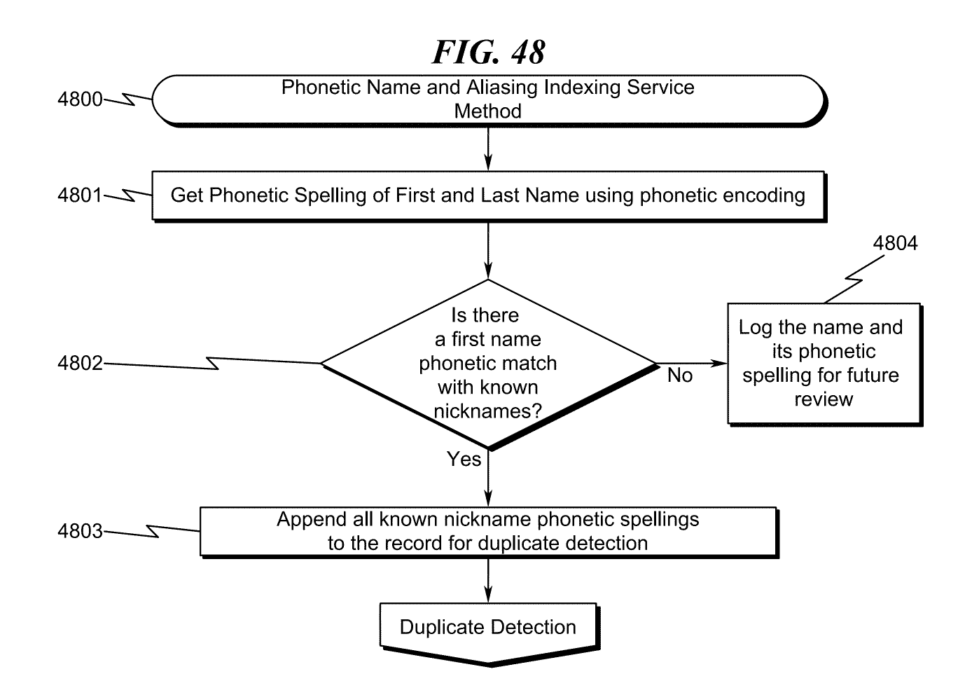

While the present invention may be implemented using a variety of graphical user interface (GUI) techniques, the exemplary system views and flowcharts depicted in FIG. 41 (4100)-FIG. 48 (4800) illustrate several details associated with one preferred embodiment of the present invention as applied to a mobile gift transaction processing system and method.

### Preferred Exemplary System Embodiment (4900)

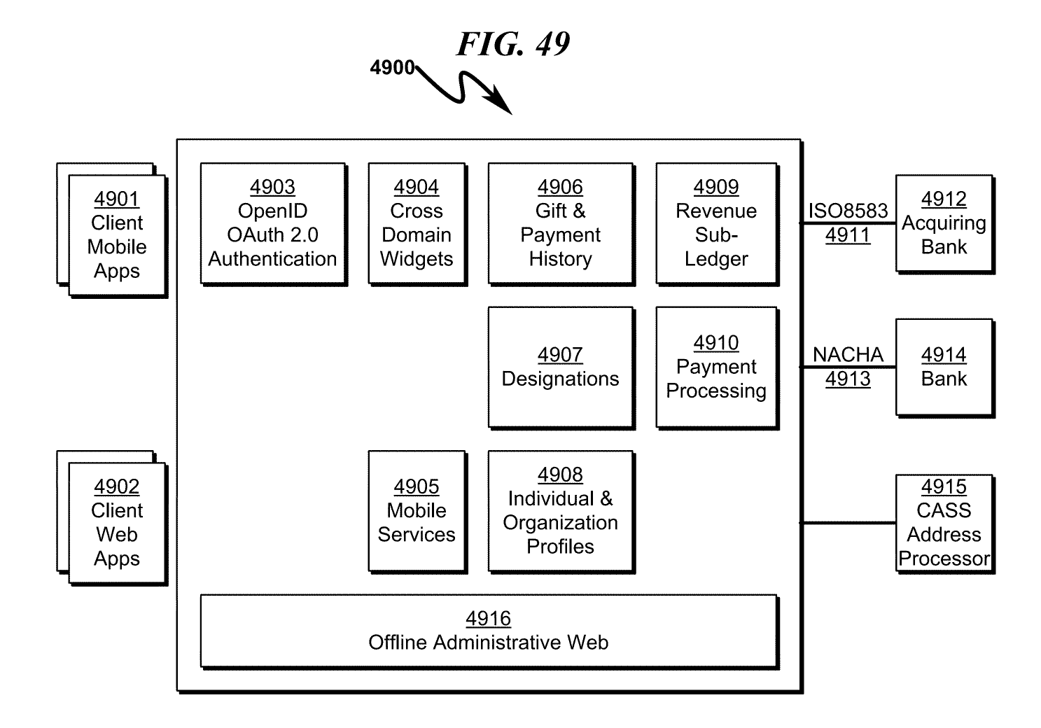

A preferred exemplary system embodiment of the present invention is generally illustrated in FIG. 49 (4900) and depicts a multi-channel gift processing system with embedded payment processing and an embedded revenue sub ledger. It provides organization specific mobile applications (4901) and supports organization specific websites (4902). It includes a donor web authentication service that supports OpenId, OAuth 2.0 and SAML authentication and authorization (4903). The integrated multi-channel gift processing supports the mobile applications via a set of mobile web services (4905). The multi-channel gift processing system also contains data tables and indexes for charitable transaction and charitable payment transaction history (4906) that is linked to the revenue sub ledger journal (4909) by foreign key relationship. It stores designations (donor intent) and associated marketing for designations and any account segment information related to designations, restrictions, and funds (4907). It stores individual and organization profiles and indexes of those profiles and their relationships to designations, and charitable transactions and charitable transaction payments (4908). All of the information stored by the multi-channel gift processing solution can be accessed through the offline administrative web site (4916).

Any payment processed via credit card or ACH is managed through the embedded payment processing (4910) which stores credit cards, bank accounts, authorizes and captures transactions, updates charitable payment history settlement and deposit status and allocates fees. The embedded payment processing communicates directly with the acquiring bank (4912) through a payment gateway or via ISO8583 messaging (4911). The embedded payment processing also communicates directly with the bank to via NACHA file transmissions to process donor transactions and to perform distribution of funds to clients related to payments processed (4914). Lastly, the system also has an integrated CASS address processor used to standardize and geo code every address prior to its being stored to make it a better tool for locating duplicates within the application (4915).

### Preferred Exemplary Data Structure for Individual Profile Contact Information (5000)

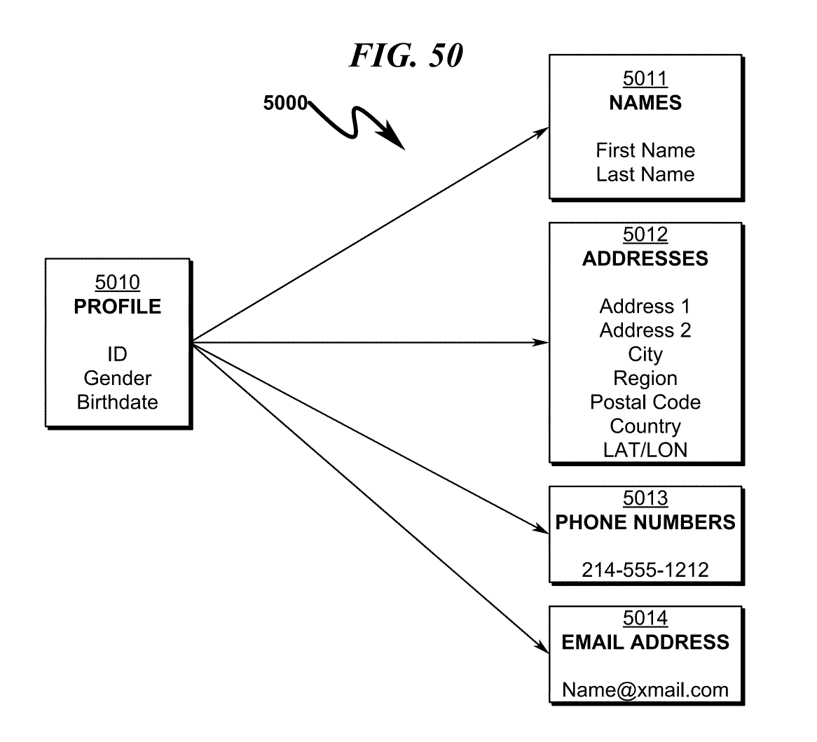

A preferred exemplary data structure for defining individual profiles is outlined in FIG. 50 (5000). One who is skilled in the art may have additional fields or contact information attached to the structure. An individual profile has an ID and some general information such as gender and birth date (5010). An individual profile may or may not have multiple first names and last names associated with the profile to provide nicknames, last name changes due to marriage, etc. (5011). An individual profile may or may not have multiple addresses for work, for home, for seasonal addresses (5012). This address structure should support the storage of latitude, longitude as well as a standardized address to be used to search for matching profile information (5012). An individual profile may contain multiple phone numbers that are associated with a profile (5013). The phone numbers should include a standardized phone number that can be used for searching profiles (5013). Lastly the information structure should provide a method to store multiple email addresses that can be associated with the individual profile (5014).

### Preferred Exemplary Data Structure for Individual Profile Contact Information (5100)

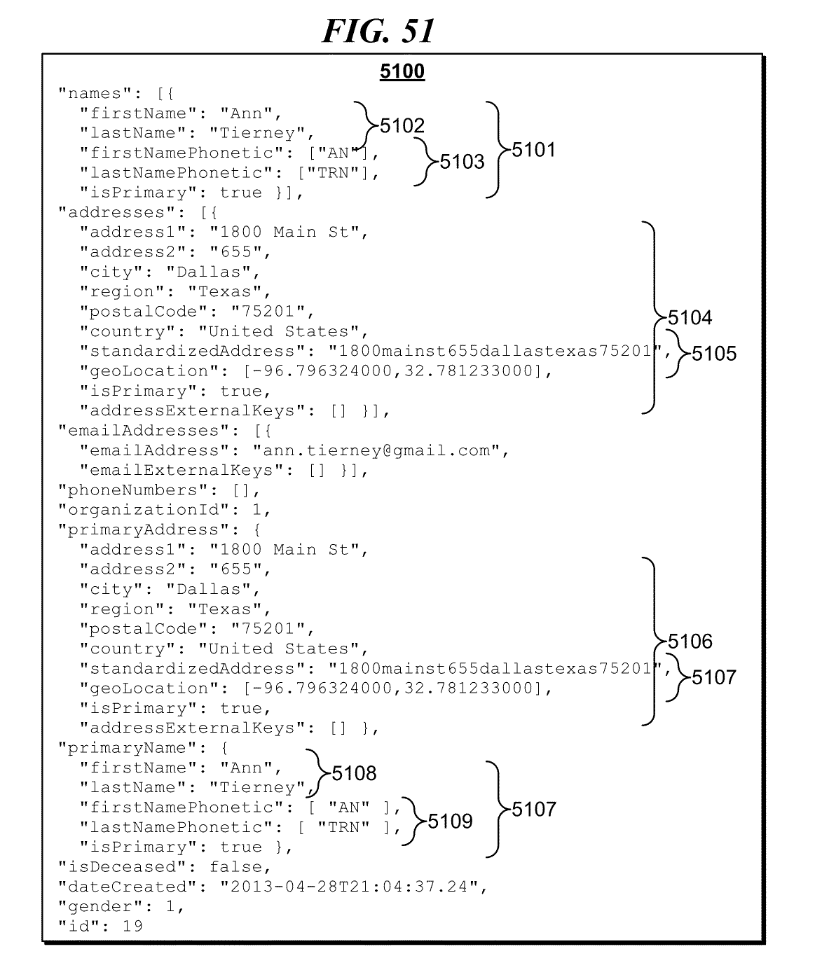

A preferred exemplary implemented index to the profile defined in FIG. 50 (5000) is presented in FIG. 51 (5100). One who is skilled in the art may make changes to the data structure to add additional fields that may be useful in the results or the storage of the fields but would use a similar structure that contains all of the relevant information necessary to score and match duplicate profiles. All of the names associated with the profile are stored in the index in an array of data structures (5101). Each name data structure contains first name, last name, (5102) and the complete set of phonetic indexes (5103) for all known first name variations for the first name and the last name. In the case of Ann it could be Anne or Annie all of which have the same phonetic index of ‘AN’ (5103). In addition to the names associated with the profile, the index structure would contain the addresses associated with the profile (5104). The address would contain a CASS standardized address key and geo location information to be used to match profiles (5105). The profile would also separately list the primary address (5106) and primary name (5108) used by the individual to allow scoring for primary to higher than old addresses and previous names. Each primary address would also have a standardized address key and geo location information (5107). Each primary name would also have the first and last name (5109) as well as the known first name phonetic indexes and last name phonetic indexes (5110).

### Preferred Exemplary Individual Profile Detection Method (5200)

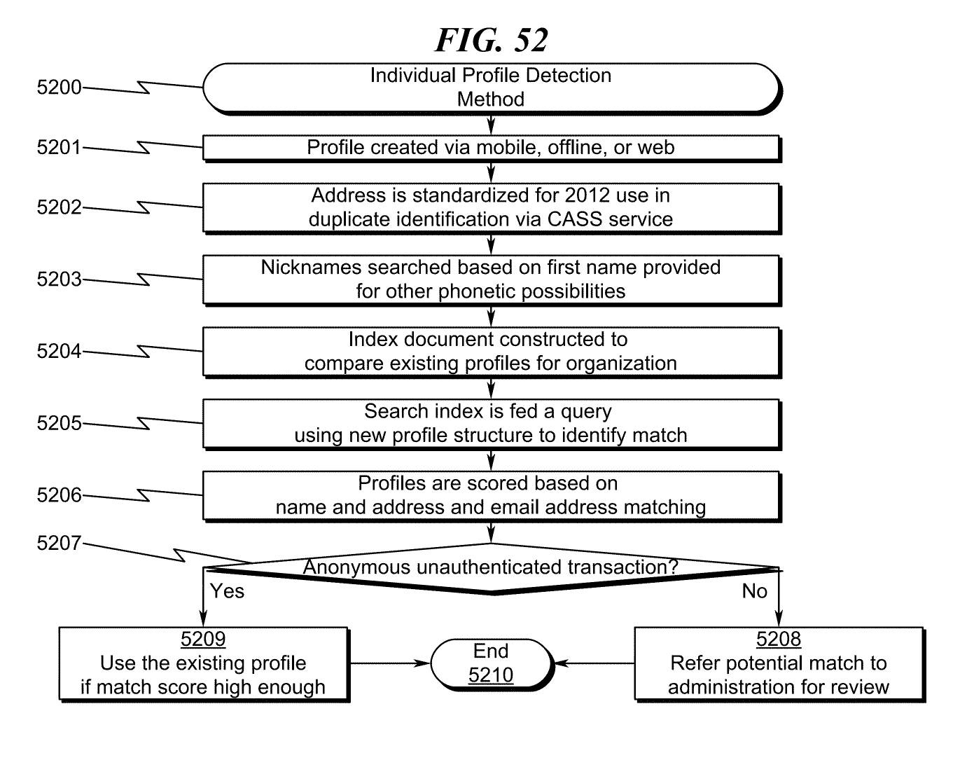

A preferred exemplary method for detecting individual profile duplicates or matching profiles with online charitable transaction payment information without the benefit of authentication for mobile and online transactions is presented in FIG. 52 (5200). The actual search queries and scoring assigned to components of the search could be altered by any who are skilled in the art. The actual search indexes and structures could be tuned to specific performance characteristics by any who are skilled in the art.

The first step in the process is to create an individual profile (see FIG. 50 (5000)) as a result of administrative input, file import, online checkout, mobile checkout that is to be used to create a query for potential matches and/or duplicates (5201). This structure would then have each of its addresses CASS standardized and geo coded via a CASS (see FIG. 49 (4915)) service (5202). The first name would be compared with the existing known aliases for first names which would append the unique phonetic indexes for those nicknames (5203). In the example of the first name of Bill, the phonetic indexes of Will, William, Willy, Billy would be added to the profile record (5203).

The data structure would then be used in a predefined query against a document search index that scores (5206) matches based on an exemplary scoring strategy of:
Highest—(first name, last name, email address, physical address, phone)
Higher—(first name phonetic, last name phonetic, email, physical address, phone)
High—(first name phonetic, last name phonetic, email)
Match—(first name phonetic, last name phonetic, address)
   The search index used in this fashion will allow a single query to be presented to the search index with standardized data and weighted scoring to match profiles. A further refinement of this approach is to score the primary contact information matches higher than the secondary contact information for names, email addresses, and addresses (5206). If the duplicate profile is part of an unauthenticated transaction (5207) the best matching profile that meets the minimum score criteria defined in the application is used in lieu of creating a new profile (5208). If the profile is being added through administrative function, i.e. offline gift entry or import and a match meets the minimum score threshold than the profile is marked as invalid due to potential duplicate detected and returned to the end user for validation (5209). Using a search index as compared to a database SQL query complete with standardized information, known aliases and phonetic names provides a much stronger much faster method of duplicate detection that makes it possible to use during all transactions with the gift processing system which is far superior to the previous art of wild card queries against a database. In addition the use of known first name aliases and phonetic indexes of names helps address the issue of mistyped names, capitalization issues, and having to add all of the potential alternatives to first name in order to find a duplicate or a match. Using a CASS standardized address as an additional key for matching profiles makes this method far more effective in narrowing and correctly identifying matching or duplicate profiles.

### Preferred Data Structure of Revenue Sub Ledger Account Design (5300)

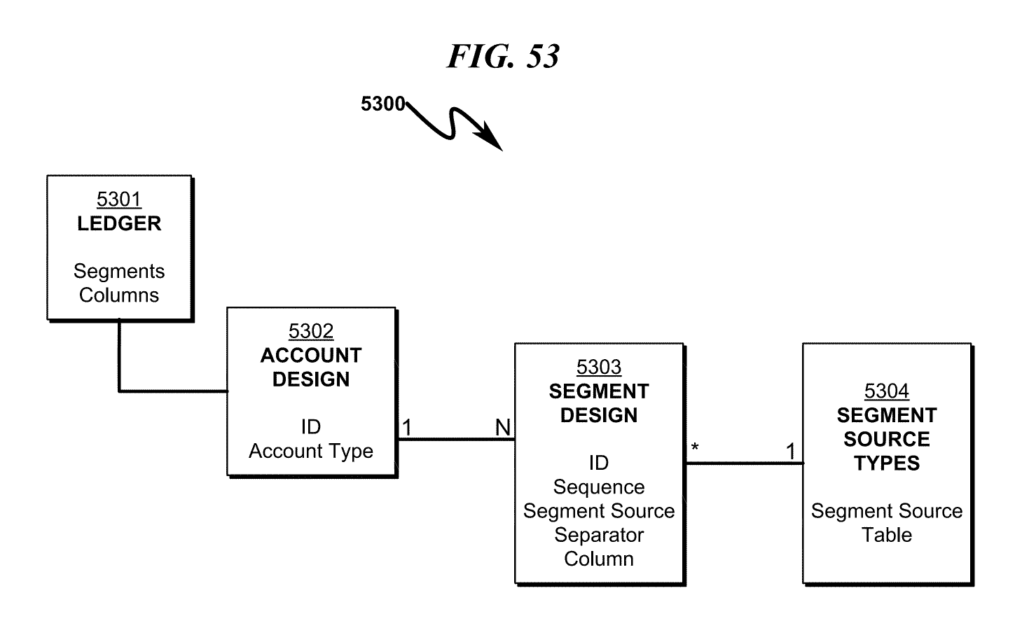

A preferred exemplary data structure for defining the account design of the revenue sub ledger is presented in FIG. 53 (5300). The concept of using a structured approach to designing a chart of accounts has been in practice for a number of years. However, typically the account numbers are created and then stored in the financial system and have to be populated in all of the transaction systems that eventually feed the ledger. Using a completely integrated revenue sub ledger allows the account number to be assembled based on the transaction as opposed to populating lookup tables or writing custom code to assign the account number to the journal entries being fed to the primary general ledger. The data structure used to store the design of the chart of accounts for the revenue sub ledger starts with the ledger design (5301) where we define the number of segments in our chart of accounts and the number of columns we expect in our feed of journal entries to the primary general ledger. The ledger design has a single account design for each of the account types (assets, cash, revenue, payables, receivables, expenses, etc.) (5302).

Each account design has the number of segments defined by the ledger associated with it (5303). Each segment design is associated with a segment source type (5304). Within each segment design a sequence number and column number, and optional separator is defined (5303). The segment design provides the sub ledger with the logic for which sources to read and how to assemble the account for each of the designs. Unlike traditional account design systems which require all of the accounts to be hand entered, once this design is complete, the chart of accounts in use by the application will be created as they are used.

### Example User Interface for Account Design (5400)

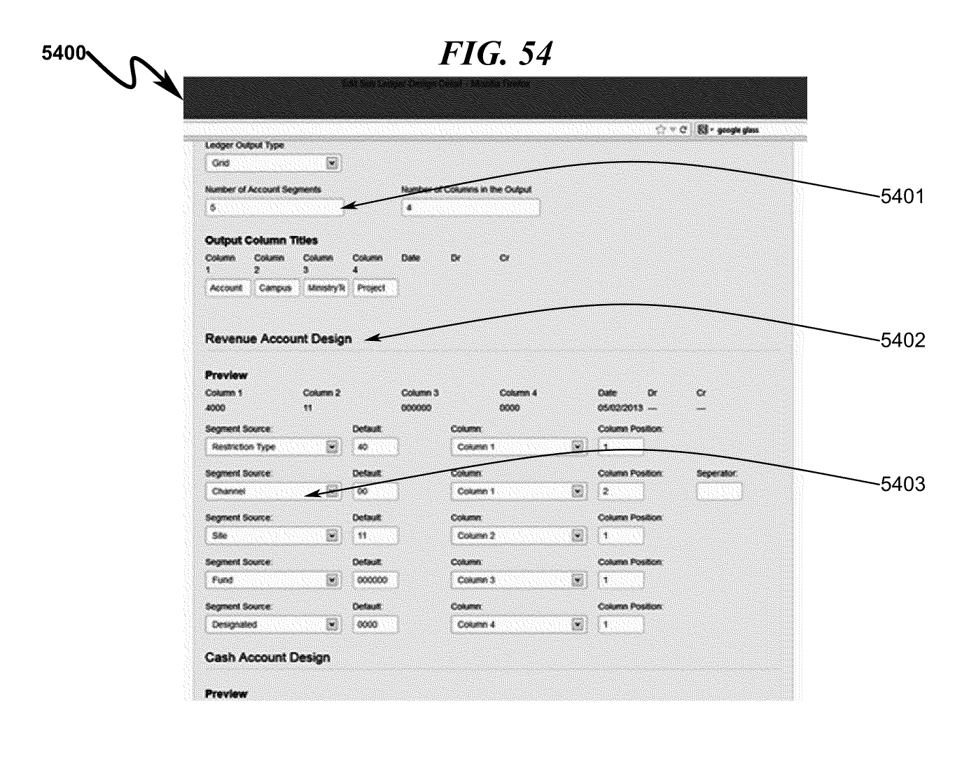

FIG. 54 (5400) provides an exemplary user interface for the Account Design process. The ledger segments and columns are defined first (5401). The account type design (5402) then has a number of segments where the source of the segment is selected, a column is selected a column position is selected and a separator is specified (5403).

### Exemplary Account Creation/Assignment Method (5500)

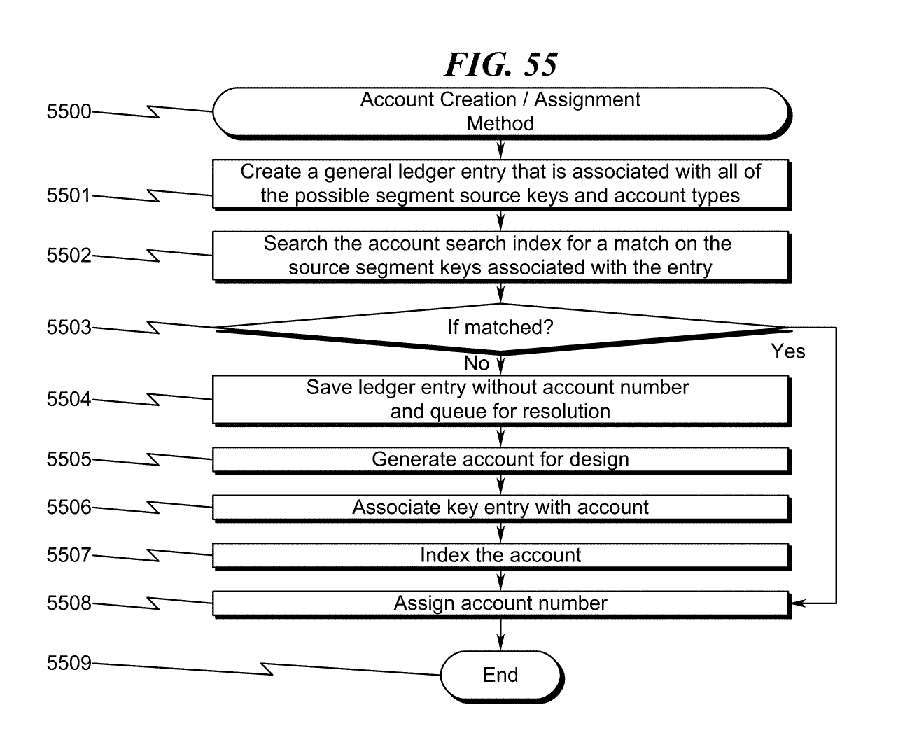

FIG. 55 (5500) illustrates an exemplary method of assigning or creating and assigning an account using a design based approach for the revenue sub ledger chart of accounts. First a ledger entry is created as part of a transaction set that is balanced (5501). The entry is associated with all of the potential sources of account segments in the application (5501). This allows for changes to be made to the chart of accounts and to calculate the adjustments from previous accounts to the new accounts that would be assigned to the ledger entry based on the redesigned chart of accounts. Using a search index of accounts a matching account is located using all of the potential keys. The account with the most matching keys is scored the highest and selected. This method of utilizing search allows transactions to be assigned to parents or children within the account structure without having to use recursive requests made to the account design. Without the use of the search index and scoring as the basis for assigning accounts the design based approach to account assignment would be too slow to use effectively (5502). If the account is matched (5503) then the account is assigned (5508). If the account is not matched, the ledger entry is saved without an account number and is queued for asynchronous account creation and assignment (5504). The ledger entry's account type is used to look up the design (5505). The design is interrogated for source segment locations and the keys associated with the ledger entry are used to look up and assemble the account (5506). The ledger entry is associated with the newly created account (5507). The account is added to the account index (5508).

Using this approach allows for ledger entries to always be saved regardless if an account design is complete, being changed, or does not exist ensuring the accuracy of the ledger once an account design is chosen. This approach also facilitates a nearly unlimited set of choices for how the gift account processing logic is assembled. If channel, payment method is used for one organization and restriction type, campus and designation is used for another, all of these choices can be setup and designed. In the case of a moderately sized organization with over 100 unique designations and 10 campuses and a five segment based design the potential account possibilities for revenue entries is over a thousand. Using this design approach all possible accounts can be serviced with a minimal set of data.

### Merchant Processing Payment Data Structure (5600)

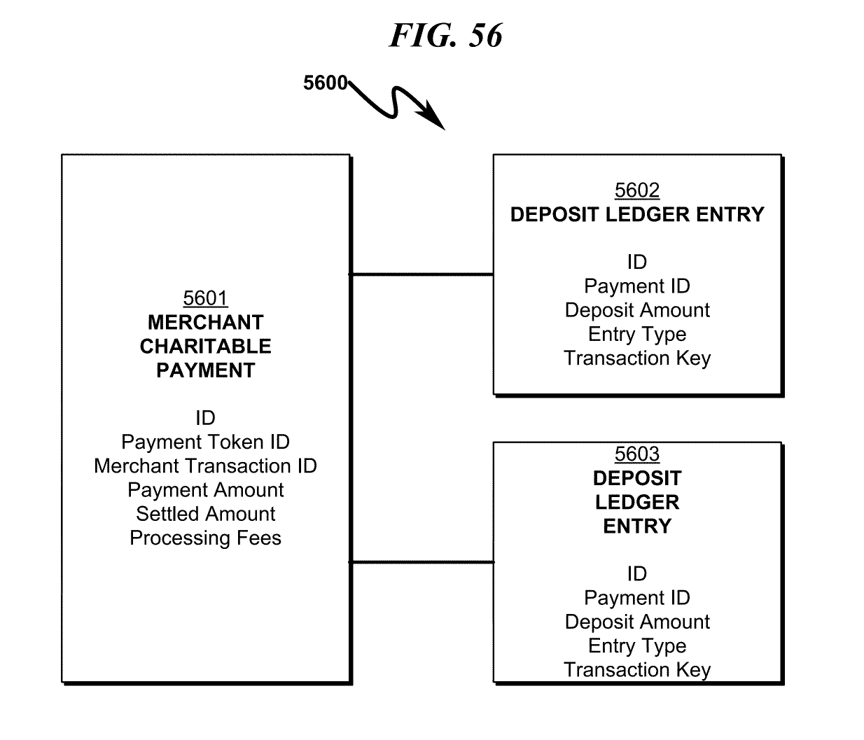

A preferred exemplary logical data model of merchant a charitable payment processing payment and its associated deposit ledger entries is presented in FIG. 56 (5600). The charitable merchant payment must have three dates (5601):
Payment Date—Date the payment was made.
Settlement Date—Date the payment is to be settled
Deposit Date—Date the payment was deposited in the organization's bank account
   The charitable merchant payment must have three amounts to support reporting and reconciliation (5601):
Payment Amount—Original payment amount
Settlement Amount—Settlement amount, the amount deposited in the account net of fees.
Fee Amount—The fees assessed on the merchant payment.
   The charitable merchant payment must be associated with the deposit ledger entry (5602). The settled amount is the amount of the deposit ledger entry. The charitable merchant payment is also associated with the payment fee ledger entry (5603). The fee amount on the payment is the amount of the fee ledger entry.

### Merchant Processing Charitable Transaction Initiation and Settlement Method with Financial Accounting (5700)

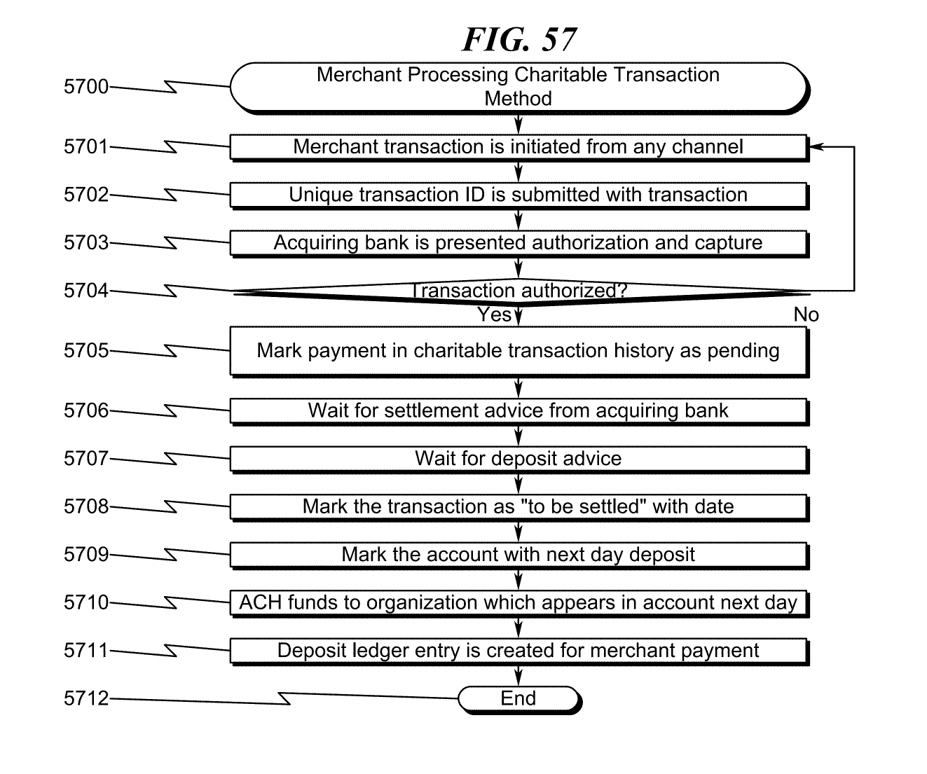

A preferred exemplary method of a merchant processing initiation and settlement with financial accounting is presented in FIG. 57 (5700). A merchant processing transaction is initiated from any channel (5701). The system assigns a unique transaction id which will be submitted with the payment to the acquiring bank (5702). The system submits the transaction to the acquiring bank for authorization and capture (5703). If the transaction is authorized (5704) the charitable payment transaction for the organization is marked as pending settlement (5705). The system will be monitor the acquiring bank transaction logs for information regarding the status of the transaction (5706). The transaction will be marked as settled with the date provided by the acquiring bank (5707). The system will then monitor the acquiring bank's transaction log for deposit advice (5708). Once the deposit date is provided, the transaction will be marked with the deposit date, updated with the settlement amount, and updated with the fee amount and an ACH will be initiated to fund the client's account (5710). A deposit ledger entry is created and associated with the payment for the settled amount and a fee ledger entry is created for the difference in the settled amount and the payment amount (5711).

### Exemplary Data Model for Joint Fundraising Efforts (5800)

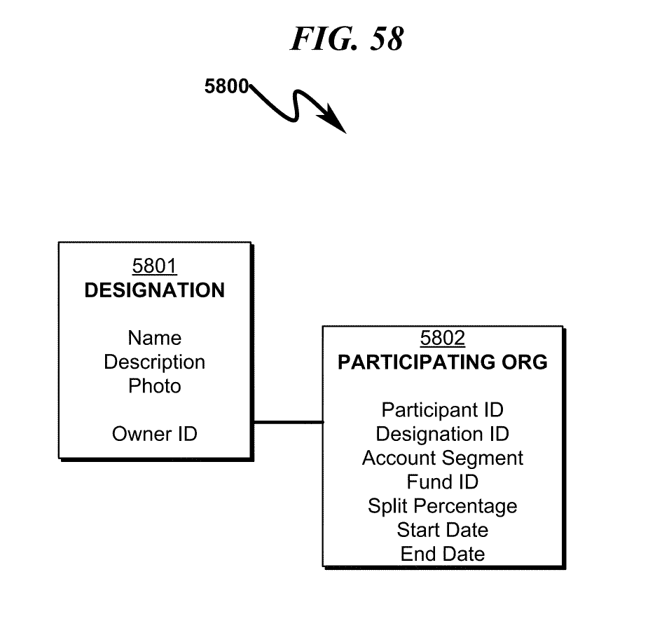

An overview of a preferred exemplary logical model the data used to support the configuration of joint fundraising is presented in FIG. 58 (5800). The accounting logical model for joint fundraising is based on the account design specified in FIG. 53 (5300). A table that contains a link to photos, a description, a name, an owner id and other related marketing information that is to be shared between organization provides the shared information to support each organizations fundraising efforts (5801). A second table provides a list of participating organizations, their account segments, fund choices, a percentage split of the proceeds, a start date and potentially an end date for participating in the joint fundraising program (5802). Only the controlling organization has the authority to change the participating organizations based on their being the owner defined in (5801).

### Exemplary Joint Fundraising Invite Method (5900)

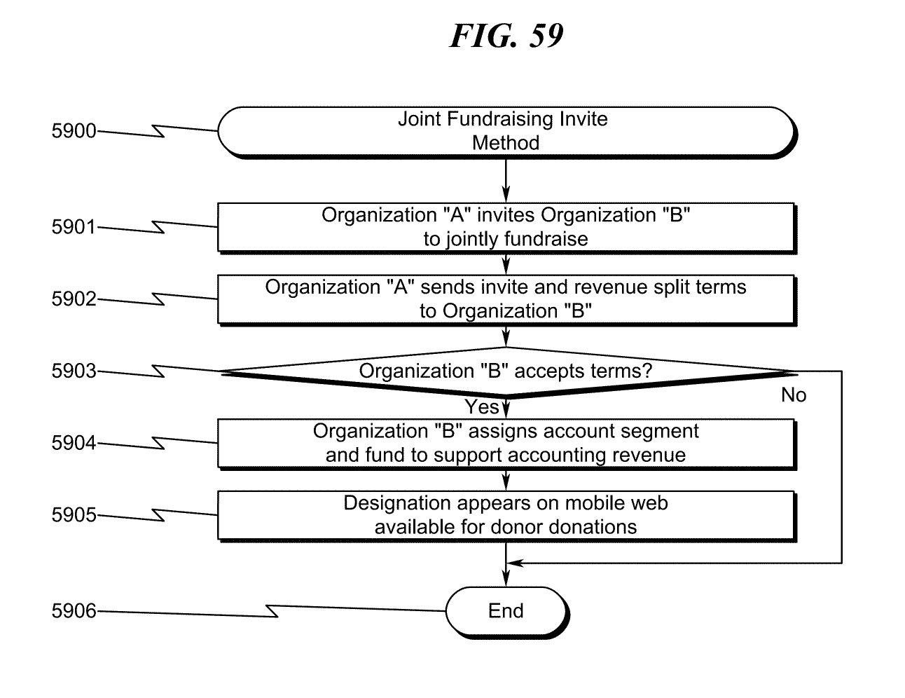

An overview of a preferred exemplary method for an organization to invite another organization to joint fundraise is presented in FIG. 59 (5900). Organization A invites organization B to joint fundraise (5901). Organization A initiates an invitation in the system for the designation being worked on jointly with a defined percentage of proceeds to be shared (5902). Organization B can choose to accept or reject organization A's invitation to participate (5903). If organization B accepts, organization B defined an account segment for the designation and assigns a fund to the designation for financial accounting purposes (5904). The system automatically makes the designation and its associated marketing that was defined by organization A available in organization B's website, mobile giving application (5905).

### Exemplary Joint Fundraising Invite and Acceptance User Interface (6000)-(6100)

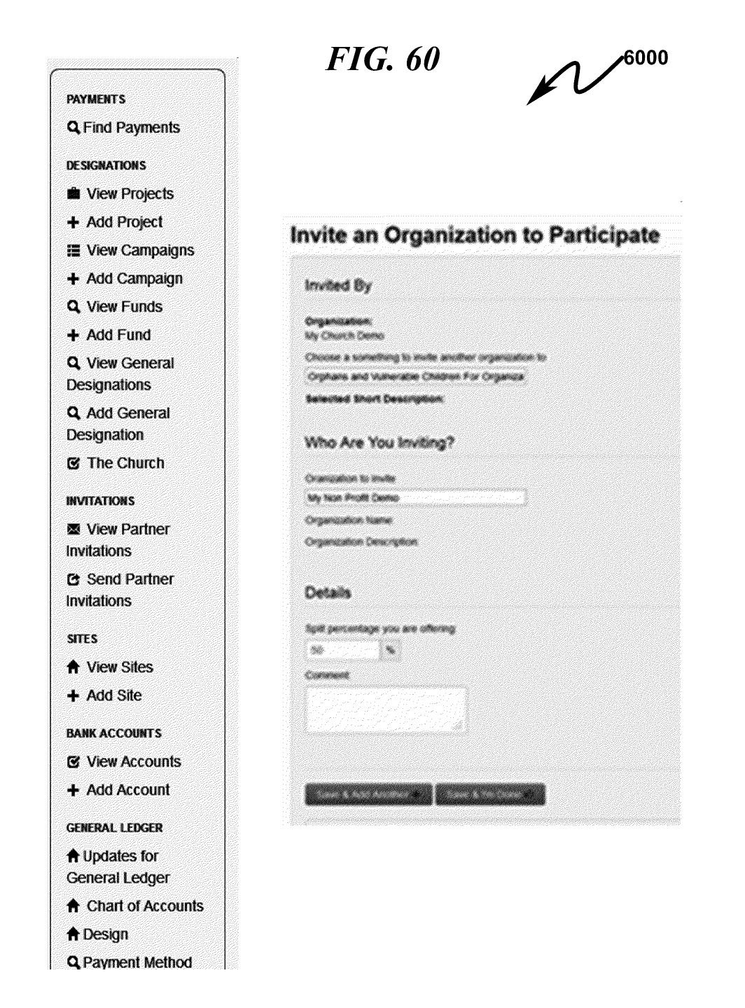

FIG. 60 (6000) provides an exemplary user interface for the invite and acceptance user interface. The user logs into organization “A” (e.g., MyChurchDemo) to in the multi-tenant multi-channel SAAS solution and chooses to invite organization “B” (e.g., MyNonProfitDemo) (6000). Organization “B” (e.g., MyNonProfitDemo) can see the invitations that have been made to it and select to accept or reject the invitation from organization “A”.

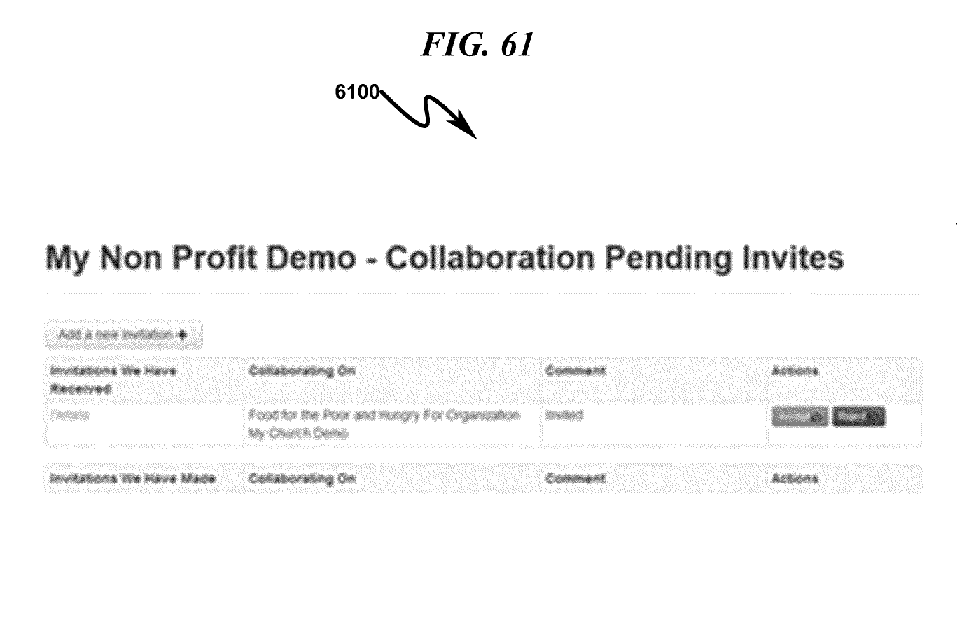

Status information regarding the pending collaborative giving invites may be displayed in a user interface dialog similar to the exemplary display depicted in FIG. 61 (6100).

### Donation Received for Joint Fundraising Method (6200)

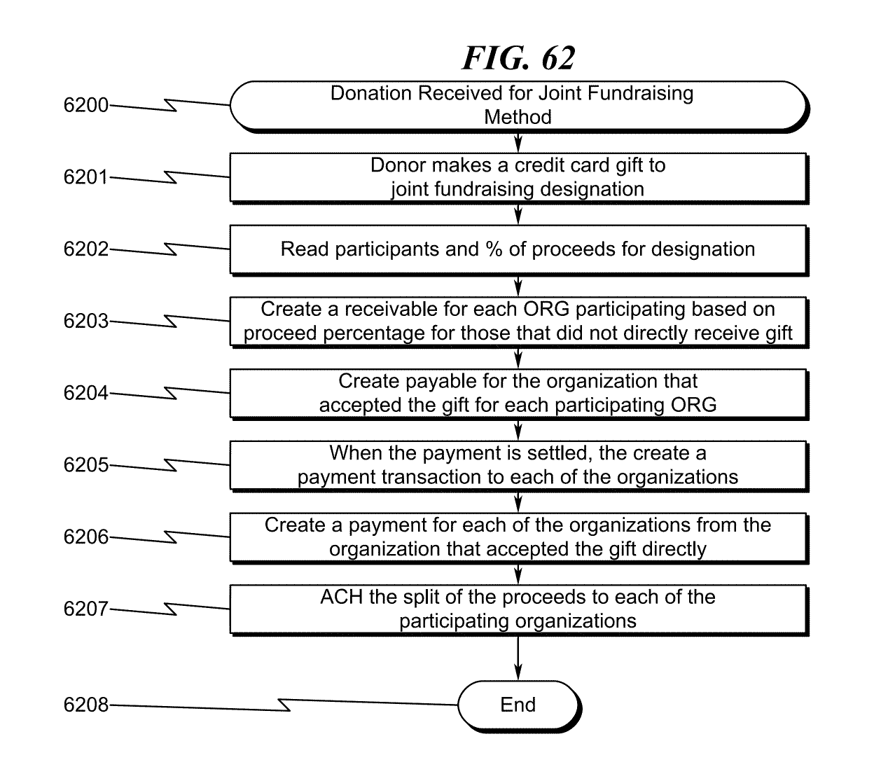

A preferred exemplary method for handling a donation to a joint fundraising designation is presented in FIG. 62 (6200). The donor makes a donation to the joint fundraising designation (6201). The system reads the data model defined in FIG. 58 (5800) to determine how the proceeds of the gift should be divided amongst the participants (6202). The system then creates a receivable for each organization that did not directly accept the gift from the donor from the organization that did directly accept the gift (6203). The system creates a payable for each organization participating in the joint fundraising effort based on the percentage split in the organization that directly accepted the gift from the donor (6204). As a result, at the time of the gift each of the participating organizations knows exactly how much has been raised and what their portion of the proceeds are. The system then waits for the payment to be deposited (6205).

After the payment has been deposited the system creates a charitable payment transaction in each of the participating organizations that did not directly accept the gift from the donor from the organization that did directly accept the gift for their percentage of the proceeds (6206). The system also creates a payment transaction to each of the organizations that did not directly accept the gift in the organization that did directly accept the gift's sub ledger (6208). The system also then ACH's the funds from the organization that accepted the donor gift directly to each of the organizations participating in the joint fundraising designation (6209). Using this method the accounting and the treasury functions are completely automated for all participating organization in the joint fundraising effort.

### Exemplary Payment Processing Reports (6300)-(6400)

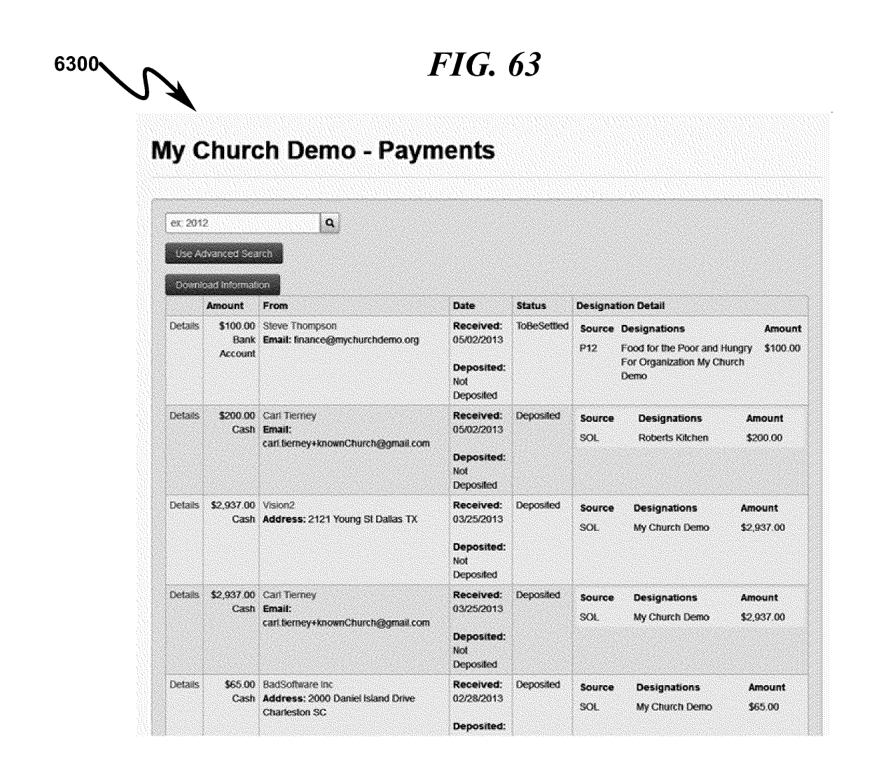

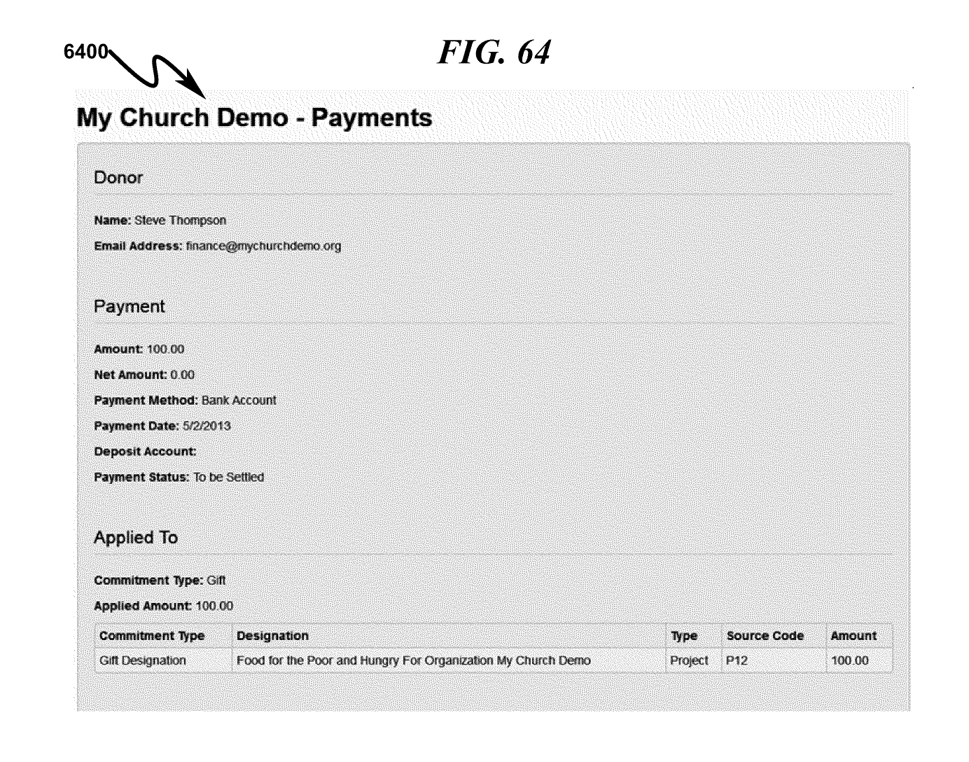

While a wide variety of user interfaces may be utilized within the present invention, several payment processing reporting screens are generally depicted in FIG. 63 (6300) (general report) and FIG. 64 (6400) (detail report).

### GPS Geolocation Gifting Opportunity Catalog Restriction

In various preferred exemplary embodiments the present invention may permit the donor to interact with a GUI embodied on a variety of computerized hardware to select a gifting opportunity from a catalog of gifting opportunities. Within this context the present invention specifically anticipates that the GPS coordinates of the GUI may be utilized to narrow the scope of gifting opportunities presented to the donor based on the physical GPS geolocation of the donor/GUI combination. Thus, in this scenario the donor may be presented with gifting opportunities (financial or non-financial) that are local to his/her location.

### Non-Financial Gifting

The present invention anticipates that some invention embodiments may be associated with non-financial gifting, such as the gifting of time, services, objects, products, discounts, etc. In this fashion the present invention may be used as a “hub” for gifting of monetary/non-monetary resources to non-profit and other organizations that may have need of items other than (or in addition to) cash and cash equivalents. For example, the present invention may be used to schedule the donation of time to a non-profit organization on a one-time or recurring basis, and may be used to match non-financial “needs” of the organization to services and other non-financial assets that donors may wish to contribute.

### System Summary

The present invention system anticipates a wide variety of variations in the basic theme of construction, but can be generalized as a gift transaction processing system comprising:
(a) gifting computing server (GCS);
(b) gifting database (GDB); and
(c) donor database (DDB);
wherein
the GCS is configured to interact with a donor via a graphical user interface (GUI) to establish identification information about the donor in the DDB;
the GCS is configured to associate the identification information with a donor ID token stored in the DDB;
the GUI is configured to allow the donor to select a gifting opportunity from a gift opportunity catalog (GOC) contained in the GDB;
the GCS is configured to transmit information on the selected gifting opportunity and the donor ID token constituting a gifting transaction to the GUI for display to the donor;
the GCS is configured to permit acceptance of the gifting transaction on the GUI display by the donor;
the GCS is configured to affect a financial transaction wherein funds are transferred from financial accounts associated with the donor to financial accounts associated with the gift recipient of the selected gifting opportunity;
the GCS and the GUI are embodied in one or more computer systems executing software retrieved from a tangible non-transitory computer readable medium; and
the computer systems are linked via a computer network.

This general system summary may be augmented by the various elements described herein to produce a wide variety of invention embodiments consistent with this overall design description.

### Alternate System Summary

The present invention system in the alternative may incorporate gifting of non-financial transactions and anticipates a wide variety of variations in the basic theme of construction, but can be generalized as a gift transaction processing system comprising:
(a) gifting computing server (GCS);
(b) gifting database (GDB); and
(c) donor database (DDB);
wherein
the GCS is configured to interact with a donor via a graphical user interface (GUI) to establish identification information about the donor in the DDB;
the GCS is configured to associate the identification information with a donor ID token stored in the DDB;
the GUI is configured to allow the donor to select a gifting opportunity from a gift opportunity catalog (GOC) contained in the GDB;
the GCS is configured to transmit information on the selected gifting opportunity and the donor ID token constituting a gifting transaction to the GUI for display to the donor;
the GCS is configured to permit acceptance of the gifting transaction on the GUI display by the donor;
the GCS is configured to affect a non-financial transaction wherein non-financial assets are transferred from non-financial accounts associated with the donor to non-financial accounts associated with the gift recipient of the selected gifting opportunity;
the GCS and the GUI are embodied in one or more computer systems executing software retrieved from a tangible non-transitory computer readable medium; and
the computer systems are linked via a computer network.

This general system summary may be augmented by the various elements described herein to produce a wide variety of invention embodiments consistent with this overall design description.

### Alternate System Summary

Yet another alternate present invention system variation may be generalized as a multi-tenant multi-channel gift transaction processing system comprising:
(a) gifting computing server (GCS);
(b) revenue sub-ledger (RSL);
(c) payment processing system (PPS);
(d) CASS address standardization system (ASS); and
(e) search index of individual profiles (SIP);
wherein
the GCS is configured to interact with a donor via a graphical user interface (GUI) to accept charitable transactions and payments;
the SIP comprises individual donor identification information stored in a donor database with donor search indexes;
the GCS is configured to identify said donor via said SIP and generate an identifier associated with said donor using said ASS;
the GCS is configured to identify and match profiles within said SIP utilizing a combination of name, phonetic name indexes, nicknames, standardized addresses and score-based matching to identify existing profile records which may be a duplicate;
the GUI allows an organization to define chart of account designs (COD);
the PPS is configured to facilitate payment processing, reconciliation, accounting for charitable transactions, and accounting for merchant processing related payments between said donor and said organization based on said COD;
the GCS is configured to update said RSL based on the completion of financial transactions between said donor and said organization;
the RSL is configured to allow the organization to assemble an account according to a design that matches a gift recipient chart of account design;
the GCS, RSL, PPS, ASS, SIP, and GUI are embodied in one or more computer systems executing software retrieved from a computer readable medium; and
the computer systems are linked via a computer network.

This general system summary may be augmented by the various elements described herein to produce a wide variety of invention embodiments consistent with this overall design description.

### Method Summary

The present invention method anticipates a wide variety of variations in the basic theme of implementation, but can be generalized as a gift transaction processing method comprising:
(1) establishing a donor database (DDB) comprising donor information;
(2) receiving a gift selection request from a donor via a graphical user interface (GUI) that associates a donor ID token with a donation request selected from a gift opportunity catalog (GOC) resident on a GDB;
(3) displaying the gift selection request and the donor information to the donor for acceptance by the donor; and
(4) processing acceptance of the gift selection request by a gifting computing server (GCS) to affect a financial transaction wherein funds are transferred from financial accounts associated with the donor to financial accounts associated with the gift recipient of the donation request;
wherein
the donor information comprises the donor ID which represents a unique identification for the donor associated with the donor information;
the steps are performed by one or more computer systems executing software retrieved from a computer readable medium; and
the computer systems are linked via a computer network.

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the financial transaction is selected from a group consisting of: credit card transactions; debit card transactions; and ACH transactions.
An embodiment wherein the GCS receives the donor ID token and the donor acceptance and processes a financial transaction on behalf of the donor associated with the donor ID token to affect transfer of funds from a financial institution to the donee gift recipient of the gifting opportunity.
An embodiment wherein the computer network comprises the Internet.
An embodiment wherein the DDB comprises a history of gifting by the donor.
An embodiment wherein the DDB comprises receipt verification for each gift donated by the donor.
An embodiment wherein the GCS comprises a secure transaction processing system.
An embodiment wherein the GDB is resident on the GCS.
An embodiment wherein the GUI is embodied in computerized hardware selected from a group consisting of: mobile phone; smartphone; tablet computer; laptop computer; and desktop computer.
An embodiment wherein the GOC is restricted based on the GPS coordinates of the GUI.
An embodiment wherein the DDB comprises a plethora a of the donor ID tokens, the donor ID tokens being individually mapped to an entry in the GOC.
An embodiment wherein the GCS is configured to allow the selected gifting opportunity to be associated with multiple gift recipients.
An embodiment wherein the GCS is configured to allow the selected gifting opportunity to be associated with multiple gift recipients wherein each of the multiple gift recipients is apportioned a percentage of the financial transaction according to data stored in the GDB.
An embodiment wherein the GCS is configured to generate a push notification to the donor to solicit a specific gifting opportunity.
An embodiment wherein the GCS is configured to allow the donor to configure the selected gifting opportunity to be executed based on a conditional gifting criterion.
An embodiment wherein the RSL allows the organization to design a method to assemble information to form an account number selected from a group consisting of: designation; restriction type; gift type; fund; payment method; channel; site; bank account; and constants.
An embodiment wherein the RSL matches the transaction with the appropriate account when creating a general ledger entry using data selected from a group consisting of: designation; restriction type; gift type; fund; payment method; channel; site; and bank account.
An embodiment wherein the RSL is automatically updated based on information received by the PPS, the information selected from a group consisting of: change of payment status; settlement; and deposit.
An embodiment wherein the GCS further comprises a multi-tenant database further comprising information on a plurality of organizations.
An embodiment wherein the GCS is configured to invite a plurality of organizations to cooperate in a joint fundraising effort based on a defined percentage split of revenue.
An embodiment wherein the GCS is configured to permit an organization to accept an invitation to participate in a joint fundraising effort based on a defined percentage split of revenue involving one or more other organizations.
An embodiment wherein the GCS is configured to automatically provide data regarding a joint fundraising designation to a participating organization in the joint fundraising designation.
An embodiment wherein the GCS is configured to automatically provide accounting for gifts designated to a joint fundraising designation.
An embodiment wherein the GCS is configured to automatically distribute funds collected in a joint fundraising designation based on settlement of payment within the PPS to each of the organizations participating in a joint fundraising designation in accordance with a defined proceed split criteria.

One skilled in the art will recognize that other embodiments are possible based on combinations of elements taught within the above invention description.

### Generalized Computer Usable Medium

In various alternate embodiments, the present invention may be implemented as a computer program product for use with a computerized computing system. Those skilled in the art will readily appreciate that programs defining the functions defined by the present invention can be written in any appropriate programming language and delivered to a computer in many forms, including but not limited to: (a) information permanently stored on non-writeable storage media (e.g., read-only memory devices such as ROMs or CD-ROM disks); (b) information alterably stored on writeable storage media (e.g., floppy disks and hard drives); and/or (c) information conveyed to a computer through communication media, such as a local area network, a telephone network, or a public network such as the Internet. When carrying computer readable instructions that implement the present invention methods, such computer readable media represent alternate embodiments of the present invention.

As generally illustrated herein, the present invention system embodiments can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d1383 (U.S. Pat. No. 5,710,578), the present invention anticipates and includes this type of computer readable media within the scope of the invention. Pursuant to In re Nuijten, 500 F.3d 1346 (Fed. Cir. 2007) (U.S. patent application Ser. No. 09/211,928), the present invention scope is limited to computer readable media wherein the media is both tangible and non-transitory.

### CONCLUSION

A gift transaction processing system/method allowing collection and management of financial and non-financial gifts from gift donors to gift recipients using a distributed communication network has been disclosed. The gift donor interacts with a graphical user interface (GUI) client to donate a gift under control of a computerized gifting computing server (GCS). The GCS receives gift donor information and assigns an identification token to the gift donor and associates this token with the received gift donor information. The GCS then sends the token and an HTML document identifying the gift to the client along with a donation application activator. The client receives this information and displays the HTML document at which time the donor selects the donation activator and the client informs the GCS to complete the gift transaction and provide a receipt to the donor via the client.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. A gift transaction processing system comprising:
(a) gifting computing server (GCS);
(b) gifting database (GDB); and
(c) donor database (DDB);
wherein
said GCS is configured to interact with a donor via a graphical user interface (GUI) to establish identification information about said donor in said DDB;
said GCS is configured to associate said identification information with a donor ID token stored in said DDB;
said GUI is configured to allow said donor to select a gifting opportunity from a gift opportunity catalog (GOC) contained in said GDB;
said GCS is configured to transmit information on said selected gifting opportunity and said donor ID token constituting a gifting transaction to said GUI for display to said donor;
said GCS is configured to permit acceptance of said gifting transaction on said GUI display by said donor;
said GCS is configured to affect a financial transaction wherein funds are transferred from financial accounts associated with said donor to financial accounts associated with the gift recipient of said selected gifting opportunity;
said GCS and said GUI are embodied in one or more computer systems executing software retrieved from a tangible non-transitory computer readable medium; and
said computer systems are linked via a computer network.

2. The gift transaction processing system of claim 1 wherein said financial transaction is selected from a group consisting of: credit card transactions; debit card transactions; and ACH transactions.

3. The gift transaction processing system of claim 1 wherein said GCS receives said donor ID token and said donor acceptance and processes a financial transaction on behalf of the donor associated with said donor ID token to affect transfer of funds from a financial institution to the donee gift recipient of said gifting opportunity.

4. The gift transaction processing system of claim 1 wherein said computer network comprises the Internet.

5. The gift transaction processing system of claim 1 wherein said DDB comprises a history of gifting by said donor.

6. The gift transaction processing system of claim 1 wherein said DDB comprises receipt verification for each gift donated by said donor.

7. The gift transaction processing system of claim 1 wherein said GCS comprises a secure transaction processing system.

8. The gift transaction processing system of claim 1 wherein said GDB is resident on said GCS.

9. The gift transaction processing system of claim 1 wherein said GUI is embodied in computerized hardware selected from a group consisting of: mobile phone; smartphone; tablet computer; laptop computer; and desktop computer.

10. The gift transaction processing system of claim 1 wherein said GOC is restricted based on the GPS coordinates of said GUI.

11. The gift transaction processing system of claim 1 wherein said DDB comprises a plethora a of said donor ID tokens, said donor ID tokens being individually mapped to an entry in said GOC.

12. The gift transaction processing system of claim 1 wherein said GCS is configured to allow said selected gifting opportunity to be associated with multiple gift recipients.

13. The gift transaction processing system of claim 1 wherein said GCS is configured to allow said selected gifting opportunity to be associated with multiple gift recipients wherein each of said multiple gift recipients is apportioned a percentage of said financial transaction according to data stored in said GDB.

14. The gift transaction processing system of claim 1 wherein said GCS is configured to generate a push notification to said donor to solicit a specific gifting opportunity.

15. The gift transaction processing system of claim 1 wherein said GCS is configured to allow said donor to configure said selected gifting opportunity to be executed based on a conditional gifting criterion.

16. A gift transaction processing method comprising:
(1) establishing a donor database (DDB) comprising donor information;
(2) receiving a gift selection request from a donor via a graphical user interface (GUI) that associates a donor ID token with a donation request selected from a gift opportunity catalog (GOC) resident on a gifting database (GDB);
(3) displaying said gift selection request and said donor information to said donor for acceptance by said donor; and
(4) processing acceptance of said gift selection request by a gifting computing server (GCS) to affect a financial transaction wherein funds are transferred from financial accounts associated with said donor to financial accounts associated with the gift recipient of said donation request;
wherein
said donor information comprises said donor ID which represents a unique identification for the donor associated with said donor information;
said steps are performed by one or more computer systems executing software retrieved from a computer readable medium; and
said computer systems are linked via a computer network.

17. The gift transaction processing method of claim 16 wherein said financial transaction is selected from a group consisting of: credit card transactions; debit card transactions; and ACH transactions.

18. The gift transaction processing method of claim 16 wherein said GCS receives said donor ID token and said donor acceptance and processes a financial transaction on behalf of the donor associated with said donor ID token to affect transfer of funds from a financial institution to the donee gift recipient of said gifting opportunity.

19. The gift transaction processing method of claim 16 wherein said computer network comprises the Internet.

20. The gift transaction processing method of claim 16 wherein said DDB comprises a history of gifting by said donor.

21. The gift transaction processing method of claim 16 wherein said DDB comprises receipt verification for each gift donated by said donor.

22. The gift transaction processing method of claim 16 wherein said GCS comprises a secure transaction processing system.

23. The gift transaction processing method of claim 16 wherein said GDB is resident on said GCS.

24. The gift transaction processing method of claim 16 wherein said GUI is embodied in computerized hardware selected from a group consisting of: mobile phone; smartphone; tablet computer; laptop computer; and desktop computer.

25. The gift transaction processing method of claim 16 wherein said GOC is restricted based on the GPS coordinates of said GUI.

26. The gift transaction processing method of claim 16 wherein said DDB comprises a plethora a of said donor ID tokens, said donor ID tokens being individually mapped to an entry in said GOC.

27. The gift transaction processing method of claim 16 wherein said GCS is configured to allow said selected gifting opportunity to be associated with multiple gift recipients.

28. The gift transaction processing method of claim 16 wherein said GCS is configured to allow said selected gifting opportunity to be associated with multiple gift recipients wherein each of said multiple gift recipients is apportioned a percentage of said financial transaction according to data stored in said GDB.

29. The gift transaction processing method of claim 16 wherein said GCS is configured to generate a push notification to said donor to solicit a specific gifting opportunity.

30. The gift transaction processing method of claim 16 wherein said GCS is configured to allow said donor to configure said selected gifting opportunity to be executed based on a conditional gifting criterion.

31. A tangible non-transitory computer usable medium having computer-readable program code means comprising a gift transaction processing method comprising:
(1) establishing a donor database (DDB) comprising donor information;
(2) receiving a gift selection request from a donor that associates a donor ID token with a donation request selected from a gift opportunity catalog (GOC) resident on a gifting database (GDB);
(3) displaying said gift selection request and said donor information to said donor for acceptance by said donor; and
(4) processing acceptance of said gift selection request by a gifting computing server (GCS) to affect a financial transaction wherein funds are transferred from financial accounts associated with said donor to financial accounts associated with the gift recipient of said donation request;
wherein
said donor information comprises said donor ID which represents a unique identification for the donor associated with said donor information;
said steps are performed by one or more computer systems executing software retrieved from a computer readable medium; and
said computer systems are linked via a computer network.

32. The computer usable medium of claim 31 wherein said financial transaction is selected from a group consisting of: credit card transactions; debit card transactions; and ACH transactions.

33. The computer usable medium of claim 31 wherein said GCS receives said donor ID token and said donor acceptance and processes a financial transaction on behalf of the donor associated with said donor ID token to affect transfer of funds from a financial institution to the donee gift recipient of said gifting opportunity.

34. The computer usable medium of claim 31 wherein said computer network comprises the Internet.

35. The computer usable medium of claim 31 wherein said DDB comprises a history of gifting by said donor.

36. The computer usable medium of claim 31 wherein said DDB comprises receipt verification for each gift donated by said donor.

37. The computer usable medium of claim 31 wherein said GCS comprises a secure transaction processing system.

38. The computer usable medium of claim 31 wherein said GDB is resident on said GCS.

39. The computer usable medium of claim 31 wherein said GUI is embodied in computerized hardware selected from a group consisting of: mobile phone; smartphone; tablet computer; laptop computer; and desktop computer.

40. The computer usable medium of claim 31 wherein said GOC is restricted based on the GPS coordinates of said GUI.

41. The computer usable medium of claim 31 wherein said DDB comprises a plethora a of said donor ID tokens, said donor ID tokens being individually mapped to an entry in said GOC.

42. The computer usable medium of claim 31 wherein said GCS is configured to allow said selected gifting opportunity to be associated with multiple gift recipients.

43. The computer usable medium of claim 31 wherein said GCS is configured to allow said selected gifting opportunity to be associated with multiple gift recipients wherein each of said multiple gift recipients is apportioned a percentage of said financial transaction according to data stored in said GDB.

44. The computer usable medium of claim 31 wherein said GCS is configured to generate a push notification to said donor to solicit a specific gifting opportunity.

45. The computer usable medium of claim 31 wherein said GCS is configured to allow said donor to configure said selected gifting opportunity to be executed based on a conditional gifting criterion.

46. A gift transaction processing system comprising:
(a) gifting computing server (GCS);
(b) revenue sub-ledger (RSL);
(c) payment processing system (PPS);
(d) CASS address standardization system (ASS); and
(e) search index of individual profiles (SIP);
wherein
said GCS is configured to interact with a donor via a graphical user interface (GUI) to accept charitable transactions and payments;
said SIP comprises individual donor identification information stored in a donor database with donor search indexes;
said GCS is configured to identify said donor via said SIP and generate an identifier associated with said donor using said ASS;
said GCS is configured to identify and match profiles within said SIP utilizing a combination of name, phonetic name indexes, nicknames, standardized addresses and score-based matching to identify existing profile records which may be a duplicate;
said GUI allows an organization to define chart of account designs (COD);
said PPS is configured to facilitate payment processing, reconciliation, accounting for charitable transactions, and accounting for merchant processing related payments between said donor and said organization based on said COD;
said GCS is configured to update said RSL based on the completion of financial transactions between said donor and said organization;
said RSL is configured to allow said organization to assemble an account according to a design that matches a gift recipient chart of account design;
said GCS, RSL, PPS, ASS, SIP, and GUI are embodied in one or more computer systems executing software retrieved from a computer readable medium; and
said computer systems are linked via a computer network.

47. The gift transaction processing system of claim 46 wherein said RSL allows said organization to design a method to assemble information to form an account number selected from a group consisting of: designation; restriction type; gift type; fund; payment method; channel; site; bank account; and constants.

48. The gift transaction processing system of claim 46 wherein said RSL matches the transaction with the appropriate account when creating a general ledger entry using data selected from a group consisting of: designation; restriction type; gift type; fund; payment method; channel; site; and bank account.

49. The gift transaction processing system of claim 46 wherein said RSL is automatically updated based on information received by the PPS, said information selected from a group consisting of: change of payment status; settlement; and deposit.

50. The gift transaction processing system of claim 46 wherein said GCS further comprises a multi-tenant database further comprising information on a plurality of organizations.

51. The gift transaction processing system of claim 46 wherein said GCS is configured to invite a plurality of organizations to cooperate in a joint fundraising effort based on a defined percentage split of revenue.

52. The gift transaction processing system of claim 46 wherein said GCS is configured to permit an organization to accept an invitation to participate in a joint fundraising effort based on a defined percentage split of revenue involving one or more other organizations.

53. The gift transaction processing system of claim 46 wherein said GCS is configured to automatically provide data regarding a joint fundraising designation to a participating organization in said joint fundraising designation.

54. The gift transaction processing system of claim 46 wherein said GCS is configured to automatically provide accounting for gifts designated to a joint fundraising designation.

55. The gift transaction processing system of claim 46 wherein said GCS is configured to automatically distribute funds collected in a joint fundraising designation based on settlement of payment within said PPS to each of the organizations participating in a joint fundraising designation in accordance with a defined proceed split criteria.
